(19) United States
(12) Patent Application Publication
(10) Pub. No.: US 2018/0062696 A1
(43) Pub. Date: Mar. 1, 2018

(54) COMMUNICATION DEVICE AND CANCELLATION METHOD

(71) Applicant: FUJITSU LIMITED, Kawasaki-shi (JP)

(72) Inventors: TOSHIO KAWASAKI, Kawasaki (JP); Nobuhisa Aoki, Kawasaki (JP); TORU MANIWA, Setagaya (JP); Tadahiro Sato, Yokohama (JP); Yusuke Tobisu, Yokohama (JP); Hiroshi Towata, Fukuoka (JP)

(73) Assignee: FUJITSU LIMITED, Kawasaki-shi (JP)

(21) Appl. No.: 15/648,115

(22) Filed: Jul. 12, 2017

(30) Foreign Application Priority Data
Aug. 31, 2016 (JP) 2016-169987

(51) Int. Cl. H04B 1/525; H04B 1/04; H04B 1/50; H04L 5/14; H04L 27/26

(52) U.S. Cl. CPC H04B 1/525; H04B 1/0475; H04L 5/1461; H04L 5/143; H04L 27/2601; H04B 1/50

(57) ABSTRACT

A passive intermodulation (PIM) canceller of a communication device includes a combining unit, a replica generating unit, and a delay measuring instrument. The replica generating unit generates an intermodulation signal based on the amount of delay of each transmission signal. The combining unit cancels out the intermodulation signal from the reception signal using the generated intermodulation signal. The delay measuring instrument delays a transmission signal x₂ included in a plurality of transmission signals by different first amounts of delay. The delay measuring instrument generates an intermediate signal Sₘ₁ by multiplying the delayed transmission signal x₂ to the reception signal. The delay measuring instrument calculates, based on the correlation values of the intermediate signal Sₘ₁ corresponding to each first amount of delay and a transmission signal x₁ included in the plurality of transmission signals, the amount of delay of the transmission signal x₁ with respect to the intermodulation signal.

### CROSS-REFERENCE TO RELATED APPLICATION

This application is based upon and claims the benefit of priority of the prior Japanese Patent Application No. 2016-169987, filed on Aug. 31, 2016, the entire contents of which are incorporated herein by reference.

### FIELD

The embodiments discussed herein are related to a communication device and a cancellation method.

### BACKGROUND

A plurality of wireless communication devices can perform communication without interference from each other by using mutually different frequencies. Moreover, in a wireless communication device in which the frequency division duplex (FDD) method is implemented, since the frequency band used for transmission signals is different from the frequency band used for reception signals, transmission and reception can be performed in parallel.

In the case in which a plurality of wireless communication devices performs communication using transmission signals of different frequencies, sometimes there occurs intermodulation of the transmission signals due to the reflection from an obstacle such as a metallic signboard, or the like, and each wireless communication device may sometimes receive intermodulation signals. Depending on the frequency allocation of the transmission signals, sometimes the intermodulation signals are included in the frequency band of the reception signals. When the frequency of the intermodulation signals is close to the frequency of the reception signals, the intermodulation signals are difficult to be completely removed using a filter, thereby resulting in quality deterioration of the reception signals in the wireless communication devices. In that regard, a method is being considered in which intermodulation signals are generated in an approximative manner from the transmission signals, and the intermodulation signals included in the reception signals are cancelled out using the generated intermodulation signals.

Prior art examples are disclosed in Japanese National Publication of International Patent Application No. 2009-526442 and in 3GPP TR37.808 v12.0.0 “Passive Intermodulation (PIM) handling for Base Stations (BS) (Release 12)”

Generally, the distance to an obstacle, which represents the source of generation of intermodulation signals, is different for each wireless communication device. Hence, at a source of generation of intermodulation signals, the intermodulation signals are generated due to a plurality of transmission signals having different amounts of delay. On the other hand, in each wireless communication device, an intermodulation signal is generated from a plurality of transmission signals but without any relation to the amounts of delay of the transmission signals responsible for the occurrence of the actual intermodulation signal. For that reason, even if the generated intermodulation signal is combined with a reception signal, it is difficult to sufficiently cancel out the intermodulation signal included in the reception signal. Thus, because of the components of the intermodulation signal remaining in the reception signal, the quality of the reception signal undergoes deterioration.

### SUMMARY

According to an aspect of an embodiment, a communication device includes a transmitting unit, a receiving unit, a delay measuring instrument, an intermodulation signal generating unit, and a cancelling unit. The transmitting unit transmits a plurality of transmission signals at mutually different frequencies. The receiving unit receives a reception signal which includes an intermodulation signal resulting from the plurality of transmission signals. The delay measuring instrument measures an amount of delay of each of the plurality of transmission signals. The intermodulation signal generating unit generates the intermodulation signal from the plurality of transmission signals based on the amount of delay of each of the plurality of transmission signals as measured by the delay measuring instrument. The cancelling unit cancels out the intermodulation signal included in the reception signal by combining the intermodulation signal, which is generated by the intermodulation signal generating unit, and the reception signal. The delay measuring instrument includes a delay signal generating unit, an intermediate signal generating unit, and a calculating unit. The delay signal generating unit generates a delay signal which includes a signal formed by delaying one particular transmission signal, among the plurality of transmission signals, by a first amount of delay. The intermediate signal generating unit multiplies, to the reception signal, either the delay signal or a complex conjugate of the delay signal generated by the delay signal generating unit, and generates an intermediate signal. The calculating unit, based on a correlation value between the intermediate signal and other transmission signal included in the plurality of transmission signals, calculates an amount of delay of the other transmission signal with respect to the intermodulation signal.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an example of a communication device;

FIG. 2 is a diagram for explaining a situation in which an intermodulation signal is generated;

FIG. 3 is a diagram illustrating an example of frequencies of an intermodulation signal;

FIG. 4 is a block diagram illustrating an example of an intermodulation signal (PIM) canceller according to a first embodiment;

FIG. 5 is a block diagram illustrating an example of a delay measuring instrument according to the first embodiment;

FIG. 6 is a diagram illustrating an example of a correlator;

FIG. 7 is a diagram illustrating an example of a correlator;

FIG. 8 is a flowchart for explaining an example of the operations performed in the communication device;

FIG. 9 is a flowchart for explaining an example of a delay amount measurement operation performed according to the first embodiment;

FIG. 10 is a diagram illustrating an example of the delay profile of each transmission signal;

FIG. 11 is a diagram illustrating an example of the delay profile of a generated intermodulation signal;

FIG. 12 is a block diagram illustrating an example of the PIM canceller according to a comparison example;

FIG. 13 is a block diagram illustrating an example of a delay measuring instrument according to the comparison example;

FIG. 14 is a diagram illustrating an example of the delay profile of the intermodulation signal generated according to the comparison example;

FIG. 15 is a block diagram illustrating another example of the delay measuring instrument according to the comparison example;

FIG. 16 is a block diagram illustrating another example of the delay measuring instrument according to the first embodiment;

FIG. 17 is a diagram illustrating an example of the delay profile of each transmission signal;

FIG. 18 is a block diagram illustrating an example of the delay measuring instrument according to a second embodiment;

FIG. 19 is a flowchart for explaining an example of a delay amount measurement operation performed according to the second embodiment;

FIG. 20 is a diagram illustrating an example of the delay profile of each transmission signal;

FIG. 21 is a block diagram illustrating another example of the delay measuring instrument according to the second embodiment;

FIG. 22 is a diagram illustrating an example of the delay profile of each transmission signal;

FIG. 23 is a block diagram illustrating an example of the delay measuring instrument according to a third embodiment;

FIGS. 24 to 26 are flowcharts for explaining an example of delay amount measurement operations according to the third embodiment;

FIG. 27 is a diagram illustrating an example of the delay profile of each transmission signal;

FIG. 28 is a block diagram illustrating an example of the delay measuring instrument according to a fourth embodiment;

FIG. 29 is a flowchart for explaining an example of a delay amount measurement operation performed according to the fourth embodiment;

FIG. 30 is a diagram illustrating an example of the delay profile of each transmission signal;

FIG. 31 is a block diagram illustrating an example of the delay measuring instrument according to a fifth embodiment;

FIGS. 32 and 33 are flowcharts for explaining an example of delay amount measurement operations according to the fifth embodiment;

FIG. 34 is a diagram illustrating an example of the delay profile of each transmission signal;

FIG. 35 is a block diagram illustrating another example of the delay measuring instrument according to the fifth embodiment;

FIG. 36 is a diagram illustrating an example of the delay profile of each transmission signal;

FIG. 37 is a block diagram illustrating an example of the delay measuring instrument according to a sixth embodiment;

FIG. 38 is a flowchart for explaining an example of a delay amount measurement operation performed according to the sixth embodiment;

FIG. 39 is a diagram illustrating an example of the delay profile of each transmission signal;

FIG. 40 is a block diagram illustrating another example of the delay measuring instrument according to the sixth embodiment;

FIG. 41 is a diagram illustrating an example of the delay profile of each transmission signal;

FIG. 42 is a block diagram illustrating an example of the delay measuring instrument according to a seventh embodiment;

FIG. 43 is a flowchart for explaining an example of a delay amount measurement operation performed according to the seventh embodiment;

FIG. 44 is a diagram illustrating an example of the delay profile of each transmission signal;

FIG. 45 is a block diagram illustrating another example of the delay measuring instrument according to the seventh embodiment;

FIG. 46 is a diagram illustrating an example of the delay profile of each transmission signal;

FIG. 47 is a block diagram illustrating an example of the delay measuring instrument according to an eighth embodiment;

FIG. 48 is a flowchart for explaining an example of a delay amount measurement operation performed according to the eighth embodiment;

FIG. 49 is a diagram illustrating an example of hardware of a remote radio equipment (RRE); and

FIG. 50 is a diagram illustrating an example of hardware of the delay measuring instrument.

### DESCRIPTION OF EMBODIMENTS

Preferred embodiments of the present invention will be explained with reference to accompanying drawings. However, the communication device and the cancellation method disclosed herein are not limited to the embodiments explained below. Moreover, the embodiments can be appropriately combined without causing contradiction in the operation details.

### [a] First Embodiment

Communication Device 10

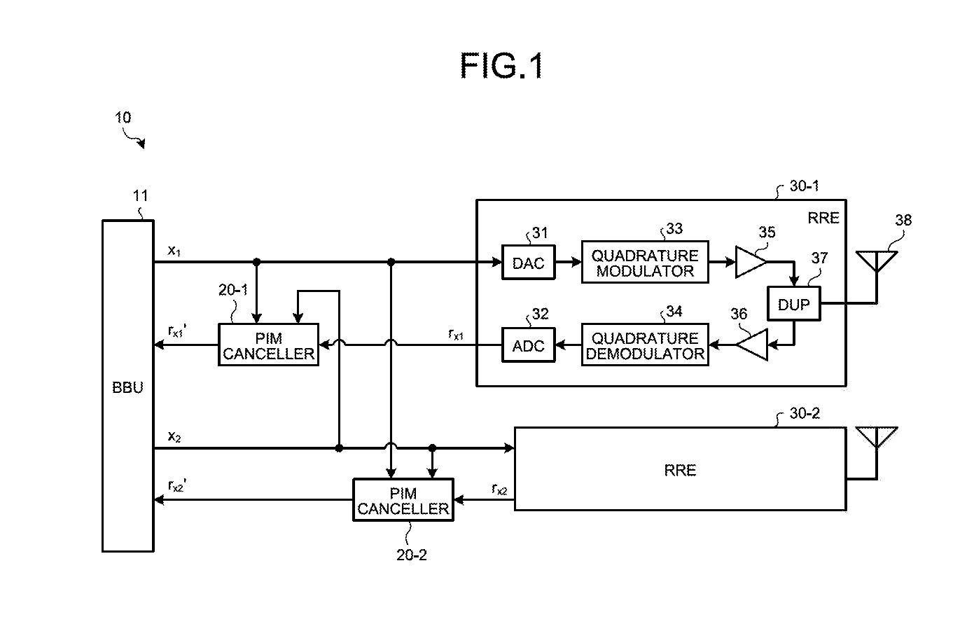

FIG. 1 is a block diagram illustrating an example of a communication device 10. Herein, the communication device 10 includes a base band unit (BBU) 11, passive intermodulation (PIM) cancellers 20-1 and 20-1, and remote radio equipments (RREs) 30-1 and 30-2. The RREs 30-1 and 30-2 transmit transmission signals having mutually different frequencies. In a firth embodiment, the RRE 30-1 transmits a transmission signal x₁ having a frequency f₁, while the RRE 30-2 transmits a transmission signal x₂ having a frequency f₂. Herein, the transmission signal x₁ represents an example of a first transmission signal, while the transmission signal x₂ represents an example of a second transmission signal. In the following explanation, it is assumed that f₁<f₂ holds true. Moreover, in the following explanation, in the case of collectively referring to the PIM cancellers 20-1 and 20-2 without distinguishing therebetween, they are simply referred to as the PIM canceller 20. Similarly, in the case of collectively referring to the RREs 30-1 and 30-2 without distinguishing therebetween, they are simply referred to as the RRE 30.

Each RRE 30 includes a digital-to-analog converter (DAC) 31, an analog-to-digital converter (ADC) 32, quadrature modulator 33, and quadrature demodulators 34. Moreover, each RRE 30 includes a power amplifier (PA) 35, a low noise amplifier (LNA) 36, a duplexer (DUP) 37, and an antenna 38.

The DAC 31 converts a transmission signal, which is a digital signal output from the BBU 11, into an analog signal and outputs the analog signal to the quadrature modulator 33. Then, the quadrature modulator 33 performs quadrature modulation with respect to the transmission signal in the form of an analog signal due to the conversion performed by the DAC 31. The PA 35 amplifies the transmission signal that has been subjected to quadrature modulation by the quadrature modulator 33. Of the transmission signal that has been amplified by the PA 35, the DUP 37 allows passage of the frequency components within the transmission band to the antenna 38. As a result, the transmission signal is transmitted from the antenna 38. Herein, the DAC 31, the quadrature modulator 33, and the PA 35 represent an example of a transmitting unit.

Moreover, of the reception signal received via the antenna 38, the DUP 37 allows passage of the frequency components within the reception band to the LNA 36. Then, the LNA 36 amplifies the reception signal output from the DUP 37. The quadrature demodulator 34 performs quadrature demodulation with respect to the reception signal that has been amplified by the LNA 36. The ADC 32 converts the reception signal, which is an analog signal subjected to quadrature demodulation by the quadrature demodulator 34, into a digital signal and outputs the digital reception signal to the PIM canceller 20. Herein, the LNA 36, the quadrature demodulator 34, and the ADC 32 represent an example of a receiving unit.

The PIM canceller 20-1 obtains the transmission signal x₁, which is transmitted by the RRE 30-1, and the transmission signal x₂, which is transmitted by the RRE 30-2, from the BBU 11 and generates an intermodulation signal based on the transmission signals x₁ and x₂. Then, the PIM canceller 20-1 cancels out the generated intermodulation signal from a reception signal rₓ₁ that is output from the RRE 30-1; and outputs a reception signal rₓ₁′, from which the intermodulation signal has been cancelled out, to the BBU 11.

The PIM canceller 20-2 obtains the transmission signal x₁, which is transmitted by the RRE 30-1, and the transmission signal x₂, which is transmitted by the RRE 30-2, from the BBU 11 and generates an intermodulation signal based on the transmission signals x₁ and x₂. Then, the PIM canceller 20-2 cancels out the generated intermodulation signal from a reception signal rₓ₂ that is output from the RRE 30-2; and outputs a reception signal rₓ₂′, from which the intermodulation signal has been cancelled out, to the BBU 11.

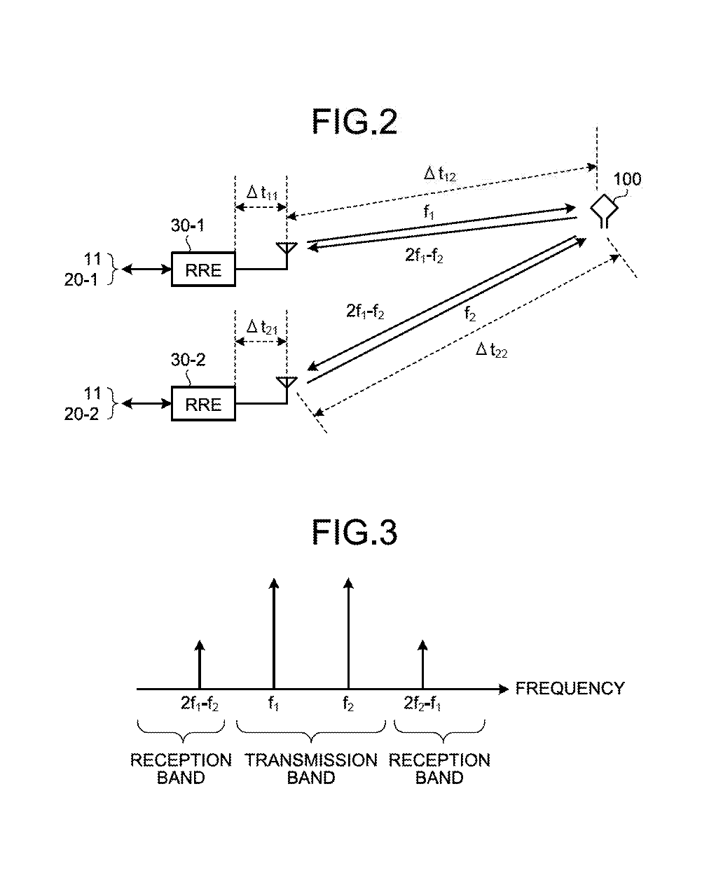

The following explanation is given about a situation in which an intermodulation signal is generated. FIG. 2 is a diagram for explaining a situation in which an intermodulation signal is generated. For example, as illustrated in FIG. 2, when an obstacle 100 such as a metallic signboard is present in the space, the transmission signal x₂, which has the frequency f₂ and which is transmitted from the RRE 30-2, reflects from the obstacle 100 thereby resulting in the generation of a distortion component signal. The distortion component includes a signal of intermodulation distortion. A signal of intermodulation distortion as generated due to the transmission signal x₁ having the frequency f₁ and the transmission signal x₂ having the frequency f₂ includes a signal having the frequency 2f₁-f₂ or the frequency 2f₂-f₁.

Depending on the frequencies f₁ and f₂, for example, as illustrated in FIG. 3, there are times when the frequency 2f₁-f₂ or the frequency 2f₂-f₁ is included in the reception band. When the frequency 2f₁-f₂ or the frequency 2f₂-f₁ is included in the reception band, sometimes the reception signal in the reception band undergoes deterioration in quality. For that reason, the PIM canceller 20 cancels out any intermodulation signal that has the frequency 2f₁-f₂ or the frequency 2f₂-f₁ and that is included in a signal received by the RRE 30, and thus enhances the quality of the reception signal.

In order to cancel out the intermodulation signal having the frequency 2f₁-f₂ or the frequency 2f₂-f₁; for example, an intermodulation signal is generated from the transmission signal x₁ having the frequency f₁ and the transmission signal x₂ having the frequency f₂, and the generated intermodulation signal is combined with the reception signal. As a result, the intermodulation signal included in the reception signal is cancelled out by the generated intermodulation signal, thereby resulting in an improvement in the quality of the reception signal.

However, for example, as illustrated in FIG. 2, a delay Δt₁₁ attributed to the cable length from the circuitry in the RRE 30-1 to the corresponding antenna is generally different than a delay Δt₂₁ attributed to the cable length from the circuitry in the RRE 30-2 to the corresponding antenna. Moreover, the distance to the obstacle 100, which represents the source of generation of intermodulation signals, is generally different from each RRE 30. For that reason, a delay Δt₁₂ attributed to the distance from the antenna of the RRE 30-1 to the obstacle 100 is generally different than a delay Δt₂₂ attributed to the distance from the antenna of the RRE 30-2 to the obstacle 100.

For that reason, in the obstacle 100, when an intermodulation signal is generated due to the transmission signal x₁ having the frequency f₁ and the transmission signal x₂ having the frequency f₂, the transmission signal x₁ and the transmission signal x₂ that are responsible for the occurrence of the intermodulation signal generally have different amounts of delay. If the transmission signals x₁ and x₂ that are used in generating an intermodulation signal have different amounts of delay than the amounts of delay of the transmission signals x₁ and x₂ that are responsible for the occurrence of the intermodulation signal included in the reception signal; even if the generated intermodulation signal is combined with the reception signal, the intermodulation signal does not be cancelled out sufficiently.

In that regard, in a first embodiment, the amounts of delay of the transmission signals x₁ and x₂ that are used in generating the intermodulation signal are approximated to the amounts of delay of the transmission signals x₁ and x₂ that are responsible for the occurrence of the received intermodulation signal. As a result, the intermodulation signal included in the reception signal is sufficiently cancelled out due to the generated intermodulation signal, thereby resulting in an improvement in the quality of the reception signal.

Meanwhile, the following explanation is given about the cancellation of an intermodulation signal having the frequency 2f₁-f₂. Regarding an intermodulation signal having the frequency 2f₂-f₁, the cancellation can be achieved in an identical manner by interchanging the frequencies f₁ and f₂.

PIM Canceller 20

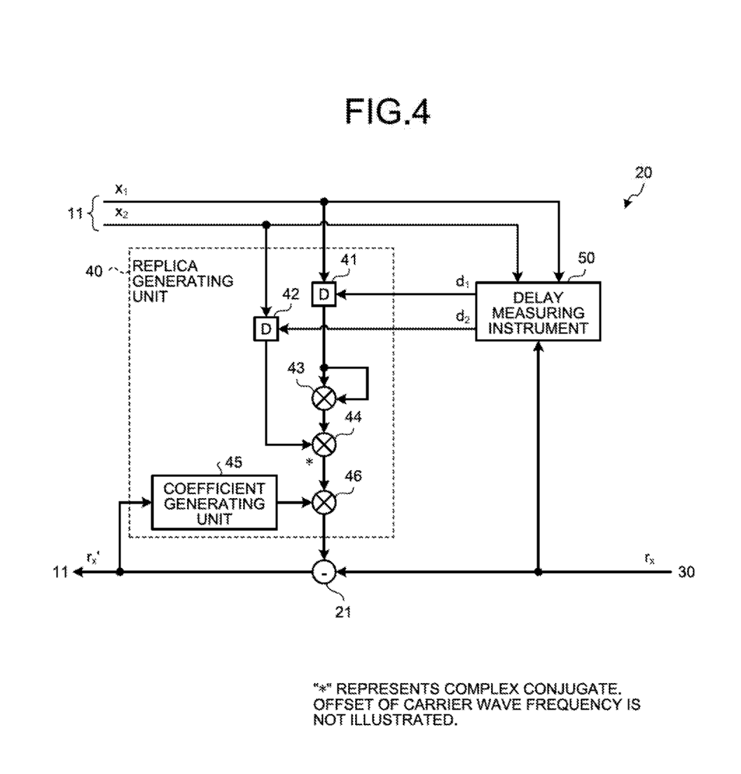

FIG. 4 is a block diagram illustrating an example of the PIM canceller 20 according to the first embodiment. The PIM canceller 20 includes a combining unit 21, a replica generating unit 40, and a delay measuring instrument 50. Based on the transmission signals x₁ and x₂ output from the BBU 11 and based on the reception signal rₓ output from the RRE 30, the delay measuring instrument 50 measures a delay amount d₁ of the transmission signal x₁ with respect to the reception signal rₓ and measures a delay amount d₂ of the transmission signal x₂ with respect to the reception signal rₓ. Then, the replica generating unit 40 generates an intermodulation signal using the transmission signals x₁ and x₂ that have been delayed by the delay amounts d₁ and d₂, respectively, calculated by the delay measuring instrument 50. The replica generating unit 40 represents an example of an intermodulation signal generating unit. The combining unit 21 combines the reception signal rₓ, which is output from the RRE 30, with the intermodulation signal generated by the replica generating unit 40, and cancels out the intermodulation signal included in the reception signal rₓ. Then, the combining unit 21 outputs a reception signal rₓ′, from which the intermodulation signal has been cancelled out, to the BBU 11. Herein, the combining unit 21 represents an example of a cancelling unit.

The replica generating unit 40 includes delay setting units 41 and 42, multipliers 43 and 44, a coefficient generating unit 45, and a multiplier 46. Herein, the multipliers 43, 44, and 46 are complex multipliers, for example. Regarding the transmission signal x₁ that is output from the BBU 11, the delay setting unit 41 delays the transmission signal x₁ by the delay amount d₁ and then the multiplier 43 calculates the square of the transmission signal x₁. Moreover, regarding the transmission signal x₂ that is output from the BBU 11, the delay setting unit 42 delays the transmission signal x₂ by the delay amount d₂. Then, the multiplier 44 multiplies the square of the transmission signal x₁ as calculated by the multiplier 43 to the complex conjugate of the transmission signal x₂ that has been delayed by the delay setting unit 42; and generates an intermodulation signal.

The coefficient generating unit 45 detects the intermodulation signal component that is included in the reception signal rₓ′ output from the combining unit 21. Then, with the aim of cancelling out the detected intermodulation signal component, the coefficient generating unit 45 calculates a coefficient for adjusting the amplitude and the phase of the intermodulation signal generated by the multiplier 44. The multiplier 46 multiplies the coefficient, which is calculated by the coefficient generating unit 45, to the intermodulation signal generated by the multiplier 44; and adjusts the phase and the amplitude of the intermodulation signal generated by the multiplier 44. The intermodulation signal that has the amplitude and the phase adjusted by the multiplier 46 is then output to the combining unit 21.

The reception signal rₓ includes, for example, an intermodulation signal S_{PIM} having the frequency 2f₁-f₂ as explained with reference to FIG. 2. The intermodulation signal S_{PIM} is expressed using, for example, Equation (1) given below. Herein, the offset frequency of the carrier wave is omitted.

S_{PIM}=A₃(x₁²·x₂*)+A₅₁(|x₁|²·x₁²·x₂*)+A₅₂(|x₂|²·x₁²·x₂*)+ . . . =(A₃+A₅₁|x₁|²+A₅₂|x₂|²+ . . . )x₁²·x₂* (1)

In Equation (1) given above; A₃, A₅₁, and A₅₂ are constant numbers representing coefficients of nonlinear distortion. Moreover, in Equation (1) given above, x* represents the complex conjugate of a transmission signal x.

When the transmission signal x₂ is multiplied to the intermodulation signal S_{PIM} given above in Equation (1), an intermediate signal Sₘ₁ representing the multiplication result is expressed using, for example, Equation (2) given below. The intermediate signal Sₘ₁ represents an example of a first intermediate signal.

Sₘ₁=S_{PIM}·x₂=(A₃+A₅₁|x₁|²+A₅₂|x₂|²+ . . . )x₁²·x₂*·x₂=(A₃+A₅₁|x₁|²+A₅₂|x₂|²+ . . . ) |x₂|²·x₁² (2)

In Equation (2), the component of the transmission signal x₂ is a real number and represents the change in the amplitude component. Thus, it becomes possible to calculate the correlation between the intermediate signal Sₘ₁ given above in Equation (2) and the square of the transmission signal x₁. Moreover, in the first embodiment, the transmission signal x₂ is delayed by a first amount of delay, and the delayed transmission signal x₂ is multiplied to the intermodulation signal S_{PIM} so as to generate the intermediate signal Sₘ₁. Then, with respect to the intermediate signal Sₘ₁ given above in Equation (2), the correlation values between the intermediate signal Sₘ₁ and the transmission signal x₁ are calculated while varying the amount of delay of the transmission signal x₁. In the first embodiment, while sequentially varying a plurality of different first amounts of delay, the correlation value between the intermediate signal Sₘ₁ and the transmission signal x₁ is calculated for each first amount of delay. Then, from among the correlation values corresponding to the first amounts of delay, the amount of delay for which the correlation value becomes the maximum value represents the delay amount d₁ of the transmission signal x₁ that is responsible for the occurrence of the intermodulation signal S_{PIM}.

Meanwhile, when the complex conjugate of the square of the transmission signal x₂ is multiplied to the intermodulation signal S_{PIM} given above in Equation (1), an intermediate signal Sₘ₂ representing the multiplication result is expressed using, for example, Equation (3) given below. The intermediate signal Sₘ₂ represents an example of a second intermediate signal.

Sₘ₂=S_{PIM}·(x₁²)*=(A₃+A₅₁|x₁|²+A₅₂|x₂|²+ . . . )x₁²·x₂*·(x₁²)*=(A₃+A₅₁|x₁|²+A₅₂|x₂|²+ . . . ) |x₁|⁴·x₂* (3)

In Equation (3) given above, the component of the transmission signal x₁ is a real number and represents the change in the amplitude component. Thus, it becomes possible to calculate the correlation between the intermediate signal Sₘ₂ given above in Equation (3) and the complex conjugate of the transmission signal x₂. Moreover, in the first embodiment, the transmission signal x₁ is delayed by a first amount of delay, and the complex conjugate of the square of the delayed transmission signal x₁ is multiplied to the intermodulation signal S_{PIM} to generate the intermediate signal Sₘ₂. Then, with respect to the intermediate signal Sₘ₂ given above in Equation (3), the correlation values between the intermediate signal Sₘ₂ and the complex conjugate of the transmission signal x₂ are calculated while varying the amount of delay of the transmission signal x₂. In the first embodiment, while sequentially varying a plurality of different first amounts of delay, the correlation value between the intermediate signal Sₘ₂ and the complex conjugate of the transmission signal x₂ is calculated for each first amount of delay. Then, from among the correlation values for the first amounts of delay, the amount of delay for which the correlation value becomes the maximum value represents the delay amount d₂ of the transmission signal x₂ that is responsible for the occurrence of intermodulation signal S_{PIM}.

In this way, after transmission signals are multiplied to a reception signal that includes an intermodulation signal, the correlation between the multiplication results and the transmission signals is calculated. With that, it becomes possible to independently obtain the delay of each transmission signal. The operation of obtaining the delay of each transmission signal is performed by the delay measuring instrument 50. Given below is the explanation of an example of a specific processing block of the delay measuring instrument 50.

Delay Measuring Instrument 50

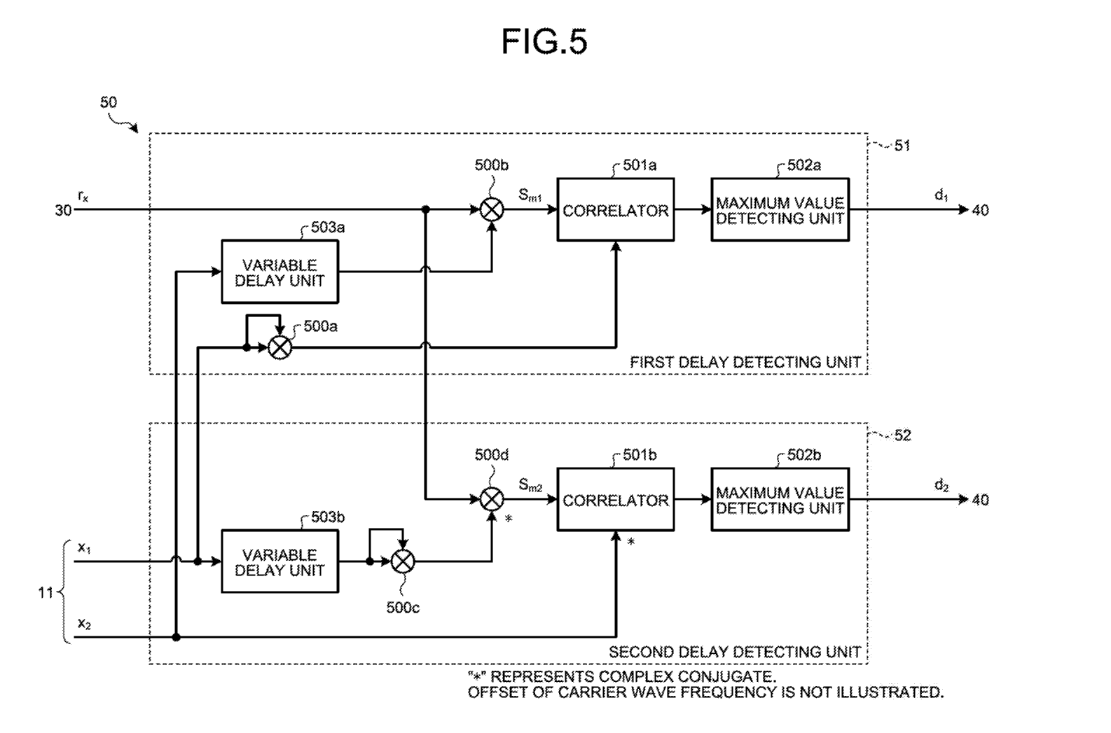

FIG. 5 is a block diagram illustrating an example of the delay measuring instrument 50 according to the first embodiment. The delay measuring instrument 50 according to the first embodiment includes a first delay detecting unit 51 that calculates the delay amount d₁ of the transmission signal x₁; and a second delay detecting unit 52 that calculates the delay amount d₂ of the transmission signal x₂. The first delay detecting unit 51 includes multipliers 500a and 500b, a correlator 501a, a maximum value detecting unit 502a, and a variable delay unit 503a. The second delay detecting unit 52 includes multipliers 500c and 500d, a correlator 501b, a maximum value detecting unit 502b, and a variable delay unit 503b. The multipliers 500a to 500d are complex multipliers, for example. The variable delay units 503a and 503b represent examples of a delay signal generating unit. The multipliers 500a and 500c represent examples of an intermediate signal generating unit. The correlators 501a and 501b represent examples of a correlating unit. The maximum value detecting units 502a and 502b represent examples of a calculating unit.

The variable delay unit 503a delays the transmission signal x₂, which is output from the BBU 11, by a first delay period. The variable delay unit 503b delays the transmission signal x₁, which is output from the BBU 11, by a first delay period. The variable delay units 503a and 503b delay the transmission signals x₂ and x₁, respectively, by first delay periods while varying a plurality of predetermined and different first amounts of delay. Herein, the transmission signal x₂ that has been delayed by the variable delay unit 503a and the transmission signal x₁ that has been delayed by the variable delay unit 503b represent examples of a delay signal. The variable delay unit 503a represents an example of a second delaying unit, and the variable delay unit 503b represents an example of a first delaying unit.

The multiplier 500b multiplies the transmission signal x₂, which has been delayed by the variable delay unit 503a, to the reception signal rₓ output from the RRE 30; and generates the intermediate signal Sₘ₁. The multiplier 500b represents an example of a first generating unit. The multiplier 500a calculates the square of the transmission signal x₁ output from the BBU 11.

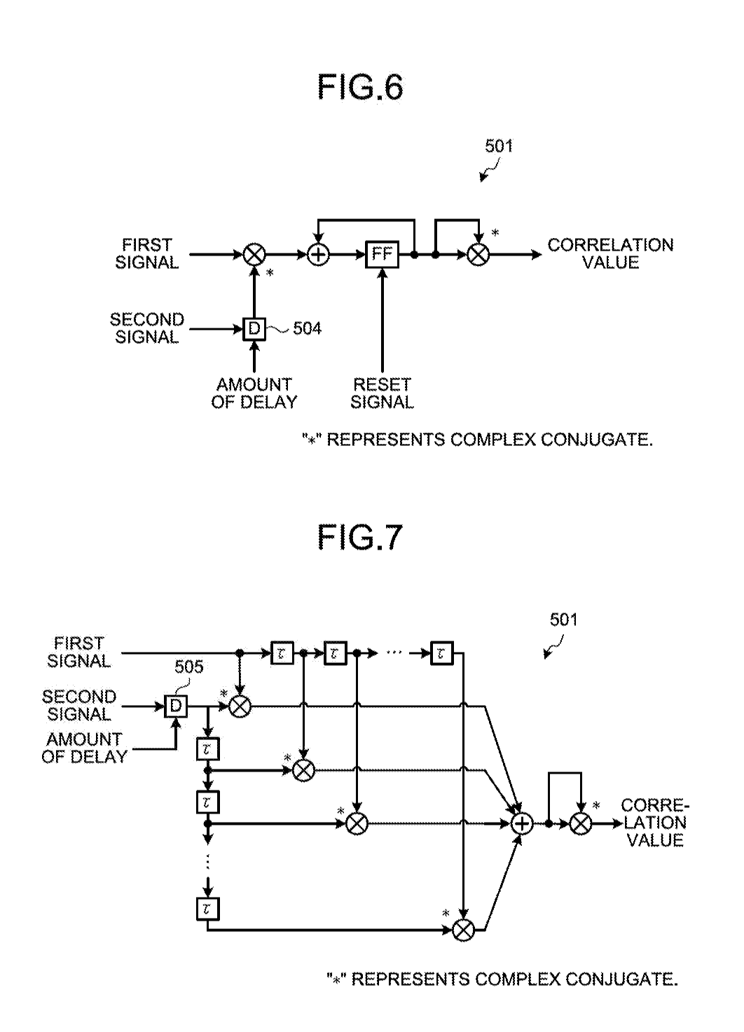

The correlator 501a calculates the correlation values between the intermediate signal Sₘ₁, which is calculated by the multiplier 500b, and the square of the transmission signal x₁ as calculated by the multiplier 500a. As far as the correlator 501a is concerned, it is possible to use, for example, a sliding correlator as illustrated in FIG. 6. Herein, FIG. 6 is a diagram illustrating an example of a correlator 501. The intermediate signal Sₘ₁ that is calculated by the multiplier 500b is input as a first signal to the correlator 501 illustrated in FIG. 6; and the square of the transmission signal x₁ as calculated by the multiplier 500a is input as a second signal to the correlator 501 illustrated in FIG. 6. Then, the correlation value between the first signal and the second signal is calculated for each amount of delay while varying the amount of delay set in a delay setting unit 504. Herein, the amount of delay set in the delay setting unit 504 represents an example of a second amount of delay.

Alternatively, as the correlator 501a, it is possible to use, for example, a matched filter as illustrated in FIG. 7. Herein, FIG. 7 is a diagram illustrating an example of the correlator 501. The intermediate signal Sₘ₁ that is calculated by the multiplier 500b is input as a first signal to the correlator 501 illustrated in FIG. 7; and the square of the transmission signal x₁ as calculated by the multiplier 500a is input as a second signal to the correlator 501 illustrated in FIG. 7. Then, the correlation value between the first signal and the second signal is calculated for each amount of delay while varying the amount of delay set in a delay setting unit 505. Herein, the amount of delay set in the delay setting unit 505 represents an example of a second amount of delay.

Meanwhile, the first amounts of delay that are varied in the variable delay units 503a and 503b have a coarser degree of resolution than the degree of resolution of the second amounts of delay that are set in the delay setting unit 504 or the delay setting unit 505. More particularly, in a plurality of different first amounts of delay and a plurality of different second amounts of delay, a difference Δt₁ between two first amounts of delay is greater than a difference Δt₂ between two second amounts of delay. In the following explanation, the difference Δt₁ between two first amounts of delay is sometimes called time resolution of the first amounts of delay.

The maximum value detecting unit 502a detects the maximum correlation value from among the correlation values calculated by the correlator 501a. Then, the maximum value detecting unit 502a outputs, as the delay amount d₁ of the transmission signal x₁, the amount of delay corresponding to the detected maximum correlation value to the replica generating unit 40. The maximum value detecting unit 502a represents an example of a first calculating unit.

The multiplier 500c calculates the square of the transmission signal x₁ that has been delayed by the variable delay unit 503b. The multiplier 500d multiplies, to the reception signal rₓ output from the RRE 30, the complex conjugate of the square of the transmission signal x₁ as calculated by the multiplier 500c; and generates the intermediate signal Sₘ₂. The multiplier 500d represents an example of a second generating unit.

The correlator 501b calculates the correlation values between the intermediate signal Sₘ₂, which is calculated by the multiplier 500d, and the complex conjugate of the transmission signal x₂ while varying the setting of the amount of delay of the complex conjugate of the transmission signal x₂. As far as the correlator 501b is concerned, for example, it is possible to use a sliding correlator as illustrated in FIG. 6 or a matched filter as illustrated in FIG. 7.

The maximum value detecting unit 502b detects the maximum correlation value from among the correlation values calculated by the correlator 501b. Then, the maximum value detecting unit 502b outputs, as the delay amount d₂ of the transmission signal x₂, the amount of delay corresponding to the detected maximum correlation value to the replica generating unit 40. The maximum value detecting unit 502b represents an example of a second calculating unit.

Operations of Communication Device 10

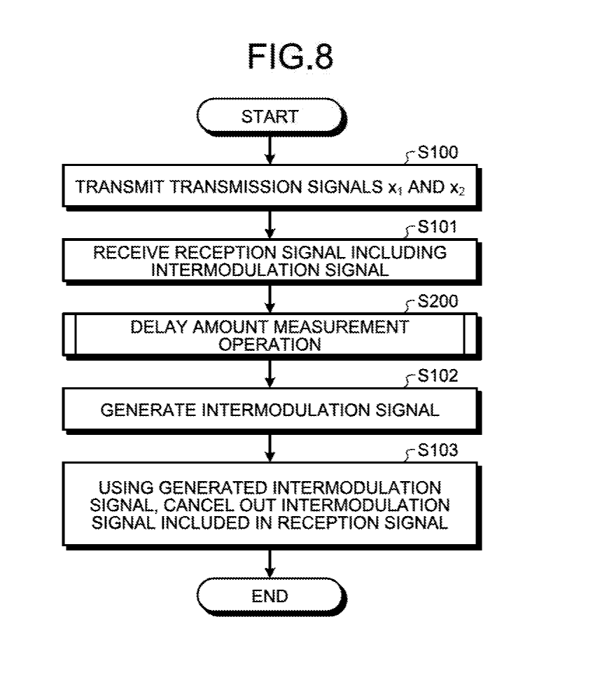

FIG. 8 is a flowchart for explaining an example of the operations performed in the communication device. The communication device 10 performs the operations illustrated in FIG. 8 at the time of transmitting the transmission signal x₁ and the transmission signal x₂.

Firstly, the BBU 11 outputs the transmission signal x₁ to the PIM cancellers 20-1 and 20-2 as well as to the RRE 30-1. Then, the RRE 30-1 modulates the transmission signal x₁ and transmits the modulated transmission signal x₁ from the antenna 38 (S100). Moreover, the BBU 11 outputs the transmission signal x₂ to the PIM cancellers 20-1 and 20-2 as well as to the RRE 30-2. Then, the RRE 30-2 modulates the transmission signal x₂ and transmits the modulated transmission signal x₂ from the antenna 38 (S100).

Then, The RRE 30-1 as well as the RRE 30-2 receives a reception signal including an intermodulation signal via the corresponding antenna 38 (S101). The reception signal rₓ₁ received by the RRE 30-1 is output to the PIM canceller 20-1, and the reception signal rₓ₂ received by the RRE 30-2 is output to the PIM canceller 20-2. Subsequently, the PIM cancellers 20-1 and 20-2 perform a delay amount measurement operation (described later) (S200).

Then, the PIM cancellers 20-1 and 20-2 generate intermodulation signals based on the amount of delay of the transmission signal x₁ and the amount of delay of the transmission signal x₂, respectively, as measured in the delay amount measurement operation (S102). The PIM canceller 20-1 combines the intermodulation signal generated therein and the reception signal rₓ₁ so as to cancel out the intermodulation signal included in the reception signal rₓ₁; and outputs the reception signal rₓ₁′, from which the intermodulation signal has been cancelled out, to the BBU 11 (S103). In an identical manner, the PIM canceller 20-2 combines the intermodulation signal generated therein and the reception signal rₓ₂ so as to cancel out the intermodulation signal included in the reception signal rₓ₂; and outputs the reception signal rₓ₂′, from which the intermodulation signal has been cancelled out, to the BBU 11 (S103).

(Delay Amount Measurement Operation>

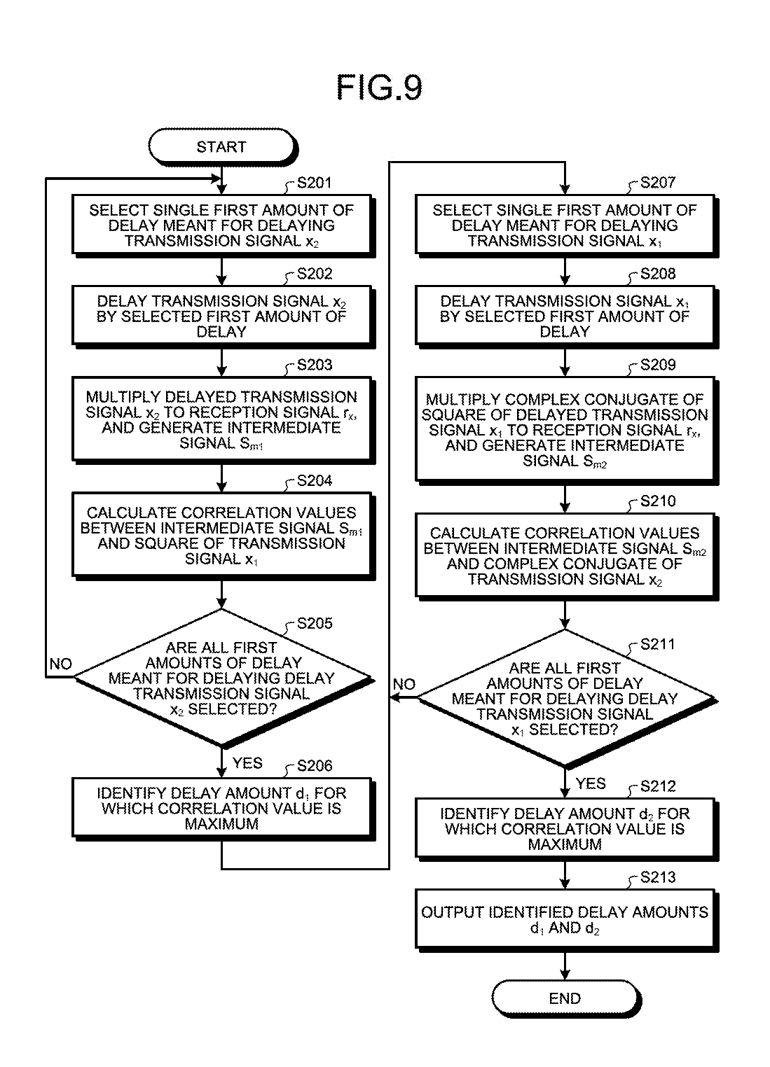

FIG. 9 is a flowchart for explaining an example of a delay amount measurement operation performed according to the first embodiment. The delay amount measurement operation illustrated in FIG. 9 is performed by the delay measuring instrument 50.

Firstly, the variable delay unit 503a selects, from among a plurality of predetermined and different first amounts of delay, a single amount of delay meant for delaying the transmission signal x₂ (S201). Then, the variable delay unit 503a delays the transmission signal x₂, which is output from the BBU 11, by the selected first amount of delay (S202). The multiplier 500b multiplies the transmission signal x₂, which has been delayed by the variable delay unit 503a, to the reception signal rₓ output from the RRE 30; and generates the intermediate signal Sₘ₁ (S203). The correlator 501a calculates the correlation values between the intermediate signal Sₘ₁ and the square of the transmission signal x₁ while varying the setting of the delay amount d₁ of the square of the transmission signal x₁ as calculated by the multiplier 500a (S204). The maximum value detecting unit 502a detects the maximum correlation value from among the correlation values calculated by the correlator 501a. Then, the maximum value detecting unit 502a holds the detected correlation value in a corresponding manner to the delay amount d₁ of the transmission signal x₁ that corresponds to the detected correlation value.

Subsequently, the variable delay unit 503a determines whether or not all first amounts of delay meant for delaying the transmission signal x₂ have been selected (S205). If any unselected first amount of delay is present (No at S205), then the variable delay unit 503a again performs the operation at Step S201. When all first amounts of delay meant for delaying the transmission signal x₂ are selected (Yes at S205), the maximum value detecting unit 502a identifies the delay amount d₁ for which the correlation value is the maximum from among the correlation values that are held (S206).

Subsequently, the variable delay unit 503b selects, from among a plurality of predetermined and different first amounts of delay, a single amount of delay meant for delaying the transmission signal x₁ (S207). Then, the variable delay unit 503b delays the transmission signal x₁, which is output from the BBU 11, by the selected first amount of delay (S208). The multiplier 500c calculates the square of the transmission signal x₁ that has been delayed by the variable delay unit 503b.

The multiplier 500d multiplies, to the reception signal rₓ output from the RRE 30, the complex conjugate of the square of the transmission signal x₁, which has been delayed by the variable delay unit 503b and which has been raised to the power of 2 by the multiplier 500c; and generates the intermediate signal Sₘ₂ (S209). The correlator 501b calculates the correlation values between intermediate signal Sₘ₂ and the complex conjugate of the transmission signal x₂ while varying the setting of the delay amount d₂ of the transmission signal x₂ (S210). The maximum value detecting unit 502b detects the maximum correlation value from among the correlation values calculated by the correlator 501b. Then, the maximum value detecting unit 502b holds the detected correlation value in a corresponding manner to the delay amount d₂ of the transmission signal x₂ that corresponds to the detected correlation value.

Subsequently, the variable delay unit 503b determines whether or not all first amounts of delay meant for delaying the transmission signal x₁ have been selected (S211). If any unselected first amount of delay is present (No at S211), then the variable delay unit 503b again performs the operation at Step S207. When all first amounts of delay meant for delaying the transmission signal x₁ are selected (Yes at S211), the maximum value detecting unit 502b identifies the delay amount d₂ for which the correlation value is the maximum from among the correlation values that are held (S212). Then, the maximum value detecting units 502a and 502b output the identified delay amounts d₁ and d₂, respectively, to the replica generating unit 40 (S213). It marks the end of the delay amount measurement operation illustrated in FIG. 9.

Meanwhile, in the flowchart illustrated in FIG. 9, the operations from Steps S207 to S212 are performed after the operations from Steps S201 to S206 have been performed. However, either the operations from Steps S201 to S206 or the operations from Steps S207 to S212 may be performed first. Alternatively, the operations from Steps S201 to S206 may be performed in parallel with the operations from Steps S207 to S212.

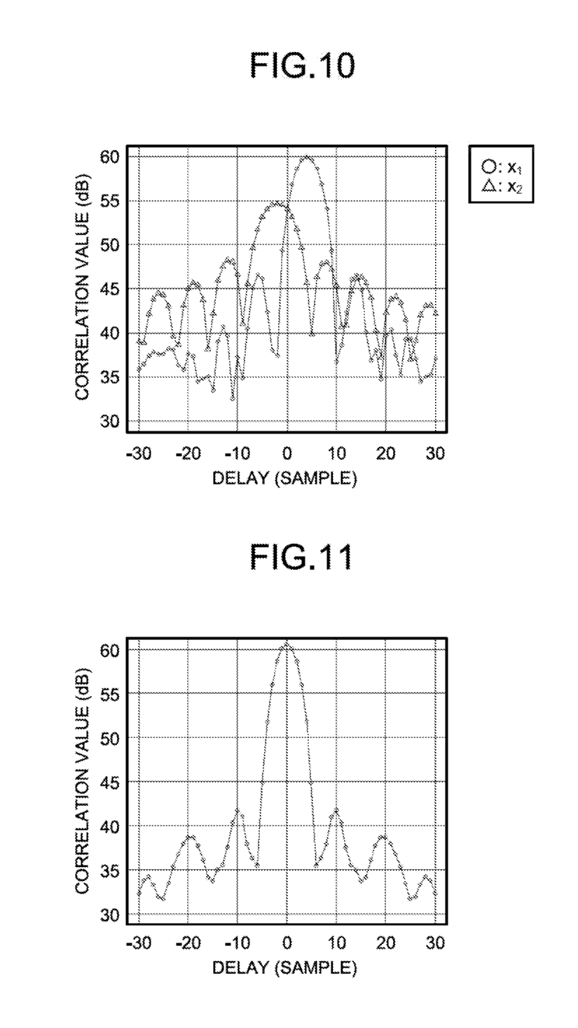

Regarding each transmission signal, a delay profile calculated by the delay measuring instrument 50 is as illustrated in FIG. 10, for example. FIG. 10 is a diagram illustrating an example of the delay profile of each transmission signal. In FIG. 10, the horizontal axis represents amounts of delay of each transmission signal with respect to the intermodulation signal, and the vertical axis represents correlation values. With reference to FIG. 10, LTE-based signals equivalent to 10 MHz are used, and the sampling frequency is, for example, 61.44 MHz. Moreover, in FIG. 10, open circles represent the correlation values between the intermediate signal Sₘ₁ and the square of the transmission signal x₁, and open triangles represent the correlation values between the intermediate signal Sₘ₂ and the complex conjugate of the transmission signal x₂. Furthermore, in FIG. 10, the illustrated correlation values represent correlation values with a reception signal that includes an intermodulation signal resulting from the transmission signal x₁ having the amount of delay of +4 samples and the transmission signal x₂ having the amount of delay of −2 samples. In the example illustrated in FIG. 10, the interval Δt₂ between the second amounts of delay, which are changed at the time of calculating the correlation values, is equal to eight samples, for example.

The maximum value in each delay profile illustrated in FIG. 10 is detected as the amount of delay of the corresponding transmission signal with respect to the intermodulation signal. In the example illustrated in FIG. 10, regarding the transmission signal x₁, the correlation value becomes the maximum value at the position of +4 samples with respect to the intermodulation signal. Regarding the transmission signal x₂, the correlation value becomes the maximum value at the position of −2 samples with respect to the intermodulation signal. In this way, after a transmission signal is multiplied to a reception signal that includes an intermodulation signal, the correlation between the multiplication result and the transmission signal is calculated. With that, it becomes possible to independently obtain the delay of each transmission signal.

As a result, an intermodulation signal can be generated based on the transmission signals having the amounts of delay to be close to the amounts of delay of the transmission signals responsible for the occurrence of the intermodulation signal. Hence, the replica generating unit 40 can generate an intermodulation signal having the waveform close to the waveform of the intermodulation signal included in the reception signal. If the correlation between the generated intermodulation signal and the reception signal is calculated; for example, as illustrated in FIG. 11, the delay profile has the maximum correlation value at the timing synchronized with the intermodulation signal included in the reception signal. As a result, the timing of the generated intermodulation signal and the timing of the intermodulation signal included in the reception signal can be matched with accuracy, and the intermodulation signal included in the reception signal can be cancelled out with accuracy.

### COMPARISON EXAMPLE

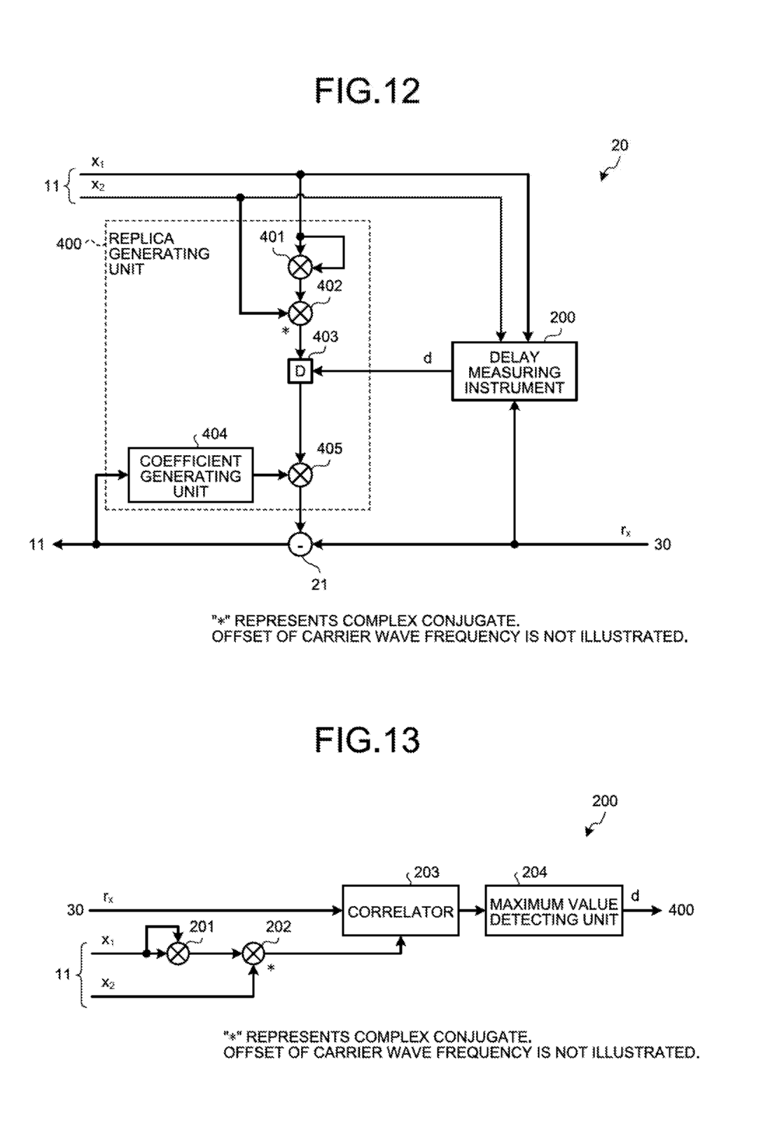

Given below is the explanation of a comparison example. FIG. 12 is a block diagram illustrating an example of the PIM canceller 20 according to the comparison example. The PIM canceller 20 according to the comparison example includes the combining unit 21, a delay measuring instrument 200, and a replica generating unit 400. The delay measuring instrument 200 generates an intermodulation signal based on the transmission signals x₁ and x₂ output from the BBU 11, and measures a delay amount d of the generated intermodulation signal based on the correlation between the intermodulation signal and the reception signal rₓ output from the RRE 30.

The replica generating unit 400 includes multipliers 401 and 402, a delay setting unit 403, a coefficient generating unit 404, and a multiplier 405. The multiplier 401 calculates the square of the transmission signal x₁ output from the BBU 11. The multiplier 402 multiplies the square of the transmission signal x₁ as calculated by the multiplier 401 to the complex conjugate of the transmission signal x₂ output from the BBU 11, and generates an intermodulation signal.

The delay setting unit 403 delays the intermodulation signal, which is generated by the multiplier 402, by the delay amount d measured by the delay measuring instrument 200. The coefficient generating unit 404 calculates a coefficient for adjusting the amplitude and the phase of the intermodulation signal, which has been delayed by the delay setting unit 403, with the aim of cancelling out the detected intermodulation signal component included in the reception signal output from the combining unit 21. The multiplier 405 multiplies the coefficient, which is calculated by the coefficient generating unit 404, to the intermodulation signal delayed by the delay setting unit 403; and adjusts the amplitude and the phase of the generated intermodulation signal.

FIG. 13 is a block diagram illustrating an example of the delay measuring instrument 200 according to the comparison example. The delay measuring instrument 200 according to the comparison example includes multipliers 201 and 202, a correlator 203, and a maximum value detecting unit 204. The multiplier 201 calculates the square of the transmission signal x₁ output from the BBU 11. The multiplier 202 multiplies the square of the transmission signal x₁ as calculated by the multiplier 201 to the complex conjugate of the transmission signal x₂ output from the BBU 11, and generates an intermodulation signal.

The correlator 203 calculates the correlation values between the reception signal rₓ, which is output from the RRE 30, and the intermodulation signal, which is generated by the multiplier 202, while varying the setting of the amount of delay of the intermodulation signal generated by the multiplier 202. The maximum value detecting unit 204 detects the maximum correlation value from among the correlation values calculated by the correlator 203. Then, the maximum value detecting unit 204 outputs, as the delay amount d of the intermodulation signal, the amount of delay corresponding to the detected maximum correlation value to the replica generating unit 400.

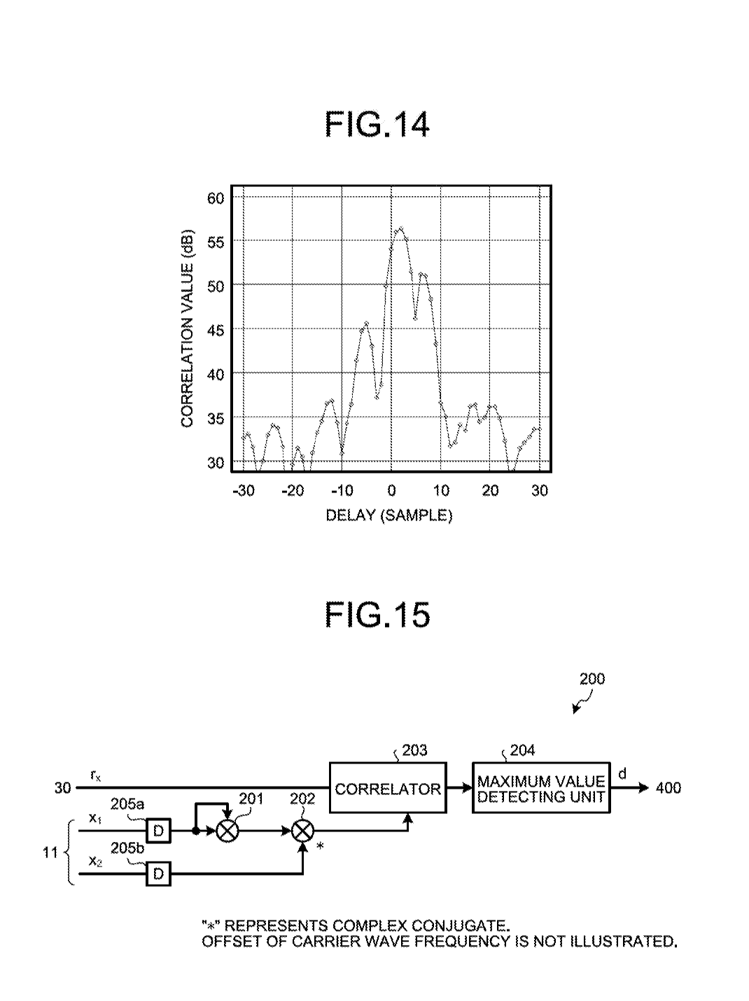

In the comparison example, the amounts of delay of the transmission signals that are responsible for the occurrence of the intermodulation signal are not taken into account. For that reason, the intermodulation signal generated according to the comparison example happens to have a different waveform than the waveform of the intermodulation signal included in the reception signal. For that reason, if the correlation between the intermodulation signal generated according to the comparison example and the reception signal is calculated, the result is as illustrated in FIG. 14, for example. FIG. 14 is a diagram illustrating an example of the delay profile of the intermodulation signal generated according to the comparison example. In FIG. 14, the horizontal axis represents amounts of delay of the generated intermodulation signal with respect to the intermodulation signal included in the reception signal, and the vertical axis represents correlation values between the reception signal and the generated intermodulation signal.

In the comparison example, the transmission signals that are responsible for the occurrence of the intermodulation signal included in the reception signal have different amounts of delay than the amounts of delay of the transmission signals used in generating an intermodulation signal. Hence, the maximum correlation value between the reception signal and the generated intermodulation signal corresponds to an amount of delay other than the amount of delay equal to zero. For that reason, it is a difficult task to combine the generated intermodulation signal in tune with the timing of the intermodulation signal included in the reception signal, and thus it is difficult to sufficiently cancel out the intermodulation signal included in the reception signal.

Moreover, in the comparison example, since the transmission signals that are responsible for the occurrence of the intermodulation signal included in the reception signal have different amounts of delay than the amounts of delay of the transmission signals used in generating an intermodulation signal, the generated intermodulation signal happens to have a different waveform than the waveform of the intermodulation signal included in the reception signal. Hence, even if the generated intermodulation signal is combined in tune with the timing of the intermodulation signal included in the reception signal, it is still difficult to sufficiently cancel out the intermodulation signal included in the reception signal.

Meanwhile, for example, as illustrated in FIG. 15, it is possible to think of individually adjusting the amounts of delay of the transmission signals x₁ and x₂ using delay setting units 205a and 205b, respectively. In the example illustrated in FIG. 15, while varying the amounts of delay set in the delay setting units 205a and 205b, such a combination of the amounts of delay can be obtained for which the correlation value is the maximum value. As a result, the amounts of delay of the transmission signals used in generating an intermodulation signal can be approximated to the amounts of delay of the transmission signals that are responsible for the occurrence of the intermodulation signal included in the reception signal.

However, in the example illustrated in FIG. 15, if there are, for example, 100 amounts of delay set for each of the transmission signals x₁ and x₂; the correlator 203 happens to calculate the correlation value for 10000 combinations of the amounts of delay. Thus, in the delay measuring instrument 200 according to the comparison example as illustrated in FIG. 15, the processing load becomes high.

In contrast, in the delay measuring instrument 50 according the first embodiment as illustrated in FIG. 5, if there are, for example, 100 first amounts of delay set for each of the transmission signals x₁ and x₂; then 100 first amounts of delay are set in each of the variable delay units 503a and 503b. For that reason, in the delay measuring instrument 50 according to the first embodiment, the correlator 501 has to calculate the correlation values for a total of 200 first amounts of delay. Thus, in the delay measuring instrument 50 according to the first embodiment, the amount of delay of each of the transmission signals x₁ and x₂ can be accurately calculated while holding down an increase in the processing load. As a result, the PIM canceller 20 according to the first embodiment can generate an intermodulation signal having a close waveform to the waveform of the intermodulation signal included in the reception signal, and thus can accurately cancel out the intermodulation signal included in the reception signal.

Meanwhile, in the case in which the transmission signals x₁ and x₂ represent the components of the transmission stream that generates the intermodulation signal S_{PIM}, the intermodulation signal S_{PIM} is expressed as Equation (1) given above. Herein, in the case of measuring the delay amount d₁ of the transmission signal x₁, as long as it is possible to calculate the correlation between the component of the transmission signal x₂(t), which generates the intermodulation signal S_{PIM}, and the transmission signal x₂(t+nΔt₁), which is delayed by the first amount of delay by the variable delay unit 503a; it serves the purpose. Herein, nΔt₁ corresponds to each first amount of delay. Hence, Δt₁ representing the time resolution of the first amounts of delay can be set to have the coarseness up to the duration for which it is expressed as the reciprocal of a signal bandwidth BW of the transmission signal x₂(t). Thus, in the delay measuring instrument 50 according to the first embodiment, it becomes possible to reduce the number of first amounts of delay set for the transmission signals x₁ and x₂, and to further hold down an increase in the processing load.

Another Example of Delay Measuring Instrument 50 According to First Embodiment

In the first embodiment described above, at the time of measuring the delay amount d₁ of the transmission signal x₁; the transmission signal x₂ that has been delayed by the first amount of delay by the variable delay unit 503a is multiplied to the reception signal rₓ, and the intermediate signal Sₘ₁ is calculated. However, the technology disclosed herein is not limited to that example. Alternatively, for example, the intermediate signal Sₘ₁ can be calculated by multiplying the complex conjugate of the transmission signal x₁ and by multiplying the transmission signal x₂, which has been delayed by the first-amount of delay by the variable delay unit 503a, to the reception signal rₓ. For example, when the complex conjugate of the transmission signal x1 and the transmission signal x₂ are multiplied to the intermodulation signal S_{PIM} given above in Equation (1), the intermediate signal Sₘ₁ representing the multiplication result can be expressed as given below in Equation (4), for example.

Sₘ₁=S_{PIM}·x₁*·x₂=(A₃+A₅₁|x₁|²+A₅₂|x₂|²+ . . . )x₁²·x₂*·x₁*·x₂=(A₃+A₅₁|x₁|²+A₅₂|x₂|²+ . . . ) |x₂|²·|x₁|²·x₁ (4)

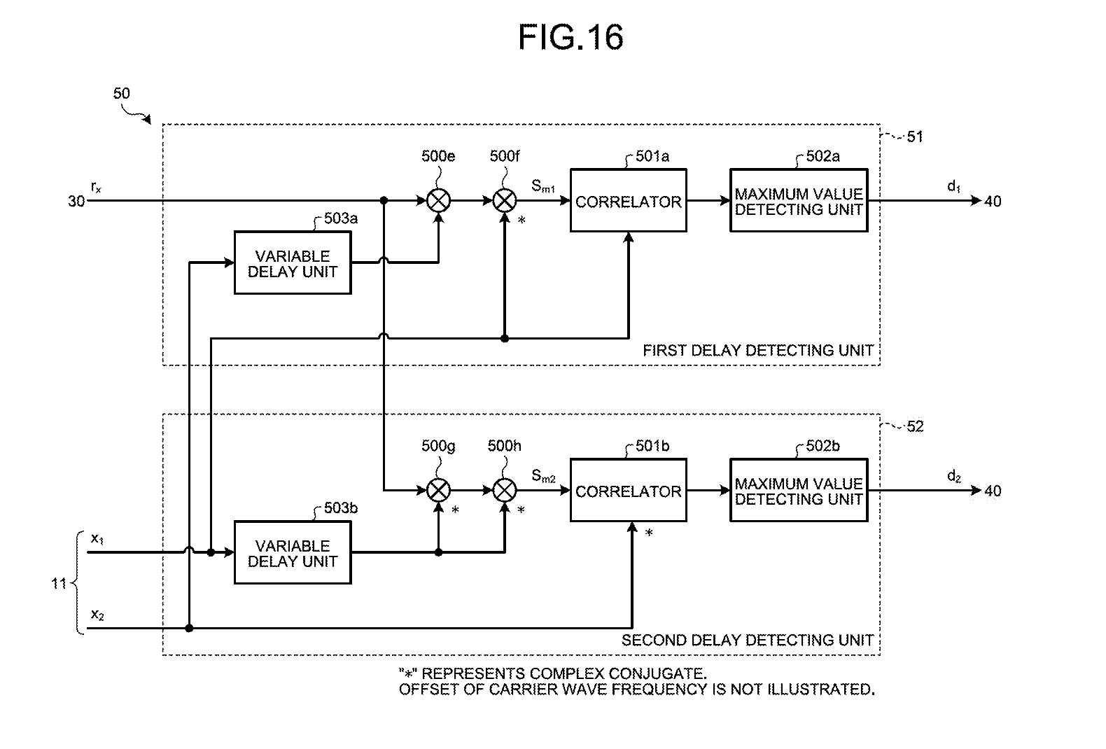

In Equation (4) given above, since the component of the transmission signal x₁ is still present, it becomes possible to calculate the correlation between the intermediate signal Sₘ₁ and the transmission signal x₁. The delay measuring instrument 50 that implements Equation (4) given above becomes as illustrated in FIG. 16. Herein, FIG. 16 is a block diagram illustrating another example of the delay measuring instrument 50 according to the first embodiment. The delay measuring instrument 50 illustrated in FIG. 16 differs from the delay measuring instrument 50 illustrated in FIG. 5 also in the way that, in the calculation of the delay amount d₂ of the transmission signal x₂, the intermediate signal Sₘ₂ is calculated by multiplying the complex conjugate of the transmission signal x₁ twice to the reception signal rₓ.

The delay measuring instrument 50 illustrated in FIG. 16 includes the first delay detecting unit 51 and the second delay detecting unit 52. The first delay detecting unit 51 includes multipliers 500e and 500f, the correlator 501a, a maximum value detecting unit 502a, and a variable delay unit 503a. The second delay detecting unit 52 includes multipliers 500g and 500h, the correlator 501b, a maximum value detecting unit 502b, and a variable delay unit 503b. The multipliers 500e to 500h are complex multipliers, for example. Meanwhile, except for the points explained below, the blocks in FIG. 16 which are referred to by the same reference numerals as in FIG. 5 have the same or identical functions as the blocks illustrated in FIG. 5. Hence, their explanation is not repeated.

The multiplier 500e multiplies the transmission signal x₂, which has been delayed by the first amount of delay by the variable delay unit 503a, to the reception signal rₓ output from the RRE 30. The multiplier 500f multiplies the complex conjugate of the transmission signal x₁, which is output from the BBU 11, to the multiplication result obtained by the multiplier 500e; and generates the intermediate signal Sₘ₁. The correlator 501a calculates the correlation values between the intermediate signal Sₘ₁, which is calculated by the multiplier 500f, and the transmission signal x₁, which is output from the BBU 11, while varying the setting of the amount of delay of the transmission signal x₁.

The multiplier 500g multiplies the complex conjugate of the transmission signal x₁, which has been delayed by the first amount of delay by the variable delay unit 503b, to the reception signal rₓ output from the RRE 30. The multiplier 500h multiplies the complex conjugate of the transmission x₁, which has been delayed by the first amount of delay by the variable delay unit 503b, to the multiplication result obtained by the multiplier 500g; and generates the intermediate signal Sₘ₂. The correlator 501b calculates the correlation values between the intermediate signal Sₘ₂, which is calculated by the multiplier 500h, and the complex conjugate of the transmission signal x₂ while varying the setting of the amount of delay of the complex conjugate of the transmission signal x₂.

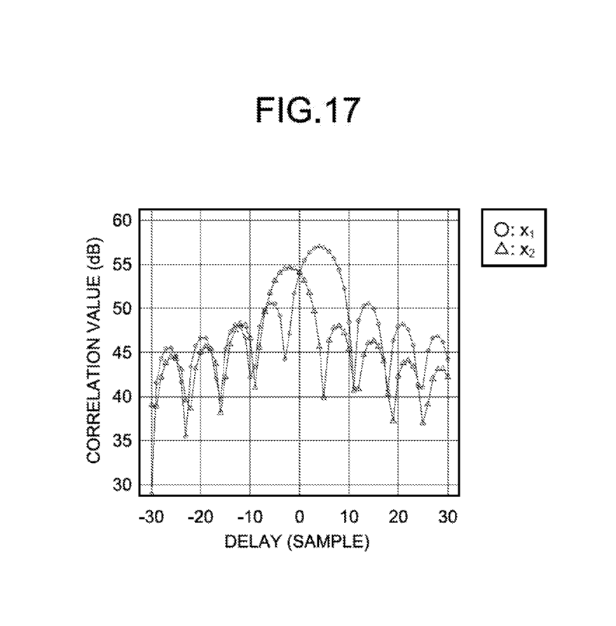

Regarding each transmission signal, a delay profile calculated by the delay measuring instrument 50 illustrated in FIG. 16 is as illustrated in FIG. 17, for example. FIG. 17 is a diagram illustrating an example of the delay profile of each transmission signal. In FIG. 17, the horizontal axis represents amounts of delay of each transmission signal with respect to the intermodulation signal, and the vertical axis represents correlation values. Moreover, in FIG. 17, open circles represent the correlation values between the intermediate signal Sₘ₁ and the transmission signal x₁, and open triangles represent the correlation values between the intermediate signal Sₘ₂ and the complex conjugate of the transmission signal x₂. Furthermore, in FIG. 17, the illustrated correlation values represent correlation values with a reception signal that includes an intermodulation signal resulting from the transmission signal x₁ having the amount of delay of +4 samples and the transmission signal x₂ having the amount of delay of −2 samples. Meanwhile, the sampling frequency and the sampling interval Δt₂ are identical to FIG. 10.

Effect of First Embodiment

The explanation given above is about the first embodiment. The communication device 10 according to the first embodiment includes the RRE 30, the delay measuring instrument 50, the replica generating unit 40, and the combining unit 21. The RRE 30 transmits a plurality of transmission signals at mutually different frequencies. Moreover, the RRE 30 receives a reception signal that includes an intermodulation signal resulting from the transmission signals. The delay measuring instrument 50 measures the amount of delay of each of a plurality of transmission signals. The replica generating unit 40 generates an intermodulation signal from the transmission signals based on the amount of delay of each transmission signal as measured by the delay measuring instrument 50. The combining unit 21 combines the intermodulation signal, which is generated by the replica generating unit 40, and the reception signal; and cancels out the intermodulation signal included in the reception signal. The delay measuring instrument 50 includes the variable delay units 503a and 503b, the multipliers 500b and 500d, and the maximum value detecting units 502a and 502b. The variable delay unit 503a as well as the variable delay unit 503b generates a delay signal that includes a signal formed by delaying one of a plurality of transmission signals by the first amount of delay. The multiplier 500b multiplies the delay signal, which is generated by the variable delay unit 503a, to the reception signal; and generates an intermediate signal. The multiplier 500d multiplies the complex conjugate of the delay signal, which is generated by the variable delay unit 503b, to the reception signal; and generates an intermediate signal. The maximum value detecting unit 502a as well as the maximum value detecting unit 502b calculates, based on an intermediate signal and the other transmission signals, the amounts of delay of the other transmission signals with respect to the intermodulation signal. As a result, in the communication device 10 according to the first embodiment, the intermodulation signal included in the reception signal can be cancelled out with accuracy.

Moreover, in the first embodiment, while varying a plurality of different first amounts of delay, the variable delay units 503a and 503b delay one of a plurality of transmission signals, which are responsible for the occurrence of the intermodulation signal, by the first amount of delay. Then, based on the correlation values between the intermediate signal and the other transmission signals for each first amount of delay, the maximum value detecting units 502a and 502b calculate the amounts of delay of the other transmission signals with respect to the intermodulation signal. As a result, in the communication device 10 according to the first embodiment, it becomes possible to accurately obtain the amount of delay of each transmission signal that is responsible for the occurrence of the intermodulation signal included in the reception signal.

Furthermore, in the first embodiment, the delay measuring instrument 50 includes the correlators 501a and 501b. The correlator 501a as well as the correlator 501b delays the other transmission signals with respect to an intermediate signal by second amounts of delay, and calculates the correlation values between the other transmission signals delayed by the second amounts of delay and the intermediate signal. The correlators 501a and 501b calculate, while varying a plurality of different second amounts of display, the correlation values for each second amount of delay. Meanwhile, the difference between two first amounts of delay is greater than the difference between two second amounts of delay. Hence, in the communication device 10 according to the first embodiment, it becomes possible to reduce the processing load at the time of obtaining the amount of delay of each transmission signal that is responsible for the occurrence of the intermodulation signal included in the reception signal.

Moreover, in the first embodiment, a plurality of transmission signals includes the transmission signals x₁ and x₂ that are transmitted at different frequencies. The delay measuring instrument 50 includes the variable delay unit 503b that delays the transmission signal x₁ by the first amount of delay, and includes the variable delay unit 503a that delays the transmission signal x₂ by the first amount of delay. The delay measuring instrument 50 further includes the multiplier 500b that multiplies the transmission signal x₂, which has been delayed by the variable delay unit 503a, to the reception signal rₓ and generates the intermediate signal Sₘ₁; and includes the multiplier 500d that multiplies the complex conjugate of the square of the transmission signal x₁, which has been delayed by the variable delay unit 503b, to the reception signal and generates the intermediate signal Sₘ₂. The delay measuring instrument 50 further includes the maximum value detecting unit 502a that, based on the correlation value between the intermediate signal Sₘ₁ and the square of the transmission signal x₁ for each first amount of delay, calculates the delay amount d₁ of the transmission signal x₁ with respect to the intermodulation signal; and includes the maximum value detecting unit 502b that, based on the correlation value between the intermediate signal Sₘ₂ and the complex conjugate of the transmission signal x₂ for each first amount of delay, calculates the delay amount d₂ of the transmission signal x₂ with respect to the intermodulation signal. As a result, in the communication device 10 according to the first embodiment, the intermodulation signal included in the reception signal can be cancelled out with accuracy.

### [b] Second Embodiment

In the communication device 10 according to the first embodiment, the delay amount d₁ of the transmission signal x₁ and the delay amount d₂ of the transmission signal x₂ are calculated independent of each other. In contrast, in the communication device 10 according to a second embodiment, calculates the delay amount d₁ of the transmission signal x₁ while varying the first amount of delay used in delaying the transmission signal x₂; and, at the time of calculating the delay amount d₂ of the transmission signal x₂, uses the calculated delay amount d₁ of the transmission signal x₁ and calculates the delay amount d₂ of the transmission signal x₂. In the second embodiment, after the delay amount d₁ of the transmission signal x₁ is calculated, the delay amount d₂ of the transmission signal x₂ is calculated using the calculated delay amount d₁. However, the technology disclosed herein is not limited to that example. Alternatively, after the delay amount d₂ of the transmission signal x₂ is calculated, the delay amount d₁ of the transmission signal x₁ can be calculated using the calculated delay amount d₂. Still alternatively, after the delay amount d₁ of the transmission signal x₁ is calculated, the delay amount d₂ of the transmission signal x₂ can be calculated using the calculated delay amount d₁, and the delay amount d₁ of the transmission signal x₁ can be further calculated using the calculated delay amount d₂. Still alternatively, the operation of calculating the delay amount d₂ of the transmission signal x₂ using the calculated delay amount d₁ and the operation of calculating the delay amount d₁ of the transmission signal x₁ using the calculated delay amount d₂ can be performed in an alternate manner for several times.

Delay Measuring Instrument 50

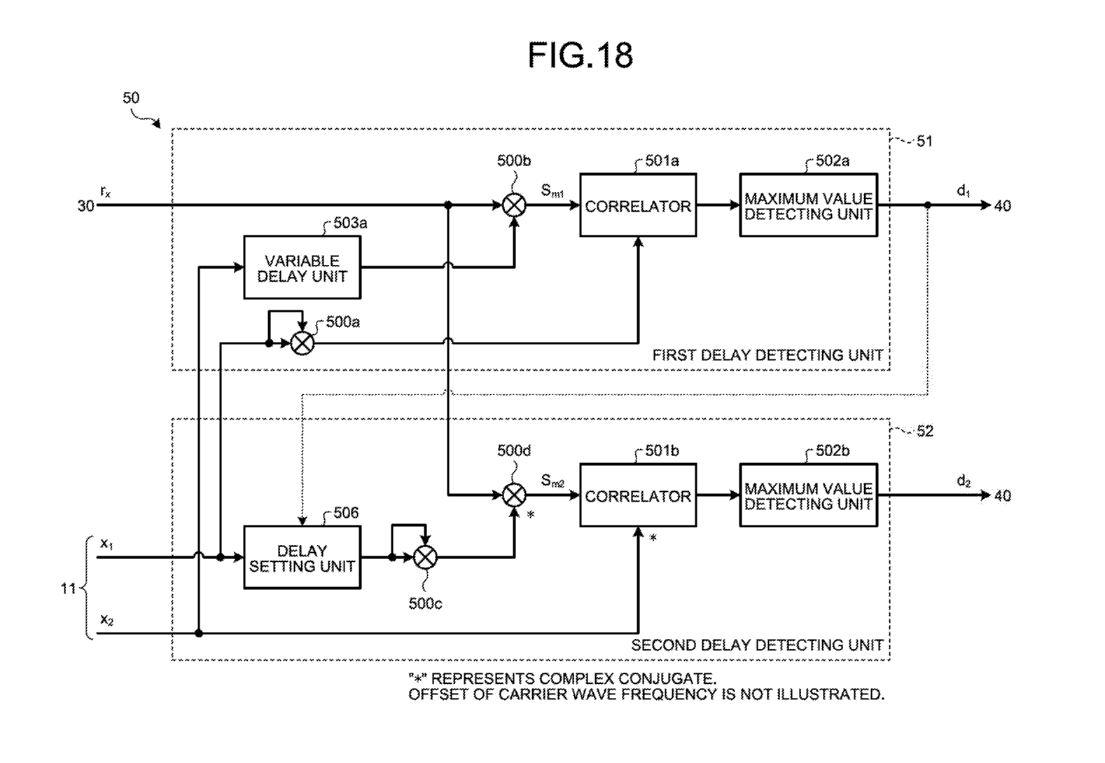

FIG. 18 is a block diagram illustrating an example of the delay measuring instrument 50 according to the second embodiment. The delay measuring instrument 50 according to the second embodiment includes the first delay detecting unit 51 and the second delay detecting unit 52. The first delay detecting unit 51 includes the multipliers 500a and 500b, the correlator 501a, the maximum value detecting unit 502a, and the variable delay unit 503a. The second delay detecting unit 52 includes the multipliers 500c and 500d, the correlator 501b, the maximum value detecting unit 502b, and a delay setting unit 506. Herein, the delay setting unit 506 represents an example of a first delaying unit. Meanwhile, except for the points explained below, the blocks in FIG. 18 which are referred to by the same reference numerals as in FIG. 5 have the same or identical functions as the blocks illustrated in FIG. 5. Hence, their explanation is not repeated.

The maximum value detecting unit 502a identifies the delay amount d₁ of the transmission signal x₁ and outputs the identified delay amount d₁ to the delay setting unit 506. The delay setting unit 506 delays the transmission signal x₁, which is output from the BBU 11, by the delay amount d₁ output from the maximum value detecting unit 502a. The multiplier 500c calculates the square of the transmission signal x₁ that has been delayed by the delay setting unit 506.

Delay Amount Measurement Operation

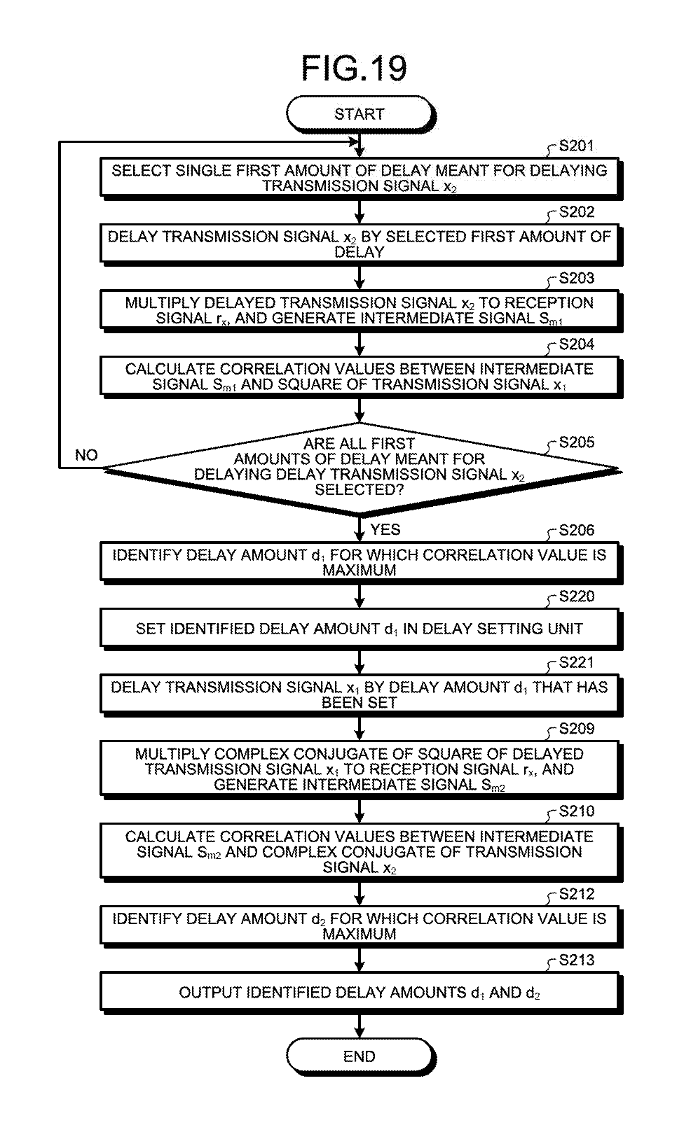

FIG. 19 is a flowchart for explaining an example of a delay amount measurement operation performed according to the second embodiment. The delay amount measurement operation illustrated in FIG. 19 is performed by the delay measuring instrument 50. Meanwhile, except for the operations explained below, the operations in FIG. 19 which are referred to by the same reference numerals as in FIG. 9 are identical operations to FIG. 9. Hence, their explanation is not repeated.

Firstly, the operations from Steps S201 to S206 are performed in an identical manner to FIG. 9. Then, the maximum value detecting unit 502a outputs the delay amount d₁, which is identified at Step S206, to the delay setting unit 506. With that, the delay amount d₁, which is identified by the maximum value detecting unit 502a, is set in the delay setting unit 506 (S220). Then, the delay setting unit 506 delays the transmission signal x₁, which is output from the BBU 11, by the delay amount d₁ set therein (S221). The multiplier 500c calculates the square of the transmission signal x₁ that has been delayed by the delay setting unit 506. That is followed by the operations at Steps S209, S210, S212, and S213. Meanwhile, at Step S220, instead of setting the delay amount d₁ identified by the maximum value detecting unit 502a, the first amount of delay closest to the delay amount d₁ can alternatively be set in the delay setting unit 506.

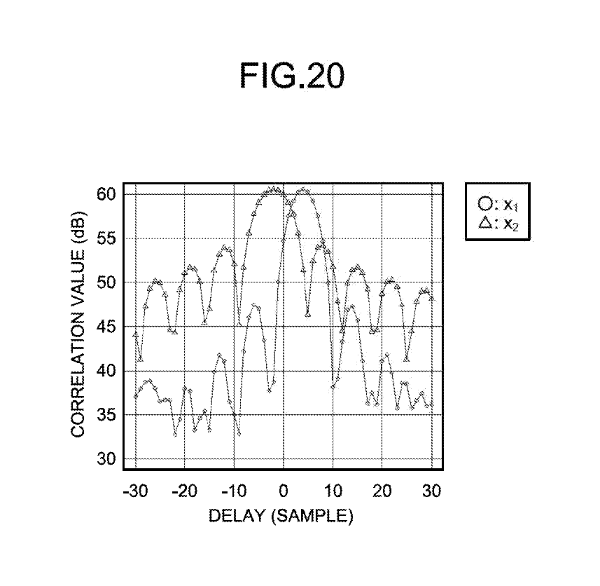

Regarding each transmission signal, a delay profile calculated by the delay measuring instrument 50 according to the second embodiment is as illustrated in FIG. 20, for example. FIG. 20 is a diagram illustrating an example of the delay profile of each transmission signal. In FIG. 20, the horizontal axis represents amounts of delay of each transmission signal with respect to the intermodulation signal, and the vertical axis represents correlation values. Moreover, in FIG. 20, open circles represent the correlation values between the intermediate signal Sₘ₁ and the square of the transmission signal x₁, and open triangles represent the correlation values between the intermediate signal Sₘ₂ and the complex conjugate of the transmission signal x₂. Furthermore, in FIG. 20, the illustrated correlation values represent correlation values with a reception signal that includes an intermodulation signal resulting from the transmission signal x₁ having the amount of delay of +4 samples and the transmission signal x₂ having the amount of delay of −2 samples. Meanwhile, the sampling frequency and the sampling interval Δt₂ are identical to FIG. 10.

Another Example of Delay Measuring Instrument 50 According to Second Embodiment

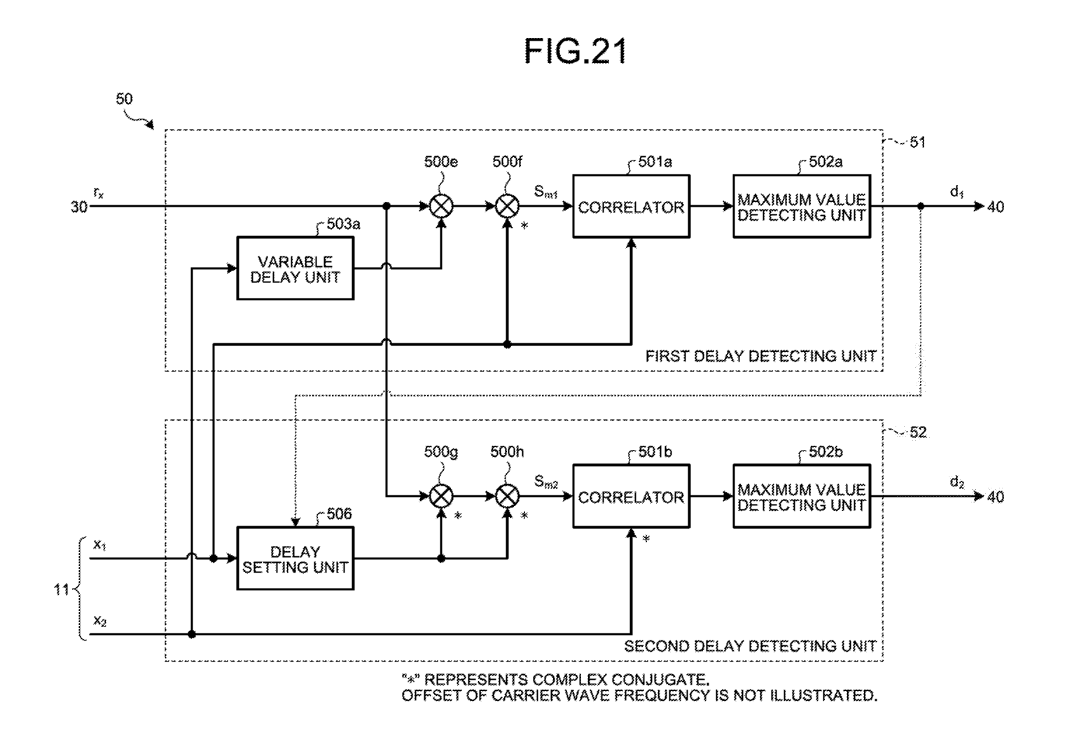

In the second embodiment too, at the time of measuring the delay amount d₁ of the transmission signal x₁, the intermediate signal Sₘ₁ can be calculated by multiplying the complex conjugate of the transmission signal x₁ and by multiplying the transmission signal x₂, which has been delayed by the first amount of delay by the variable delay unit 503a, to the reception signal rₓ. FIG. 21 is a block diagram illustrating another example of the delay measuring instrument 50 according to the second embodiment. The delay measuring instrument 50 illustrated in FIG. 21 differs from the delay measuring instrument 50 illustrated in FIG. 18 also in the way that, in the calculation of the delay amount d₂ of the transmission signal x₂, the intermediate signal Sₘ₂ is calculated by multiplying the complex conjugate of the transmission signal x₁ twice to the reception signal rₓ.

The delay measuring instrument 50 illustrated in FIG. 21 includes the first delay detecting unit 51 and the second delay detecting unit 52. The first delay detecting unit 51 includes the multipliers 500e and 500f, the correlator 501a, the maximum value detecting unit 502a, and the variable delay unit 503a. The second delay detecting unit 52 includes the multipliers 500g and 500h, the correlator 501b, the maximum value detecting unit 502b, and the delay setting unit 506. Meanwhile, except for the points explained below, the blocks in FIG. 21 which are referred to by the same reference numerals as in FIG. 16 or FIG. 18 have the same or identical functions as the blocks illustrated in FIG. 16 or FIG. 18. Hence, their explanation is not repeated.

The multiplier 500g multiplies the complex conjugate of the transmission signal x₁, which has been delayed by the first delay amount d₁ by the delay setting unit 506, to the reception signal rₓ output from the RRE 30. The multiplier 500h multiplies the complex conjugate of the transmission x₁, which has been delayed by the delay amount d₁ by the delay setting unit 506, to the multiplication result obtained by the multiplier 500g; and generates the intermediate signal Sₘ₂.

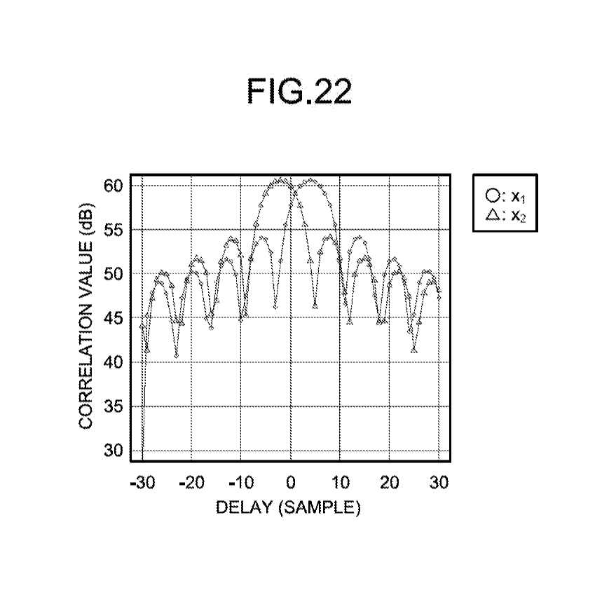

Regarding each transmission signal, a delay profile calculated by the delay measuring instrument 50 illustrated in FIG. 21 is as illustrated in FIG. 22, for example. FIG. 22 is a diagram illustrating an example of the delay profile of each transmission signal. In FIG. 22, the horizontal axis represents amounts of delay of each transmission signal with respect to the intermodulation signal, and the vertical axis represents correlation values. Moreover, in FIG. 22, open circles represent the correlation values between the intermediate signal Sₘ₁ and the transmission signal x₁, and open triangles represent the correlation values between the intermediate signal Sₘ₂ and the complex conjugate of the transmission signal x₂. Furthermore, in FIG. 22, the illustrated correlation values represent correlation values with a reception signal that includes an intermodulation signal resulting from the transmission signal x₁ having the amount of delay of +4 samples and the transmission signal x₂ having the amount of delay of −2 samples. Meanwhile, the sampling frequency and the sampling interval Δt₂ are identical to FIG. 10.

Effect of Second Embodiment

The explanation given above is about the second embodiment. In the communication device 10 according to the second embodiment, the delay amount d₁ of the transmission signal x₁ is calculated while varying the first amount of delay meant for delaying the transmission signal x₂ and, at the time of calculating the delay amount d₂ of the transmission signal x₂, the calculated delay amount d₁ of the transmission signal x₁ is used to calculate the delay amount d₂ of the transmission signal x₂.

### [c] Third Embodiment

In the first and second embodiments, the explanation is given about the communication device 10 in which an intermodulation signal, which results from the transmission signals x₁ and x₂ that are transmitted at two different frequencies, is cancelled out. In a third embodiment, the explanation is given about cancelling out an intermodulation signal resulting from transmission signals x₁, x₂, and x₃ that are transmitted at three different frequencies. In the following explanation, f₁ is defined as the frequency of the transmission signal x₁, f₂ is defined as the frequency of the transmission signal x₂, and f₃ is defined as the frequency of the transmission signal x₃; and it is assumed that f₁<f₂<f₃ holds true. The transmission signal x₁ represents an example of a first transmission signal, the transmission signal x₂ represents an example of a second transmission signal, and the transmission signal x₃ represents an example of a third transmission signal.

Of the intermodulation signal S_{PIM} resulting from the transmission signals x₁, x₂, and x₃; the intermodulation signal S_{PIM} having the frequency f₁+f₂−f₃ is expressed using, for example, Equation (5) given below. Herein, the offset frequency of the carrier wave is omitted.

S_{PIM}=(A₃+A₅₁|x₁|²+A₅₂|x₂²+A₅₃|x₃|²+ . . . )x₁·x₂·x₃* (5)

When the complex conjugate of the transmission signal x₂ and the transmission signal x₃ are multiplied to the intermodulation signal S_{PIM} given above in Equation (5), the intermediate signal Sₘ₁ representing the multiplication result is expressed using, for example, Equation (6) given below.

Sₘ₁=S_{PIM}·x₂*·x₃=K·x₁·x₂·x₃*·x₂*·x₃=K·|x₂|²·|x₃|²·x₁ (6)

Herein, K represents (A₃+A₅₁|x₁|²+A₅₂|x₂|²+A₅₃|x₃|²+ . . . ).

In Equation (6) given above, the components of the transmission signals x₂ and x₃ are real numbers and represent the change in the amplitude component. Thus, it becomes possible to calculate the correlation between the intermediate signal Sₘ₁ given above in Equation (6) and the transmission signal x₁. With respect to the intermediate signal Sₘ₁ given above in Equation (6), the correlation values between the intermediate signal Sₘ₁ and the transmission signal x₁ are calculated while varying the amount of delay of the transmission signal x₁; and the amount of delay for which the correlation value becomes the maximum value represents the delay amount d₁ of the transmission signal x₁ that is responsible for the occurrence of the intermodulation signal S_{PIM}.

Meanwhile, when the complex conjugate of the square of the transmission signal x₁ and the transmission signal x₃ are multiplied to the intermodulation signal S_{PIM} given above in Equation (5), the intermediate signal Sₘ₂ representing the multiplication result is expressed using, for example, Equation (7) given below.

Sₘ₂=S_{PIM}·x₁*·x₃=K·x₁·x₂·x₃*·x₁*·x₃=K·|x₁|²·|x₃|²·x₂· (7)

Herein, K represents (A₃+A₅₁|x₁|²+A₅₂|x₂|²+A₅₃|x₃|²+ . . . ).

In Equation (7) given above, the components of the transmission signals x₁ and x₃ are real numbers and represent the change in the amplitude component. Thus, it becomes possible to calculate the correlation between the intermediate signal Sₘ₂ given above in Equation (7) and the transmission signal x₂. With respect to the intermediate signal Sₘ₂ given above in Equation (7), the correlation values between the intermediate signal Sₘ₂ and the transmission signal x₂ are calculated while varying the amount of delay of the transmission signal x₁; and the amount of delay for which the correlation value becomes the maximum value represents the delay amount d₂ of the transmission signal x₂ that is responsible for the occurrence of the intermodulation signal S_{PIM}.

When the complex conjugate of the transmission signal x1 and the complex conjugate of the transmission signal x₂ are multiplied to the intermodulation signal S_{PIM} given above in Equation (5), an intermediate signal Sₘ₃ representing the multiplication result can be expressed as given below in Equation (8), for example.

Sₘ₃=S_{PIM}·x₁*·x₂*=K·x₁·x₂·x₃*·x₁*·x₂*=K·|x₁|²·|x₂|²·x₃* (8)

Herein, K represents (A₃+A₅₁|x₁|²+A₅₂|x₂|²+A₅₃|x₃|²+ . . . ).

In Equation (8) given above, the components of the transmission signals x₁ and x₂ are real numbers and represent the change in the amplitude component. Thus, it becomes possible to calculate the correlation between the intermediate signal Sₘ₃ given above in Equation (8) and the complex conjugate of the transmission signal x₃. With respect to the intermediate signal Sₘ₃ given above in Equation (8), the correlation values between the intermediate signal Sₘ₃ and the complex conjugate of the transmission signal x₃ are calculated while varying the amount of delay of the transmission signal x₃; and the amount of delay for which the correlation value becomes the maximum value represents a delay amount d₃ of the transmission signal x₃ that is responsible for the occurrence of the intermodulation signal S_{PIM}.

Given below is the explanation of an example of a specific functional block of the delay measuring instrument 50 that implements the operations according to the third embodiment.

Delay Measuring Instrument 50

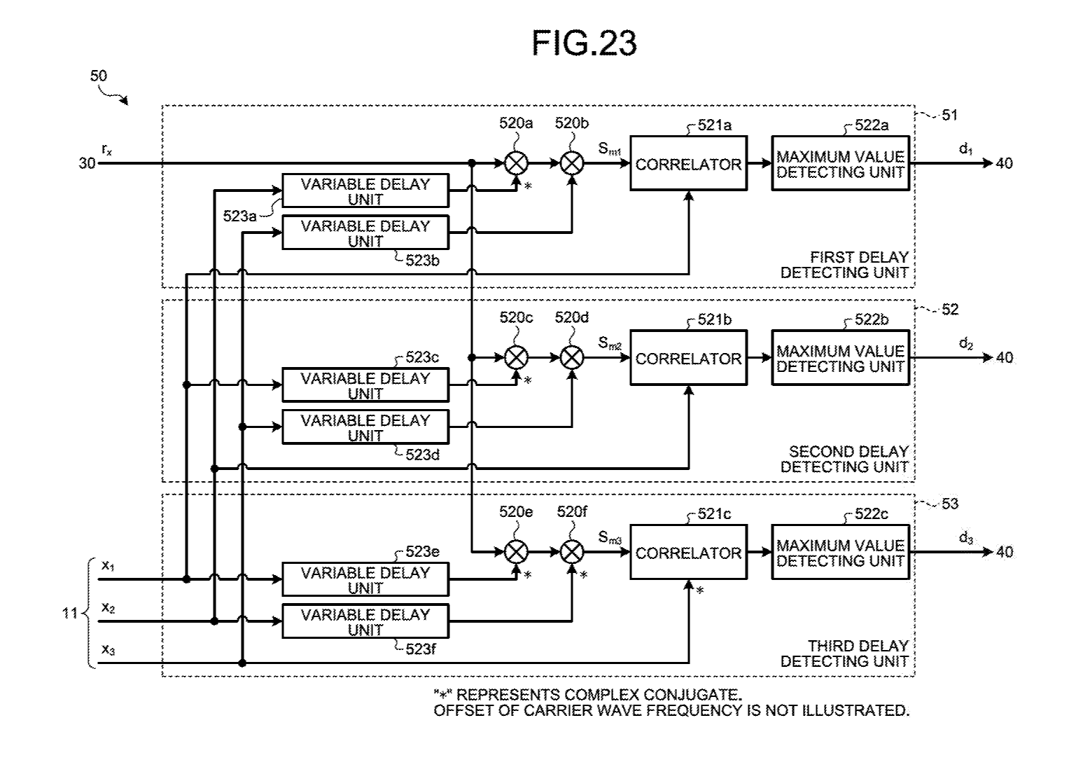

FIG. 23 is a block diagram illustrating an example of the delay measuring instrument 50 according to the third embodiment. The delay measuring instrument 50 according to the third embodiment includes the first delay detecting unit 51 that calculates the delay amount d₁ of the transmission signal x₁, the second delay detecting unit 52 that calculates the delay amount d₂ of the transmission signal x₂, and a third delay detecting unit 53 that calculates the delay amount d₃ of the transmission signal x₃. The first delay detecting unit 51 includes multipliers 520a and 520b, a correlator 521a, a maximum value detecting unit 522a, and variable delay units 523a and 523b. The second delay detecting unit 52 includes multipliers 520c and 520d, a correlator 521b, a maximum value detecting unit 522b, and variable delay units 523c and 523d. The third delay detecting unit 53 includes multipliers 520e and 520f, a correlator 521c, a maximum value detecting unit 522c, and variable delay units 523e and 523f. The multipliers 520a to 520b are complex multipliers, for example. Moreover, as far as the correlators 521a to 521c are concerned, for example, it is possible to use sliding correlators as illustrated in FIG. 6 or it is possible to use matched filters as illustrated in FIG. 7. The variable delay units 523a to 523f represent examples of a delay signal generating unit. The multipliers 520a to 520f represent examples of an intermediate signal generating unit. The maximum value detecting units 522a to 522c represent examples of a calculating unit.

The variable delay unit 523a delays the transmission signal x₂, which is output from the BBU 11, by the first delay period. The variable delay unit 523b delays the transmission signal x₃, which is output from the BBU 11, by the first delay period. The variable delay unit 523c delays the transmission signal x₁, which is output from the BBU 11, by the first delay period. The variable delay unit 523d delays the transmission signal x₃, which is output from the BBU 11, by the first delay period. The variable delay unit 523e delays the transmission signal x₁, which is output from the BBU 11, by the first delay period. The variable delay unit 523f delays the transmission signal x₂, which is output from the BBU 11, by the first delay period. The variable delay units 523a to 523f delay the respective transmission signals by the first delay period while varying a plurality of predetermined and different first amounts of delay. The variable delay units 523c and 523e represent examples of a first delaying unit; the variable delay units 523a and 523f represent examples of a second delaying unit; and the variable delay units 523b and 523d represent examples of a third delaying unit.

The multiplier 520a multiplies the complex conjugate of the transmission signal x₂, which has been delayed by the variable delay unit 523a, to the reception signal rₓ output from the RRE 30. The multiplier 520b multiplies the transmission signal x₃, which has been delayed by the variable delay unit 523b, to the multiplication result obtained by the multiplier 520a; and generates the intermediate signal Sₘ₁. The multipliers 520a and 520b represent examples of a first generating unit.

The correlator 521a calculates the correlation values between the intermediate signal Sₘ₁ and the transmission signal x₁, which is output from the BBU 11, while varying the setting of the amount of delay of the transmission signal x₁. The maximum value detecting unit 522a detects the maximum correlation value from among the correlation values calculated by the correlator 521a. Then, the maximum value detecting unit 522a outputs, as the delay amount d₁ of the transmission signal x₁, the amount of delay corresponding to the detected maximum correlation value to the replica generating unit 40. The maximum value detecting unit 522a represents an example of a first calculating unit.

The multiplier 520c multiplies the complex conjugate of the transmission signal x₁, which has been delayed by the variable delay unit 523c, to the reception signal rₓ output from the RRE 30. The multiplier 520d multiplies the transmission signal x₃, which has been delayed by the variable delay unit 523d, to the multiplication result obtained by the multiplier 520c; and generates the intermediate signal Sₘ₂. The multipliers 520c and 520d represent examples of a second generating unit.

The correlator 521b calculates the correlation values between the intermediate signal Sₘ₂ and the transmission signal x₂ while varying the setting of the amount of delay of the transmission signal x₂ output from the BBU 11. The maximum value detecting unit 522b detects the maximum correlation value from among the correlation values calculated by the correlator 521b. Then, the maximum value detecting unit 522b outputs, as the delay amount d₂ of the transmission signal x₂, the amount of delay corresponding to the detected maximum correlation value to the replica generating unit 40. The maximum value detecting unit 522b represents an example of a second calculating unit.

The multiplier 520e multiplies the complex conjugate of the transmission signal x₁, which has been delayed by the variable delay unit 523e, to the reception signal rₓ output from the RRE 30. The multiplier 520f multiplies the complex conjugate of the transmission signal x₂, which has been delayed by the variable delay unit 523f, to the multiplication result obtained by the multiplier 520e; and generates the intermediate signal Sₘ₃. The multipliers 520e and 520f represent examples of a third generating unit.

The correlator 521c calculates the correlation values between the intermediate signal Sₘ₃ and the complex conjugate of the transmission signal x₃, which is output from the BBU 11, while varying the setting of the amount of delay of the transmission signal x₃. The maximum value detecting unit 522c detects the maximum correlation value from among the correlation values calculated by the correlator 521c. Then, the maximum value detecting unit 522c outputs, as the delay amount d₃ of the transmission signal x₃, the amount of delay corresponding to the detected maximum correlation value to the replica generating unit 40. The maximum value detecting unit 522c represents an example of a third calculating unit.

Delay Amount Measurement Operation

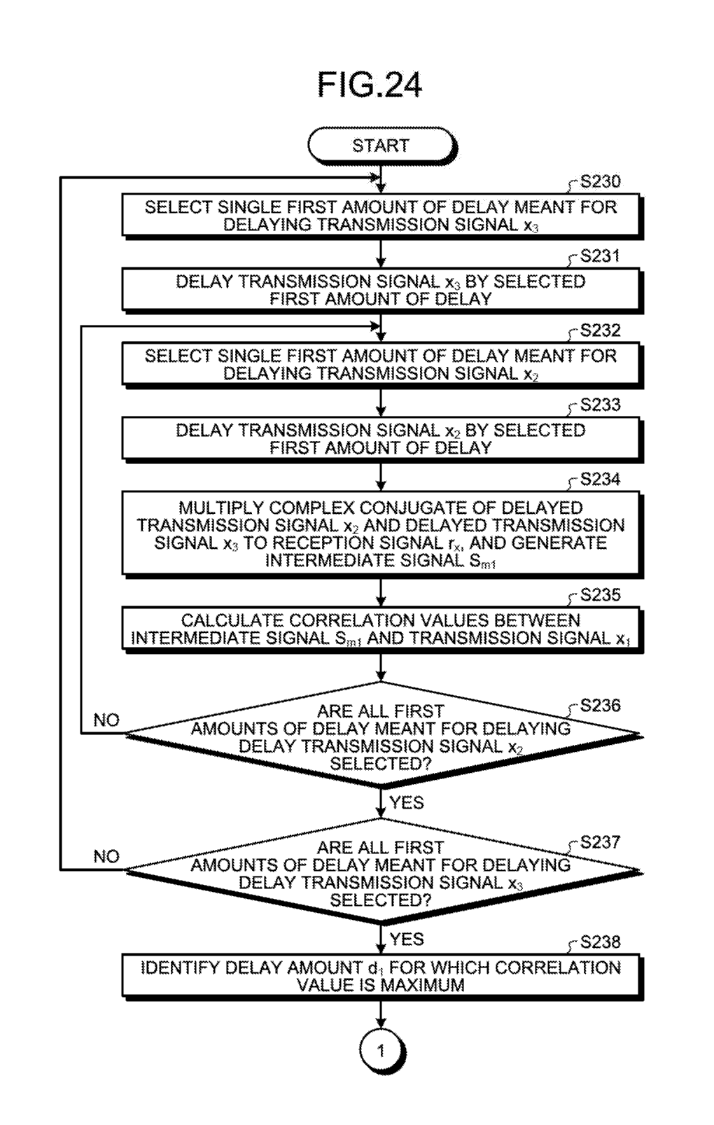

FIGS. 24 to 26 are flowcharts for explaining an example of delay amount measurement operations according to the third embodiment. The delay amount measurement operations illustrated in FIGS. 24 to 26 are performed by the delay measuring instrument 50.

Firstly, the variable delay unit 523b selects, from among a plurality of predetermined and different first amounts of delay, a single amount of delay meant for delaying the transmission signal x₃ (S230). Then, the variable delay unit 523b delays the transmission signal x₃, which is output from the BBU 11, by the selected first amount of delay (S231). Subsequently, the variable delay unit 523a selects, from among a plurality of predetermined and different first amounts of delay, a single amount of delay meant for delaying the transmission signal x₂ (S232). Then, the variable delay unit 523a delays the transmission signal x₂, which is output from the BBU 11, by the selected first amount of delay (S233).

The multiplier 520a multiplies the complex conjugate of the transmission signal x₂, which has been delayed by the variable delay unit 523a. The multiplier 520b multiplies the transmission signal x₃, which has been delayed by the variable delay unit 523b, to the multiplication result obtained by the multiplier 520a; and generates the intermediate signal Sₘ₁ (S234). Then, the correlator 521a calculates the correlation values between the intermediate signal Sₘ₁ and the transmission signal x₁, which is output from the BBU 11, while varying the setting of the amount of delay of the transmission signal x₁ (S235). The maximum value detecting unit 522a detects the maximum correlation value from among the correlation values calculated by the correlator 521a. Then, the maximum value detecting unit 522a holds the detected correlated value in a corresponding manner to the delay amount d₁ of the transmission signal x₁ that corresponds to the detected correlation value.

Subsequently, the variable delay unit 523a determines whether or not all first amounts of delay meant for delaying the transmission signal x₂ have been selected (S236). If any unselected first amount of delay is present (No at S236), then the variable delay unit 523a again performs the operation at Step S232. When all first amounts of delay meant for delaying the transmission signal x₂ are selected (Yes at S236), the variable delay unit 523b determines whether or not all first amounts of delay meant for delaying the transmission signal x₃ have been selected (S237). If any unselected first amount of delay is present (No at S237), then the variable delay unit 523b again performs the operation at Step S230. When all first amounts of delay meant for delaying the transmission signal x₃ are selected (Yes at S237), the maximum value detecting unit 522a identifies the delay amount d₁ for which the correlation value is the maximum value from among the correlation values that are held (S238).

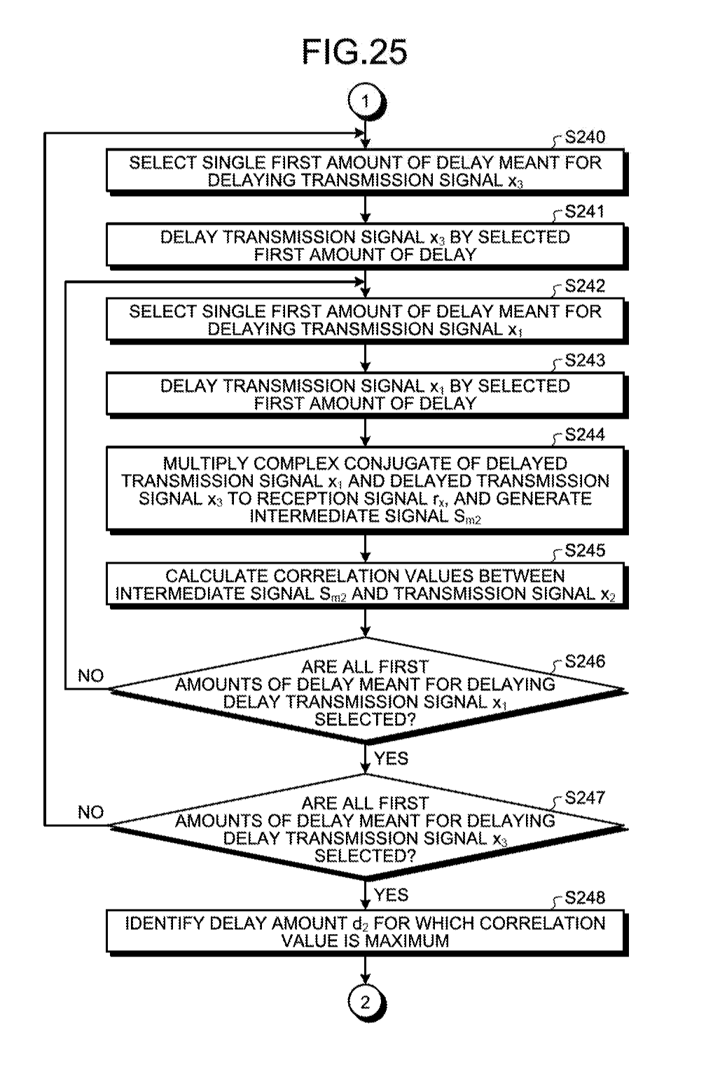

Subsequently, the variable delay unit 523d selects, from among a plurality of predetermined and different first amounts of delay, a single amount of delay meant for delaying the transmission signal x₃ (S240 illustrated in FIG. 25). Then, the variable delay unit 523d delays the transmission signal x₃, which is output from the BBU 11, by the selected first amount of delay (S241). Subsequently, the variable delay unit 523c selects, from among a plurality of predetermined and different first amounts of delay, a single amount of delay meant for delaying the transmission signal x₁ (S242). Then, the variable delay unit 523c delays the transmission signal x₁, which is output from the BBU 11, by the selected first amount of delay (S243).

Subsequently, the multiplier 520c multiplies the complex conjugate of the transmission signal x₁, which has been delayed by the variable delay unit 523c, to the reception signal rₓ output from the RRE 30. The multiplier 520d multiplies the transmission signal x₃, which has been delayed by the variable delay unit 523d, to the multiplication result obtained by the multiplier 520c; and generates the intermediate signal Sₘ₂ (S244). The correlator 521b calculates the correlation values between the intermediate signal Sₘ₂ and the transmission signal x₂, which is output from the BBU 11, while varying the setting of the amount of delay of the transmission signal x₂ (S245). The maximum value detecting unit 522b detects the maximum correlation value from among the correlation values calculated by the correlator 521b. Then, the maximum value detecting unit 522b holds the detected correlated value in a corresponding manner to the delay amount d₂ of the transmission signal x₂ that corresponds to the detected correlation value.

Subsequently, the variable delay unit 523c determines whether or not all first amounts of delay meant for delaying the transmission signal x₁ have been selected (S246). If any unselected first amount of delay is present (No at S246), then the variable delay unit 523c again performs the operation at Step S242. When all first amounts of delay meant for delaying the transmission signal x₁ are selected (Yes at S246), the variable delay unit 523d determines whether or not all first amounts of delay meant for delaying the transmission signal x₃ have been selected (S247). If any unselected first amount of delay is present (No at S247), then the variable delay unit 523d again performs the operation at Step S240. When all first amounts of delay meant for delaying the transmission signal x₃ are selected (Yes at S247), the maximum value detecting unit 522b identifies the delay amount d₂ for which the correlation value is the maximum value from among the correlation values that are held (S248).

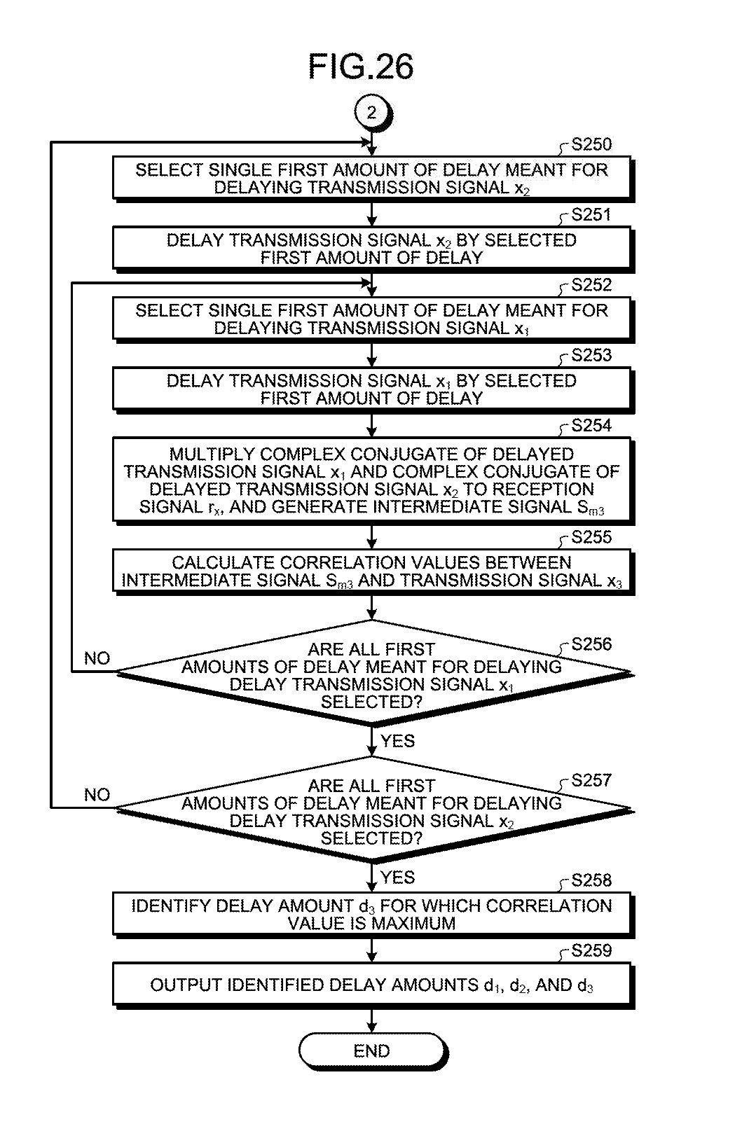

Subsequently, the variable delay unit 523f selects, from among a plurality of predetermined and different first amounts of delay, a single amount of delay meant for delaying the transmission signal x₂ (S250 illustrated in FIG. 26). Then, the variable delay unit 523f delays the transmission signal x₂, which is output from the BBU 11, by the selected first amount of delay (S251). Subsequently, the variable delay unit 523e selects, from among a plurality of predetermined and different first amounts of delay, a single amount of delay meant for delaying the transmission signal x₁ (S252). Then, the variable delay unit 523e delays the transmission signal x₁, which is output from the BBU 11, by the selected first amount of delay (S253).

Subsequently, the multiplier 520e multiplies the complex conjugate of the transmission signal x₁, which has been delayed by the variable delay unit 523e, to the reception signal rₓ output from the RRE 30. The multiplier 520f multiplies the complex conjugate of the transmission signal x₂, which has been delayed by the variable delay unit 523f, to the multiplication result obtained by the multiplier 520e; and generates the intermediate signal Sₘ₃ (S254). The correlator 521c calculates the correlation values between the intermediate signal Sₘ₃ and the complex conjugate of the transmission signal x₃, which output from the BBU 11, while varying the setting of the amount of delay of the transmission signal x₃ (S255). The maximum value detecting unit 522c detects the maximum correlation value from among the correlation values calculated by the correlator 521c. Then, the maximum value detecting unit 522c holds the detected correlated value in a corresponding manner to the delay amount d₃ of the transmission signal x₃ that corresponds to the detected correlation value.

Subsequently, the variable delay unit 523e determines whether or not all first amounts of delay meant for delaying the transmission signal x₁ have been selected (S256). If any unselected first amount of delay is present (No at S256), then the variable delay unit 523e again performs the operation at Step S252. When all first amounts of delay meant for delaying the transmission signal x₁ are selected (Yes at S256), the variable delay unit 523f determines whether or not all first amounts of delay meant for delaying the transmission signal x₂ have been selected (S257). If any unselected first amount of delay is present (No at S257), then the variable delay unit 523f again performs the operation at Step S250. When all first amounts of delay meant for delaying the transmission signal x₂ are selected (Yes at S257), the maximum value detecting unit 522c identifies the delay amount d₃ for which the correlation value is the maximum value from among the correlation values that are held (S258). Subsequently, the maximum value detecting units 522a to 522c output the identified delay amounts d₁ to d₃, respectively, to the replica generating unit 40 (S259). It marks the end of the delay amount measurement operations illustrated in FIGS. 24 to 26.

In the flowcharts illustrated in FIGS. 24 to 26, the operations from Steps S230 to S238 are followed by the operations from Steps S240 to S248; and the operations from Steps S240 to S248 are followed by the operations from Steps S250 to S258. However, the technology disclosed herein is not limited to that example. Alternatively, for example, the set of operations from Steps S230 to S238, the set of operations from Steps S240 to S248, and the set of operations from Steps S250 to S258 can be performed in an arbitrary sequence. Still alternatively, the set of operations from Steps S230 to S238, the set of operations from Steps S240 to S248, and the set of operations from Steps S250 to S258 can be performed in parallel.

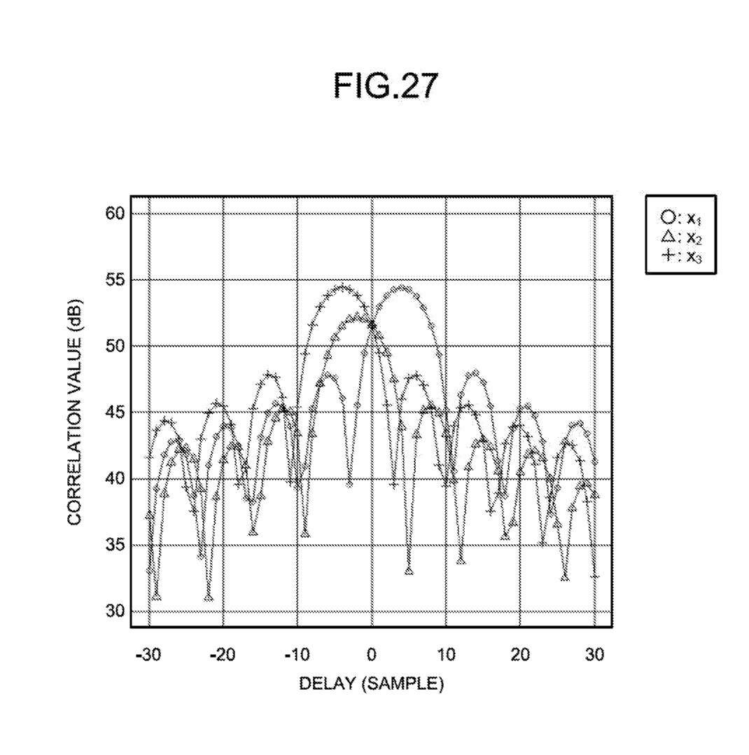

Regarding each transmission signal, a delay profile calculated by the delay measuring instrument 50 according to the third embodiment is as illustrated in FIG. 27, for example. FIG. 27 is a diagram illustrating an example of the delay profile of each transmission signal. In FIG. 27, the horizontal axis represents amounts of delay of each transmission signal with respect to the intermodulation signal, and the vertical axis represents correlation values. Moreover, in FIG. 27, open circles represent the correlation values between the intermediate signal Sₘ₁ and the transmission signal x₁; open triangles represent the correlation values between the intermediate signal Sₘ₂ and the transmission signal x₂; and “+” signs represent the correlation values between the intermediate signal Sₘ₃ and the complex conjugate of the transmission signal x₃. Furthermore, in FIG. 27, the illustrated correlation values represent correlation values with a reception signal that includes an intermodulation signal resulting from the transmission signal x₁ having the amount of delay of +4 samples, the transmission signal x₂ having the amount of delay of −2 samples, and the transmission signal x₃ having the amount of delay of −4 samples. Meanwhile, the sampling frequency and the sampling interval Δt₂ are identical to FIG. 10.

Effect of Third Embodiment

The explanation given above is about the third embodiment. In the communication device 10 according to the third embodiment, in a reception signal that includes an intermodulation signal resulting from three transmission signals having different frequencies, it becomes possible to accurately calculate the amount of delay of each transmission signal that is responsible for the occurrence of the intermodulation signal. As a result, in the communication device 10 according to the third embodiment, it becomes possible to generate an intermodulation signal having a close waveform to the waveform of the intermodulation signal included in the reception signal. Hence, in the communication device 10 according to the third embodiment, the intermodulation signal included in the reception signal can be cancelled out with accuracy, and the quality of the reception signal can be improved.

### [d] Fourth Embodiment

In the third embodiment described above, in a reception signal that includes an intermodulation signal resulting from three transmission signals having different frequencies, the amount of delay of each transmission signal, which is responsible for the occurrence of the intermodulation signal, is independently calculated. In contrast, in a fourth embodiment, in a reception signal that includes an intermodulation signal resulting from three transmission signals having different frequencies, the amount of delay of a single transmission signal is calculated and is then used in calculating the amounts of delay of the other transmission signals.

Delay Measuring Instrument 50

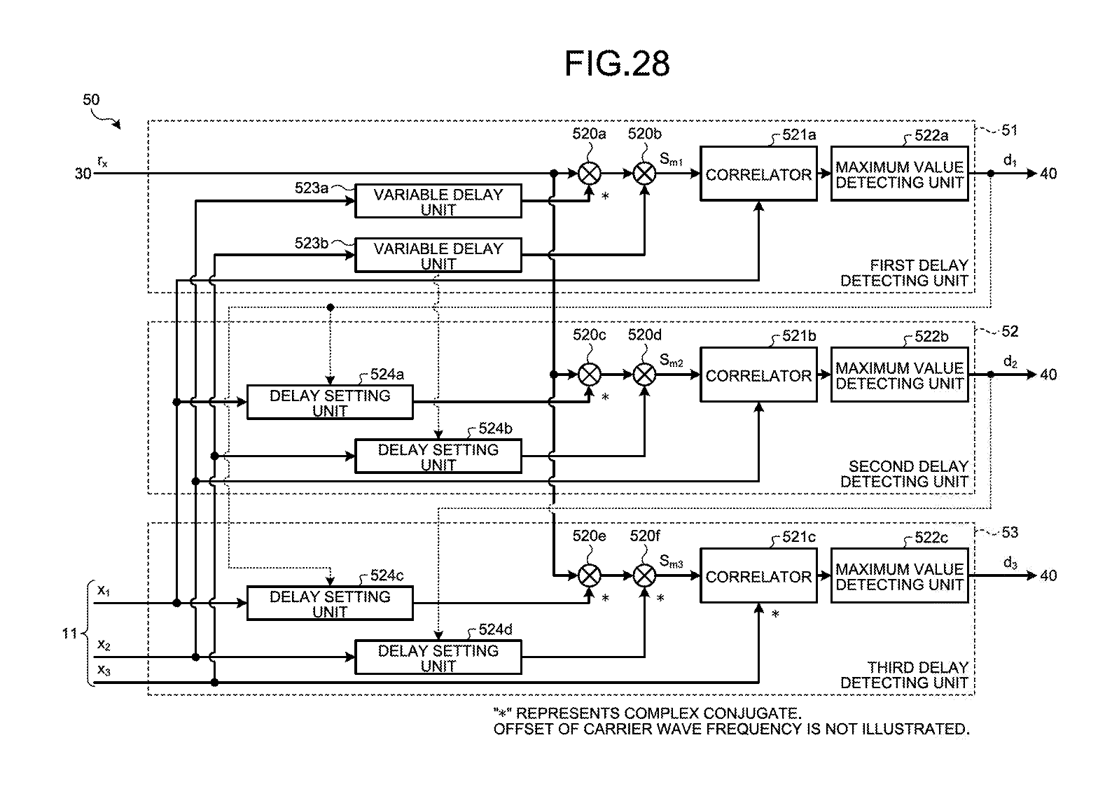

FIG. 28 is a block diagram illustrating an example of the delay measuring instrument 50 according to the fourth embodiment. The delay measuring instrument 50 according to the fourth embodiment includes the first delay detecting unit 51, the second delay detecting unit 52, and the third delay detecting unit 53. The first delay detecting unit 51 includes the multipliers 520a and 520b, the correlator 521a, the maximum value detecting unit 522a, and the variable delay units 523a and 523b. The second delay detecting unit 52 includes the multipliers 520c and 520d, the correlator 521b, the maximum value detecting unit 522b, and delay setting units 524a and 524b. The third delay detecting unit 53 includes the multipliers 520e and 520f, the correlator 521c, the maximum value detecting unit 522c, and delay setting units 524c and 524d. Meanwhile, except for the points explained below, the blocks in FIG. 28 which are referred to by the same reference numerals as in FIG. 23 have the same or identical functions as the blocks illustrated in FIG. 23. Hence, their explanation is not repeated.

The maximum value detecting unit 522a identifies the delay amount d₁ of the transmission signal x₁, and outputs the identified delay amount d₁ to the delay setting units 524a and 524c. The maximum value detecting unit 522b identifies the delay amount d₂ and outputs the identified delay amount d₂ to the delay setting unit 524d. The variable delay unit 523b outputs, to the delay setting unit 524b, the first amount of delay that is set in the variable delay unit 523b at the time of identification of the delay amount d₁ of the transmission signal x₁.

The delay setting units 524a and 524c delay the transmission signal x₁, which is output from the BBU 11, by the delay amount d₁ output from the maximum value detecting unit 522a. The delay setting unit 524b delays the transmission signal x₃, which is output from the BBU 11, by the first amount of delay output from the variable delay unit 523b. The delay setting unit 524d delays the transmission signal x₂, which is output from the BBU 11, by the delay amount d₂ output from the maximum value detecting unit 522b. In the fourth embodiment, the variable delay unit 523a represents an example of a first delaying unit, and the variable delay unit 523b represents an example of a second delaying unit. Moreover, the delay setting unit 524a represents an example of a third delaying unit; the delay setting unit 524b represents an example of a fourth delaying unit; the delay setting unit 524c represents an example of a fifth delaying unit; and the delay setting unit 524d represents an example of a sixth delaying unit.

The multiplier 520c multiplies the complex conjugate of the transmission signal x₁, which has been delayed by the delay setting unit 524a, to the reception signal rₓ. The multiplier 520d multiplies the transmission signal x₃, which has been delayed by the delay setting unit 524b, to the multiplication result obtained by the multiplier 520c; and generates the intermediate signal Sₘ₂.

The multiplier 520e multiplies the complex conjugate of the transmission signal x₁, which has been delayed by the delay setting unit 524c, to the reception signal rₓ output from the RRE 30. The multiplier 520f multiplies the complex conjugate of the transmission signal x₂, which has been delayed by the delay setting unit 524d, to the multiplication result obtained by the multiplier 520e; and generates the intermediate signal Sₘ₃.

Delay Amount Measurement Operation

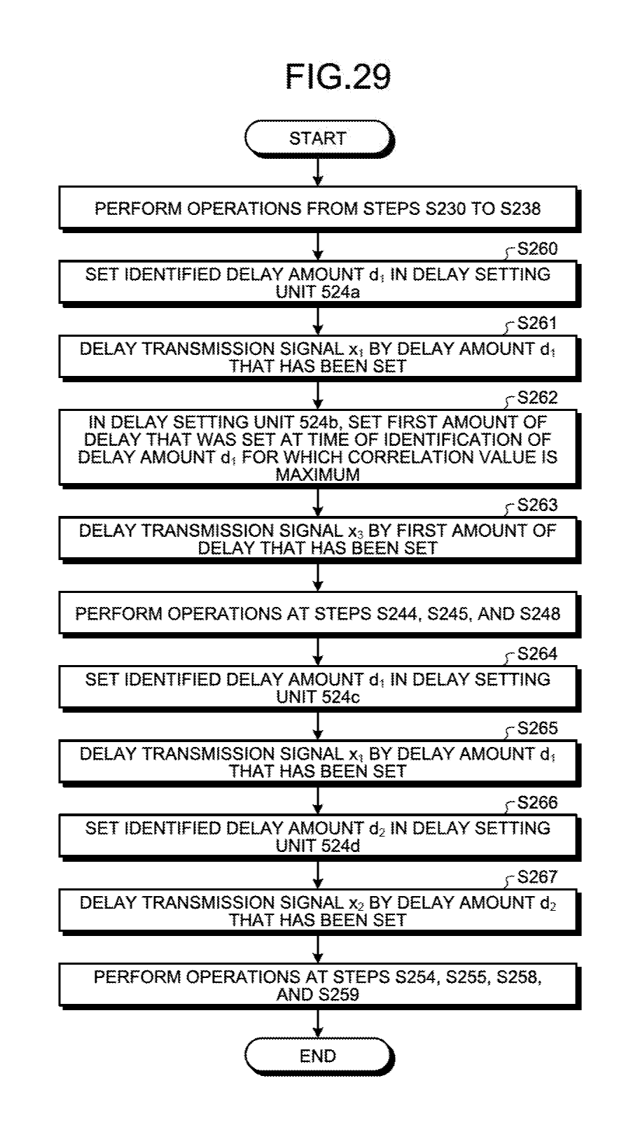

FIG. 29 is a flowchart for explaining an example of a delay amount measurement operation performed according to the fourth embodiment. The delay amount measurement operation illustrated in FIG. 29 is performed by the delay measuring instrument 50. In the delay amount measurement operation illustrated in FIG. 29, regarding the operations identical to the operations in the delay amount measurement operations illustrated in FIGS. 24 to 26, the same step numbers are used as the step numbers in the delay amount measurement operations illustrated in FIGS. 24 to 26, and the detailed explanation of those operations is not repeated.

Firstly, the operations from Steps S230 to S238, which are explained with reference to FIG. 24, are performed. Then, the delay amount d₁ of the transmission signal x₁, which is identified by the maximum value detecting unit 522a, is set in the delay setting unit 524a (S260). The delay setting unit 524a delays the transmission signal x₁, which is output from the BBU 11, by the delay amount d₁ set therein (S261). Subsequently, the first amount of delay that was set in the variable delay unit 523b at the time of identification of the delay amount d₁ of the transmission signal x₁ is set in the delay setting unit 524b (S262). The delay setting unit 524b delays the transmission signal x₃, which is output from the BBU 11, by the first amount of delay set therein (S263). That is followed by the operations at Steps S244, S245, and S248 explained with reference to FIG. 25.

Subsequently, the delay amount d₁ of the transmission x₁, which is identified by the maximum value detecting unit 522a, is set in the delay setting unit 524c (S264). The delay setting unit 524c delays the transmission signal x₁, which is output from the BBU 11, by the delay amount d₁ set therein (S265). Then, the delay amount d₂ of the transmission x₂, which is identified by the maximum value detecting unit 522b, is set in the delay setting unit 524d (S266). The delay setting unit 524d delays the transmission signal x₂, which is output from the BBU 11, by the delay amount d₂ set therein (S267). That is followed by the operations at Steps S254, S255, S258, and S259 explained with reference to FIG. 26, are performed.

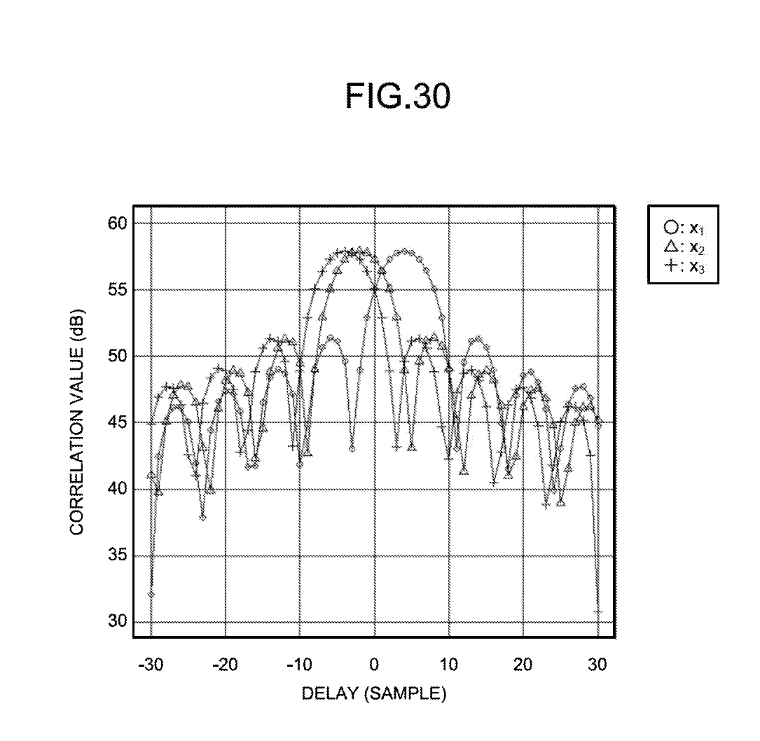

Regarding each transmission signal, a delay profile calculated by the delay measuring instrument 50 is as illustrated in FIG. 30, for example. FIG. 30 is a diagram illustrating an example of the delay profile of each transmission signal. In FIG. 30, the horizontal axis represents amounts of delay of each transmission signal with respect to the intermodulation signal, and the vertical axis represents correlation values. Moreover, in FIG. 30, open circles represent the correlation values between the intermediate signal Sₘ₁ and the transmission signal x₁; open triangles represent the correlation values between the intermediate signal Sₘ₂ and the transmission signal x₂; and “+” signs represent the correlation values between the intermediate signal Sₘ₃ and the complex conjugate of the transmission signal x₃. Furthermore, in FIG. 30, the illustrated correlation values represent correlation values with a reception signal that includes an intermodulation signal resulting from the transmission signal x₁ having the amount of delay of +4 samples, the transmission signal x₂ having the amount of delay of −2 samples, and the transmission signal x₃ having the amount of delay of −4 samples. Meanwhile, the sampling frequency and the sampling interval Δt₂ are identical to FIG. 10.

Effect of Fourth Embodiment

The explanation given above is about the fourth embodiment. In the communication device 10 according to the fourth embodiment, in a reception signal that includes an intermodulation signal resulting from three transmission signals having different frequencies, the amount of delay of a single transmission signal is calculated and is then used in calculating the amounts of delay of the other transmission signals. That enables achieving reduction in the amount of calculation at the time of calculating the amounts of delay of the other transmission signals.

### [e] Fifth Embodiment

In the first embodiment described earlier, the explanation is given about cancelling out the intermodulation signal resulting from the transmission signals x₁ and x₂ having two different frequencies. In a fifth embodiment, the explanation is given about cancelling out the intermodulation signal resulting from two sets of transmission signals having two different frequencies. Of the two sets of transmission signals, one set includes two transmission signals x₁ and x₂ that are transmitted at the same frequency; and the other set includes two transmission signals x₃ and x₄ that are transmitted at the same frequency. Such an intermodulation signal occurs in the case in which, for example, a plurality of RREs 30 is present that transmits transmission signals of a plurality of different frequencies and each RRE 30 transmits transmission signals of the same frequency from the two antennas. In the following explanation, f₁ is defined as the frequency of the transmission signal x₁ and f₂ is defined as the frequency of the transmission signal x₂; and it is assumed that f₁<f₂ holds true. Meanwhile, the transmission signals x₁ to x₄ are mutually non-correlated signals.

Of the intermodulation signal S_{PIM}, the intermodulation signal S_{PIM} having the frequency 2f₁-f₂ is expressed using, for example, Equation (9) given below.

S_{PIM}=K·(x₁+x₂)²·(x₃+x₄)*=K·(x₁²x₃*+2x₁x₂x₃*+x₂²x₃*+x₁²x₄*+2x₁x₂x₄*+x₂²x₄*) (9)

Herein, K represents (A₃+A₅₁|x₁+x₂|²+A₅₂|x₃+x₄|²+ . . . ).

In the case of obtaining the delay amount d₁ of the transmission signal x₁, the transmission signal x₃ is multiplied to the intermodulation signal S_{PIM} given above in Equation (9). The intermediate signal Sₘ₁ representing the multiplication result includes a member made of the product of x₁² and a real number. The members other than the member made of the product of x₁² and a real number include x₁, x₂, x₃, and x₄. Herein, x₁, x₂, x₃, and x₄ are non-correlated with x₁². Thus, it becomes possible to calculate the correlation between the intermediate signal Sₘ₁ and x₁². That is, with respect to the intermediate signal Sₘ₁ obtained by multiplying the transmission signal x₃ to the intermodulation signal S_{PIM} given above in Equation (9), the correlation values between the intermediate signal Sₘ₁ and x₁² are calculated while varying the amount of delay of the transmission signal x₁. Then, the amount of delay corresponding to the maximum correlation value becomes the delay amount d₁ of the transmission signal x₁ that is responsible for the occurrence of the intermodulation signal S_{PIM}.

In the case of obtaining the delay amount d₂ of the transmission signal x₂, the transmission signal x₄ is multiplied to the intermodulation signal S_{PIM} given above in Equation (9). The intermediate signal Sₘ₂ representing the multiplication result includes a member made of the product of x₂² and a real number. Since x₂² is non-correlated with x₁, x₂, x₃, and x₄; it becomes possible to calculate the correlation between the intermediate signal Sₘ₂ and x₂². That is, with respect to the intermediate signal Sₘ₂ obtained by multiplying the multiplication signal x₄ to the intermodulation signal S_{PIM} given above in Equation (9), the correlation values between the intermediate signal Sₘ₂ and x₂² are calculated while varying the amount of delay of the transmission signal x₂. Then, the amount of delay corresponding to the maximum correlation value becomes the delay amount d₂ of the transmission signal x₂ that is responsible for the occurrence of the intermodulation signal S_{PIM}.

In the case of obtaining the delay amount d₃ of the transmission signal x₃, the complex conjugate of the square of the transmission signal x₁ is multiplied to the intermodulation signal S_{PIM} given above in Equation (9). The intermediate signal Sₘ₃ representing the multiplication result includes a member made of the product of the complex conjugate of x₃ and a real number. Since the complex conjugate of x₃ is non-correlated with x₁, x₂, x₃, and x₄; it becomes possible to calculate the correlation between the intermediate signal Sₘ₃ and the complex conjugate of x₃. That is, with respect to the intermediate signal Sₘ₃ obtained by multiplying the complex conjugate of the square of the transmission signal x₁ to the intermodulation signal S_{PIM} given above in Equation (9), the correlation values between the intermediate signal Sₘ₃ and the complex conjugate of x₃ are calculated while varying the amount of delay of the transmission signal x₃. Then, the amount of delay corresponding to the maximum correlation value becomes the delay amount d₃ of the transmission signal x₃ that is responsible for the occurrence of the intermodulation signal S_{PIM}.

In the case of obtaining the delay amount d₄ of the transmission signal x₄, the complex conjugate of the square of the transmission signal x₂ is multiplied to the intermodulation signal S_{PIM} given above in Equation (9). An intermediate signal Sₘ₄ representing the multiplication result includes a member made of the product of the complex conjugate of x₄ and a real number. Since the complex conjugate of x₄ is non-correlated with x₁, x₂, x₃, and x₄; it becomes possible to calculate the correlation between the intermediate signal Sₘ₄ and the complex conjugate of x₄. That is, with respect to the intermediate signal Sₘ₄ obtained by multiplying the complex conjugate of the square of the transmission signal x₂ to the intermodulation signal S_{PIM} given above in Equation (9), the correlation values between the intermediate signal Sₘ₄ and x₄ are calculated while varying the amount of delay of the transmission signal x₄. Then, the amount of delay corresponding to the maximum correlation value becomes the delay amount d₄ of the transmission signal x₄ that is responsible for the occurrence of the intermodulation signal S_{PIM}.

Given below is the explanation of an example of a specific functional block of the delay measuring instrument 50 that implements the operations according to the fifth embodiment.

Delay Measuring Instrument 50

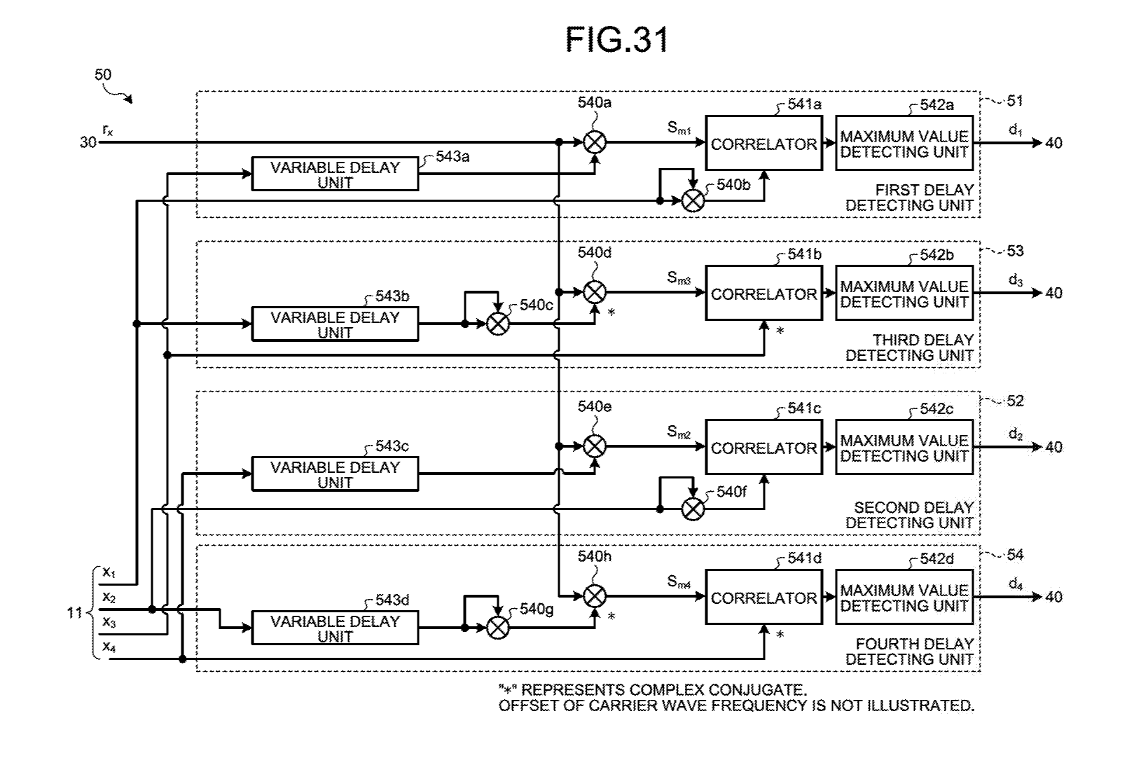

FIG. 31 is a block diagram illustrating an example of the delay measuring instrument 50 according to the fifth embodiment. The delay measuring instrument 50 according to the fifth embodiment includes the first delay detecting unit 51, the second delay detecting unit 52, the third delay detecting unit 53, and a fourth delay detecting unit 54. The first delay detecting unit 51 includes multipliers 540a and 540b, a correlator 541a, a maximum value detecting unit 542a, and a variable delay unit 543a. The second delay detecting unit 52 includes multipliers 540e and 540f, a correlator 541c, a maximum value detecting unit 542c, and a variable delay unit 543c. The third delay detecting unit 53 includes multipliers 540c and 540d, a correlator 541b, a maximum value detecting unit 542b, and a variable delay unit 543b. The fourth delay detecting unit 54 includes multipliers 540g and 540h, a correlator 541d, a maximum value detecting unit 542d, and a variable delay unit 543d. The multipliers 540a to 540h are complex multipliers, for example. Moreover, as far as the correlators 541a to 541d are concerned, for example, it is possible to use sliding correlators as illustrated in FIG. 6 or it is possible to use matched filters as illustrated in FIG. 7. The variable delay units 543a to 543d represent examples of a delay signal generating unit. The multipliers 540a, 540d, 540e, and 540h represent examples of an intermediate signal generating unit. The maximum value detecting units 542a to 542d represent examples of a calculating unit.

The variable delay unit 543a delays the transmission signal x₃, which is output from the BBU 11, by the first delay period. The variable delay unit 543b delays the transmission signal x₁, which is output from the BBU 11, by the first delay period. The variable delay unit 543c delays the transmission signal x₄, which is output from the BBU 11, by the first delay period. The variable delay unit 543d delays the transmission signal x₂, which is output from the BBU 11, by the first delay period. The variable delay units 543a to 543d delay the respective transmission signals by the first delay period while varying a plurality of predetermined and different first amounts of delay. In the fifth embodiment, the variable delay unit 543a represents an example of a first delaying unit; the variable delay unit 543b represents an example of a second delaying unit; the variable delay unit 543c represents an example of a third delaying unit; and the variable delay unit 543d represents an example of a fourth delaying unit.

The multiplier 540a multiplies the transmission signal x₃, which has been delayed by the variable delay unit 543a, to the reception signal rₓ output from the RRE 30; and generates the intermediate signal Sₘ₁. The multiplier 540a represents an example of a first generating unit. The multiplier 540b calculates the square of the transmission signal x₁ that is output from the BBU 11.

The multiplier 540e multiplies the transmission signal x₄, which has been delayed by the variable delay unit 543c, to the reception signal rₓ output from the RRE 30; and generates the intermediate signal Sₘ₂. The multiplier 540e represents an example of a second generating unit. The multiplier 540f calculates the square of the transmission signal x₂ that is output from the BBU 11.

The multiplier 540c calculates the square of the transmission signal x₁ that has been delayed by the variable delay unit 543b. The multiplier 540d multiplies, to the reception signal rₓ output from the RRE 30, the complex conjugate of the square of the transmission signal x₁ as calculated by the multiplier 540c; and generates the intermediate signal Sₘ₃. The multiplier 540d represents an example of a third generating unit.

The multiplier 540g calculates the square of the transmission signal x₂ that has been delayed by the variable delay unit 543d. The multiplier 540h multiplies, to the reception signal rₓ output from the RRE 30, the complex conjugate of the square of the transmission signal x₂ as calculated by the multiplier 540g; and generates the intermediate signal Sₘ₄. The multiplier 540h represents an example of a fourth generating unit.

The correlator 541a calculates the correlation values between the intermediate signal Sₘ₁ and the square of the transmission signal x₁ while varying the setting of the amount of delay of the square of the transmission signal x₁ as calculated by the multiplier 540b. The maximum value detecting unit 542a detects the maximum correlation value from among the correlation values calculated by the correlator 541a. Then, the maximum value detecting unit 542a outputs, as the delay amount d₁ of the transmission signal x₁, the amount of delay corresponding to the detected maximum correlation value to the replica generating unit 40. The maximum value detecting unit 542a represents an example of a first calculating unit.

The correlator 541c calculates the correlation values between the intermediate signal Sₘ₂ and the square of the transmission signal x₂ while varying the setting of the amount of delay of the square of the transmission signal x₂ as calculated by the multiplier 540f. The maximum value detecting unit 542c detects the maximum correlation value from among the correlation values calculated by the correlator 541c. Then, the maximum value detecting unit 542c outputs, as the delay amount d₂ of the transmission signal x₂, the amount of delay corresponding to the detected maximum correlation value to the replica generating unit 40. The maximum value detecting unit 542c represents an example of a second calculating unit.

The correlator 541b calculates the correlation values between the intermediate signal Sₘ₃ and the complex conjugate of the transmission signal x₃, which is output from the BBU 11, while varying the setting of the amount of delay of the complex conjugate of the transmission signal x₃. The maximum value detecting unit 542b detects the maximum correlation value from among the correlation values calculated by the correlator 541b. Then, the maximum value detecting unit 542b outputs, as the delay amount d₃ of the transmission signal x₃, the amount of delay corresponding to the detected maximum correlation value to the replica generating unit 40. The maximum value detecting unit 542b represents an example of a third calculating unit.

The correlator 541d calculates the correlation values between the intermediate signal Sₘ₄ and the complex conjugate of the transmission signal x₄, which is output from the BBU 11, while varying the setting of the amount of delay of the complex conjugate of the transmission signal x₄. The maximum value detecting unit 542d detects the maximum correlation value from among the correlation values calculated by the correlator 541d. Then, the maximum value detecting unit 542d outputs, as the delay amount d₄ of the transmission signal x₄, the amount of delay corresponding to the detected maximum correlation value to the replica generating unit 40. The maximum value detecting unit 542d represents an example of a fourth calculating unit.

Delay Amount Measurement Operation

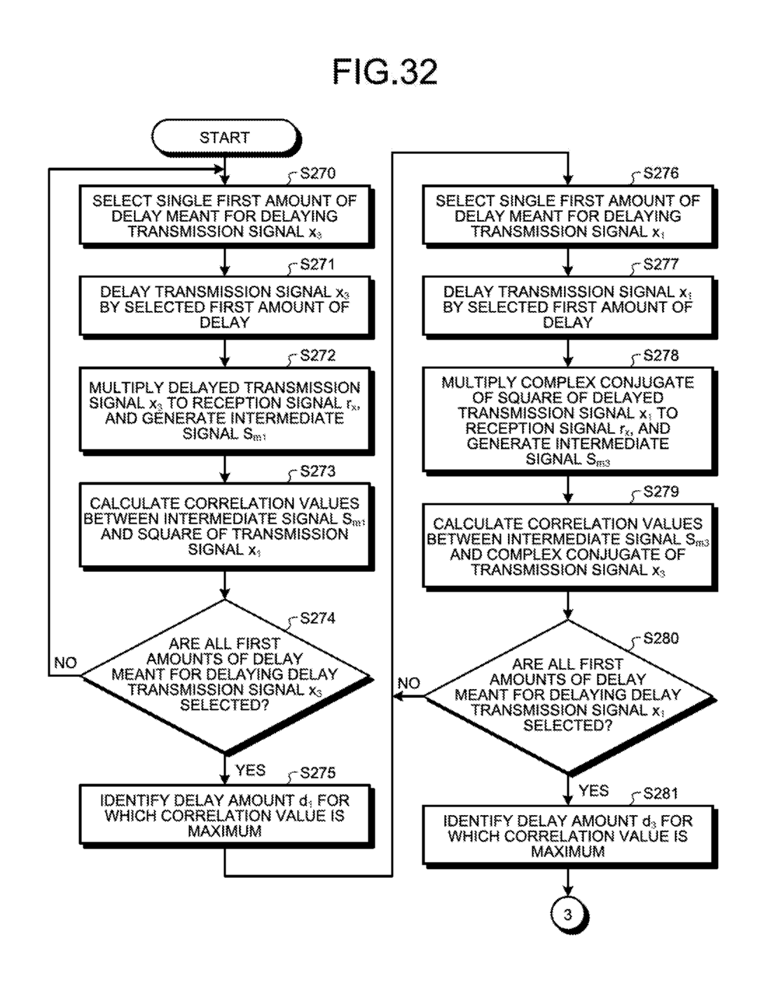

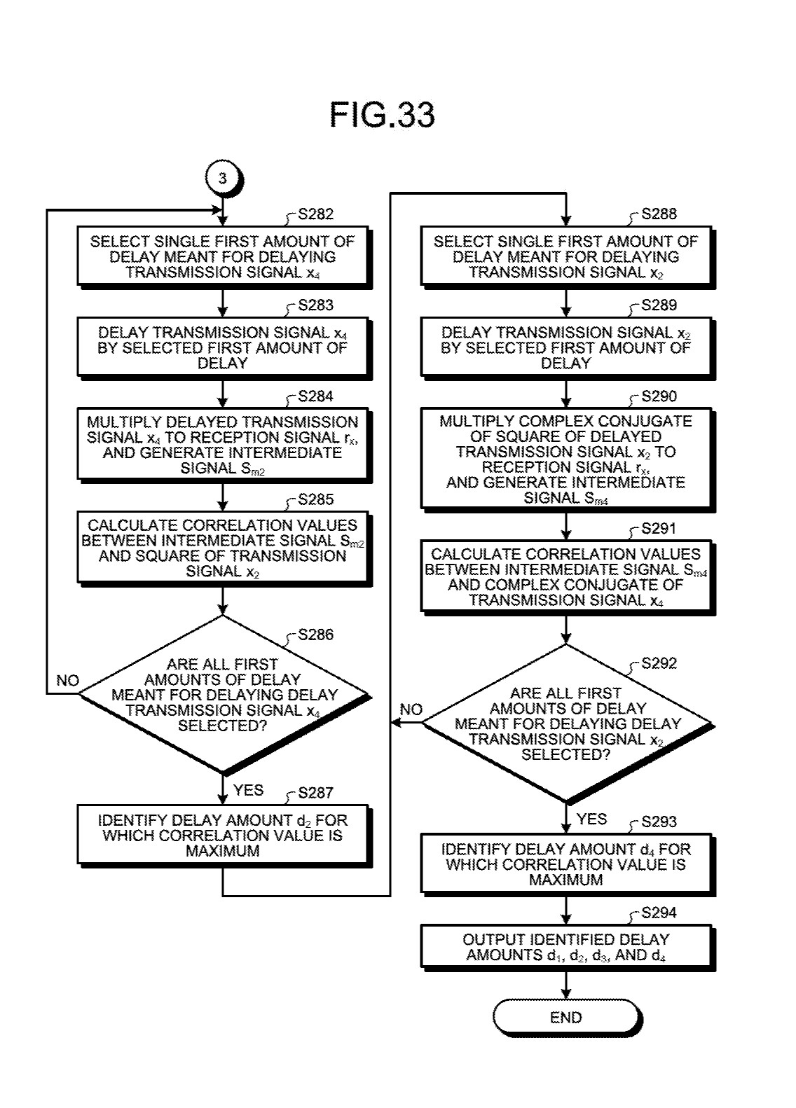

FIGS. 32 and 33 are flowcharts for explaining an example of delay amount measurement operations according to the fifth embodiment. The delay amount measurement operations illustrated in FIGS. 32 and 33 are performed by the delay measuring instrument 50.

Firstly, the variable delay unit 543a selects, from among a plurality of predetermined and different first amounts of delay, a single amount of delay meant for delaying the transmission signal x₃ (S270). Then, the variable delay unit 543a delays the transmission signal x₃, which is output from the BBU 11, by the selected first amount of delay (S271).

Subsequently, the multiplier 540a multiplies the transmission signal x₃, which has been delayed by the variable delay unit 543a, to the reception signal rₓ output from the RRE 30; and generates the intermediate signal Sₘ₁ (S272). Then, the correlator 541a calculates the correlation values between the intermediate signal Sₘ₁ and the square of the transmission signal x₁ while varying the setting of the amount of delay of the square of the transmission signal x₁ as calculated by the multiplier 540b (S273). The maximum value detecting unit 542a detects the maximum correlation value from among the correlation values calculated by the correlator 541a. Then, the maximum value detecting unit 542a holds the detected correlation value in a corresponding manner to the delay amount d₁ of the transmission signal x₁ that corresponds to the detected correlation value.

Subsequently, the variable delay unit 543a determines whether or not all first amounts of delay meant for delaying the transmission signal x₃ have been selected (S274). If any unselected first amount of delay is present (No at S274), then the variable delay unit 543a again performs the operation at Step S270. When all first amounts of delay meant for delaying the transmission signal x₃ are selected (Yes at S274), the maximum value detecting unit 542a identifies the delay amount d₁ for which the correlation value is the maximum value from among the correlation values that are held (S275).

Then, the variable delay unit 543b selects, from among a plurality of predetermined and different first amounts of delay, a single amount of delay meant for delaying the transmission signal x₁ (S276). Then, the variable delay unit 543b delays the transmission signal x₁, which is output from the BBU 11, by the selected first amount of delay (S277). The multiplier 540c calculates the square of the transmission signal x₁ that has been delayed by the variable delay unit 543b.

Subsequently, the multiplier 540d multiplies, to the reception signal rₓ output from the RRE 30, the complex conjugate of the square of the transmission signal x₁ as calculated by the multiplier 540c; and generates the intermediate signal Sₘ₃ (S278). Then, the correlator 541b calculates the correlation values between the intermediate signal Sₘ₃ and the complex conjugate of the transmission signal x₃, which is output from the BBU 11, while varying the setting of the amount of delay of the complex conjugate of the transmission signal x₃ (S279). The maximum value detecting unit 542b detects the maximum correlation value from among the correlation values calculated by the correlator 541b. Then, the maximum value detecting unit 542b holds the detected correlation value in a corresponding manner to the delay amount d₃ of the transmission signal x₃ that corresponds to the detected correlation value.

Subsequently, the variable delay unit 543b determines whether or not all first amounts of delay meant for delaying the transmission signal x₁ have been selected (S280). If any unselected first amount of delay is present (No at S280), then the variable delay unit 543b again performs the operation at Step S276. When all first amounts of delay meant for delaying the transmission signal x₁ are selected (Yes at S280), the maximum value detecting unit 542b identifies the delay amount d₃ for which the correlation value is the maximum value from among the correlation values that are held (S281).

Subsequently, the variable delay unit 543c selects, from among a plurality of predetermined and different first amounts of delay, a single amount of delay meant for delaying the transmission signal x₄ (S282 illustrated in FIG. 33). Then, the variable delay unit 543c delays the transmission signal x₄, which is output from the BBU 11, by the selected first amount of delay (S283).

Subsequently, the multiplier 540e multiplies the transmission signal x₄, which has been delayed by the variable delay unit 543c, to the reception signal rₓ output from the RRE 30; and generates the intermediate signal Sₘ₂ (S284). Then, the correlator 541c calculates the correlation values between the intermediate signal Sₘ₂ and the square of the transmission signal x₂ while varying the setting of the amount of delay of the square of the transmission signal x₂ as calculated by the multiplier 540f (S285). The maximum value detecting unit 542c detects the maximum correlation value from among the correlation values calculated by the correlator 541c. Then, the maximum value detecting unit 542c holds the detected correlation value in a corresponding manner to the delay amount d₂ of the transmission signal x₂ that corresponds to the detected correlation value.

Subsequently, the variable delay unit 543c determines whether or not all first amounts of delay meant for delaying the transmission signal x₄ have been selected (S286). If any unselected first amount of delay is present (No at S286), then the variable delay unit 543c again performs the operation at Step S282. When all first amounts of delay meant for delaying the transmission signal x₄ are selected (Yes at S286), the maximum value detecting unit 542c identifies the delay amount d₂ for which the correlation value is the maximum value from among the correlation values that are held (S287).

Subsequently, the variable delay unit 543d selects, from among a plurality of predetermined and different first amounts of delay, a single amount of delay meant for delaying the transmission signal x₂ (S288). Then, the variable delay unit 543d delays the transmission signal x₂, which is output from the BBU 11, by the selected first amount of delay (S289). The multiplier 540g calculates the square of the transmission signal x₂ that has been delayed by the variable delay unit 543d.

Subsequently, the multiplier 540h multiplies, to the reception signal rₓ output from the RRE 30, the complex conjugate of the square of the transmission signal x₂ as calculated by the multiplier 540g; and generates the intermediate signal Sₘ₄ (S290). Then, the correlator 541d calculates the correlation values between the intermediate signal Sₘ₄ and the complex conjugate of the transmission signal x₄, which is output from the BBU 11, while varying the setting of the amount of delay of the complex conjugate of the transmission signal x₄ (S291). The maximum value detecting unit 542d detects the maximum correlation value from among the correlation values calculated by the correlator 541d. Then, the maximum value detecting unit 542d holds the detected correlation value in a corresponding manner to the delay amount d₄ of the transmission signal x₄ that corresponds to the detected correlation value.

Subsequently, the variable delay unit 543d determines whether or not all first amounts of delay meant for delaying the transmission signal x₂ have been selected (S292). If any unselected first amount of delay is present (No at S292), then the variable delay unit 543d again performs the operation at Step S288. When all first amounts of delay meant for delaying the transmission signal x₂ are selected (Yes at S292), the maximum value detecting unit 542d identifies the delay amount d₄ for which the correlation value is the maximum value from among the correlation values that are held (S293). Subsequently, the maximum value detecting units 542a to 542d output the identified delay amounts d₁ to d₄, respectively, to the replica generating unit 40 (S294). It marks the end of the delay amount measurement operations illustrated in FIGS. 32 and 33.

Meanwhile, regarding the set of operations from Steps S270 to S275, the set of operations from Steps S276 to S281, the set of operations from Steps S282 to S287, and the set of operations from Steps S288 to S293; the sequence of operations is not limited to the sequence illustrated in FIGS. 32 and 33. Alternatively, regarding the set of operations from Steps S270 to S275, the set of operations from Steps S276 to S281, the set of operations from Steps S282 to S287, and the set of operations from Steps S288 to S293; the operations can be performed in an arbitrary sequence. Still alternatively, regarding the set of operations from Steps S270 to S275, the set of operations from Steps S276 to S281, the set of operations from Steps S282 to S287, and set of the operations from Steps S288 to S293; the operations can be performed in parallel.

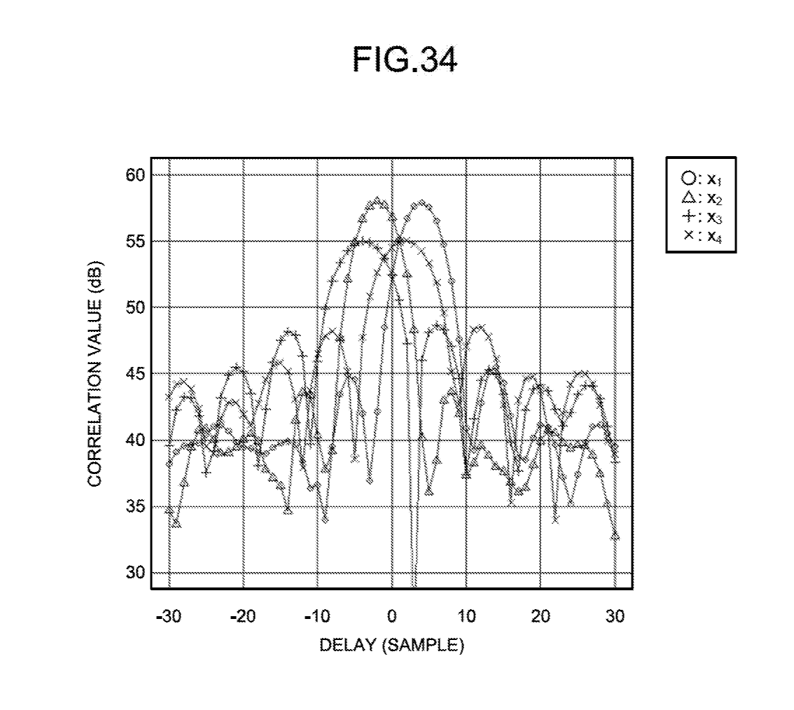

Regarding each transmission signal, a delay profile calculated by the delay measuring instrument 50 according to the fifth embodiment is as illustrated in FIG. 34, for example. FIG. 34 is a diagram illustrating an example of the delay profile of each transmission signal. In FIG. 34, the horizontal axis represents amounts of delay of each transmission signal with respect to the intermodulation signal, and the vertical axis represents correlation values. Moreover, in FIG. 34, open circles represent the correlation values between the intermediate signal Sₘ₁ and the square of the transmission signal x₁; and open triangles represent the correlation values between the intermediate signal Sₘ₂ and the square of the transmission signal x₂. Furthermore, in FIG. 34, “+” signs represent the correlation values between the intermediate signal Sₘ₃ and the complex conjugate of the transmission signal x₃; and “×” signs represent the correlation values between the intermediate signal Sₘ₄ and the complex conjugate of the transmission signal x₄. Moreover, in FIG. 34, the illustrated correlation values represent correlation values with a reception signal that includes an intermodulation signal resulting from the transmission signal x₁ having the amount of delay of +4 samples, the transmission signal x₂ having the amount of delay of −2 samples, the transmission signal x₃ having the amount of delay of −4 samples, and the transmission signal x₄ having the amount of delay of +2 samples. Meanwhile, the sampling frequency and the sampling interval Δt₂ are identical to FIG. 10.

Another Example of Delay Measuring Instrument 50 According to Fifth Embodiment

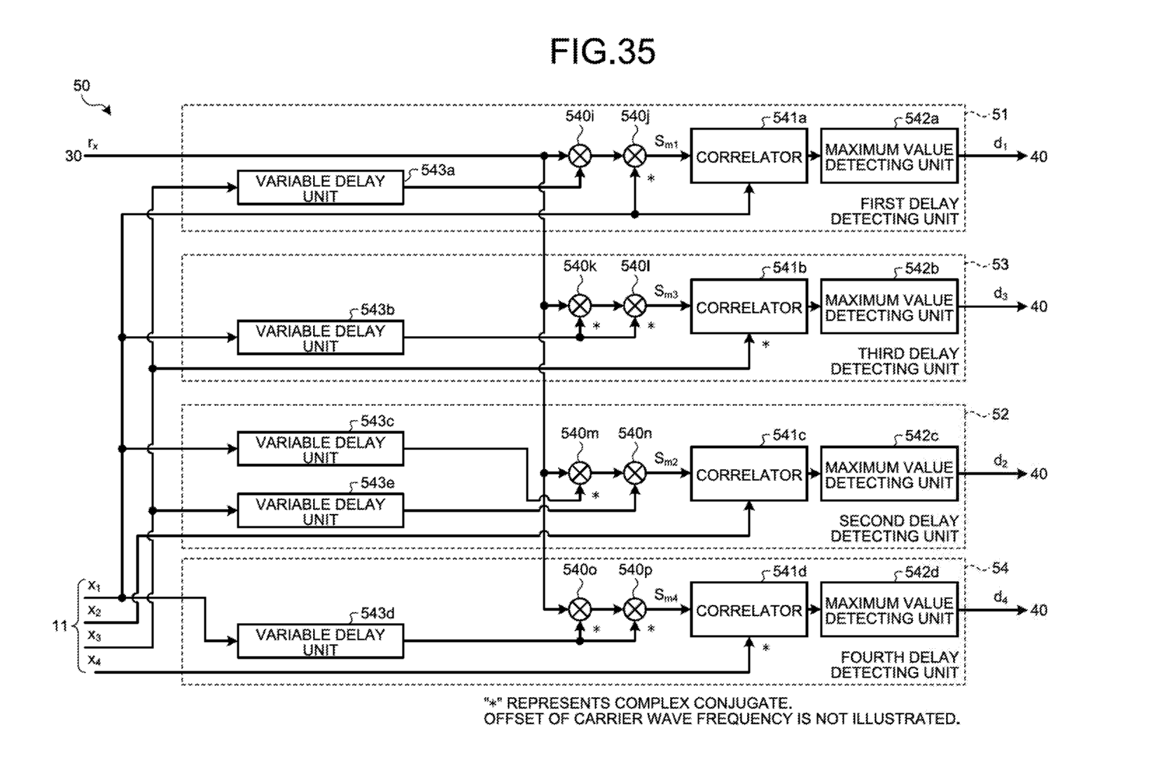

The delay measuring instrument 50 according to the fifth embodiment can also be configured as illustrated in FIG. 35, for example. FIG. 35 is a block diagram illustrating another example of the delay measuring instrument 50 according to the fifth embodiment. The delay measuring instrument 50 illustrated in FIG. 35 includes the first delay detecting unit 51, the second delay detecting unit 52, the third delay detecting unit 53, and the fourth delay detecting unit 54. The first delay detecting unit 51 includes multipliers 540i and 540j, the correlator 541a, the maximum value detecting unit 542a, and the variable delay unit 543a. The second delay detecting unit 52 includes multipliers 540m and 540n, the correlator 541c, the maximum value detecting unit 542c, and variable delay units 543c and 543e. The third delay detecting unit 53 includes multipliers 540k and 540l, the correlator 541b, the maximum value detecting unit 542b, and the variable delay unit 543b. The fourth delay detecting unit 54 includes multipliers 540o and 540p, the correlator 541d, the maximum value detecting unit 542d, and the variable delay unit 543d. The multipliers 540i to 540p are complex multipliers, for example. Meanwhile, except for the points explained below, the blocks in FIG. 35 which are referred to by the same reference numerals as in FIG. 31 have the same or identical functions as the blocks illustrated in FIG. 31. Hence, their explanation is not repeated.

The multiplier 540i multiplies the transmission signal x₃, which has been delayed by the variable delay unit 543a, to the reception signal rₓ output from the RRE 30. The multiplier 540j multiplies the complex conjugate of the transmission signal x₁, which is output from the BBU 11, to the multiplication result obtained by the multiplier 540i; and generates the intermediate signal Sₘ₁. In the fifth embodiment, the multipliers 540i and 540j represent examples of a first generating unit. The correlator 541a calculates the correlation values between the intermediate signal Sₘ₁ and the transmission signal x₁, which is output from the BBU 11, while varying the setting of the amount of delay of the transmission signal x₁.

The multiplier 540k multiplies the complex conjugate of the transmission signal x₁, which has been delayed by the variable delay unit 543b, to the reception signal rₓ output from the RRE 30. The multiplier 540l multiplies the complex conjugate of the transmission signal x₁, which has been delayed by the variable delay unit 543b, to the multiplication result obtained by the multiplier 540k; and generates the intermediate signal Sₘ₃. In the fifth embodiment, the multipliers 540k and 540l represent examples of a third generating unit. The correlator 541b calculates the correlation values between the intermediate signal Sₘ₃ and the complex conjugate of the transmission signal x₃, which is output from the BBU 11, while varying the setting of the amount of delay of the complex conjugate of the transmission signal x₃.

The variable delay unit 543e delays the transmission signal x₃, which is output from the BBU 11, by the first delay period. The multiplier 540m multiplies the complex conjugate of the transmission signal x₁, which has been delayed by the variable delay unit 543c, to the reception signal rₓ output from the RRE 30. The multiplier 540n multiplies the transmission signal x₃, which has been delayed by the variable delay unit 543e, to the multiplication result obtained by the multiplier 540m; and generates the intermediate signal Sₘ₂. In the fifth embodiment, the multipliers 540m and 540n are examples of a second generating unit. The correlator 541c calculates the correlation values between the intermediate signal Sₘ₂ and the transmission signal x₂, which is output from the BBU 11, while varying the setting of the setting amount of the transmission signal x₂.

The variable delay unit 543d delays the transmission signal x₁, which is output from the BBU 11, by the first delay period. The multiplier 540o multiplies the complex conjugate of the transmission signal x₁, which has been delayed by the variable delay unit 543d, to the reception signal rₓ output from the RRE 30. The multiplier 540p multiplies the complex conjugate of the transmission signal x₁, which has been delayed by the variable delay unit 543d, to the multiplication result obtained by the multiplier 540o; and generates the intermediate signal Sₘ₄. In the fifth embodiment, the multipliers 540o and 540p are examples of a fourth generating unit. The correlator 541d calculates the correlation values between the intermediate signal Sₘ₄ and the transmission signal x₄, which is output from the BBU 11, while varying the setting of the amount of delay of the complex conjugate of the transmission signal x₄.

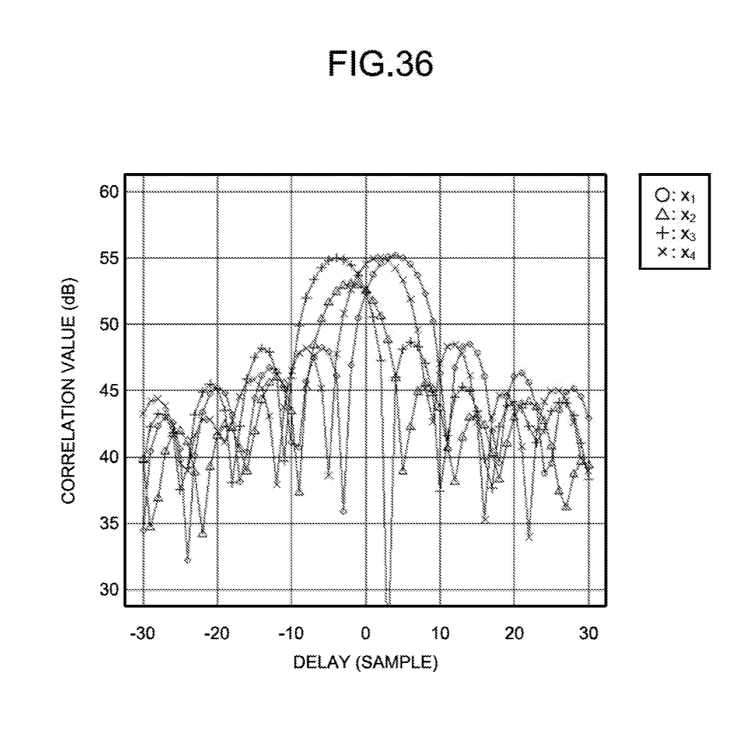

Regarding each transmission signal, a delay profile calculated by the delay measuring instrument 50 illustrated in FIG. 35 is as illustrated in FIG. 36, for example. FIG. 36 is a diagram illustrating an example of the delay profile of each transmission signal. In FIG. 36, the horizontal axis represents amounts of delay of each transmission signal with respect to the intermodulation signal, and the vertical axis represents correlation values. Moreover, in FIG. 36, open circles represent the correlation values between the intermediate signal Sₘ₁ and the transmission signal x₁; and open triangles represent the correlation values between the intermediate signal Sₘ₂ and the transmission signal x₂. Furthermore, in FIG. 36, “+” signs represent the correlation values between the intermediate signal Sₘ₃ and the complex conjugate of the transmission signal x₃; and “×” signs represent the correlation values between the intermediate signal Sₘ₄ and the complex conjugate of the transmission signal x₄. Moreover, in FIG. 36, the illustrated correlation values represent correlation values with a reception signal that includes an intermodulation signal resulting from the transmission signal x₁ having the amount of delay of +4 samples, the transmission signal x₂ having the amount of delay of −2 samples, the transmission signal x₃ having the amount of delay of −4 samples, and the transmission signal x₄ having the amount of delay of +2 samples. Meanwhile, the sampling frequency and the sampling interval Δt₂ are identical to FIG. 10.

Effect of Fifth Embodiment

The explanation given above is about the fifth embodiment. In the delay measuring instrument 50 according to the fifth embodiment, in a reception signal that includes an intermodulation signal resulting from two different sets of transmission signals having different frequencies, it becomes possible to calculate the amount of delay of each transmission signal responsible for the occurrence of the intermodulation signal. As a result, in the communication device 10 according to the fifth embodiment, it becomes possible to generate an intermodulation signal having a close waveform to the waveform of the intermodulation signal included in the reception signal. Thus, in the communication device 10 according to the fifth embodiment, the intermodulation signal included in the reception signal can be accurately cancel out, and the quality of the reception signal can be improved.

### [f] Sixth Embodiment

In the fifth embodiment described above, in a reception signal that includes an intermodulation signal resulting from two different sets of transmission signals having different frequencies, the amount of delay of each transmission signal responsible for the occurrence of the intermodulation signal is independently calculated. In contrast, in a sixth embodiment, in a reception signal that includes an intermodulation signal resulting from two different sets of transmission signals having different frequencies, the amount of delay of a single transmission signal is calculated and is then used in calculating the amounts of delay of the other transmission signals.

Delay Measuring Instrument 50

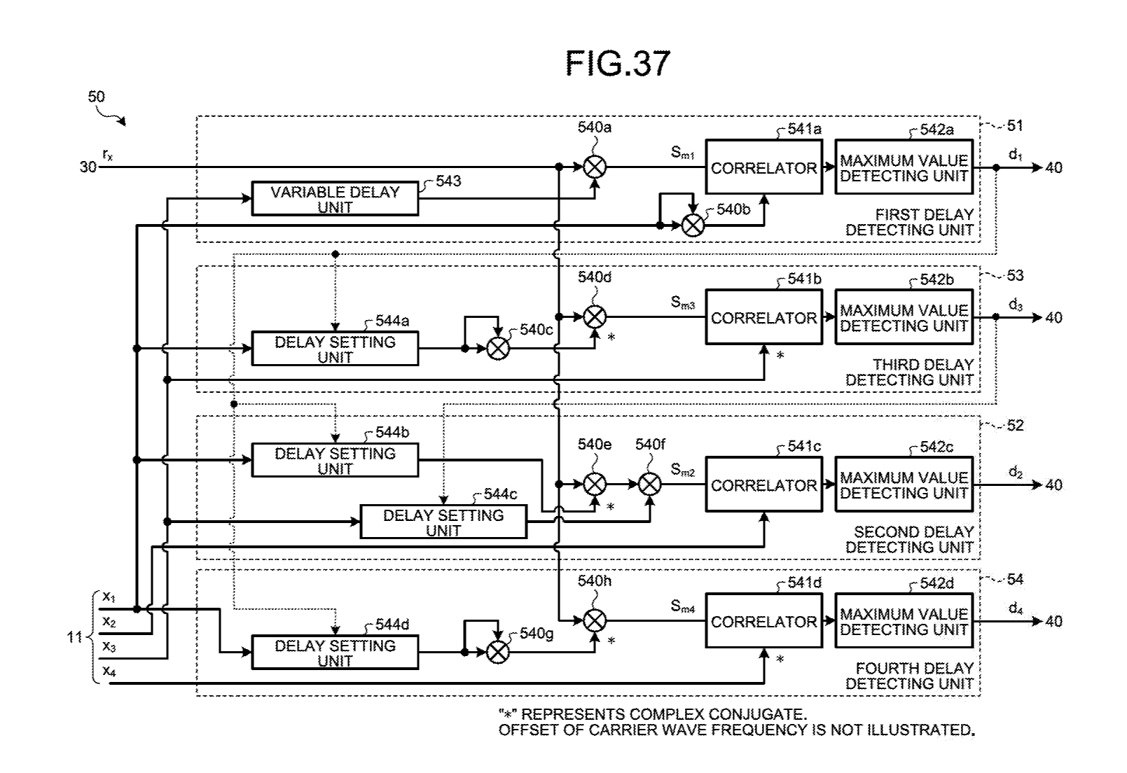

FIG. 37 is a block diagram illustrating an example of the delay measuring instrument 50 according to the sixth embodiment. The delay measuring instrument 50 according to the sixth embodiment includes the first delay detecting unit 51, the second delay detecting unit 52, the third delay detecting unit 53, and the fourth delay detecting unit 54. The first delay detecting unit 51 includes the multipliers 540a and 540b, the correlator 541a, the maximum value detecting unit 542a, and a variable delay unit 543. The second delay detecting unit 52 includes the multipliers 540e and 540f, the correlator 541c, the maximum value detecting unit 542c, and delay setting units 544b and 544c. The third delay detecting unit 53 includes the multipliers 540c and 540d, the correlator 541b, the maximum value detecting unit 542b, and a delay setting unit 544a. The fourth delay detecting unit 54 includes the multipliers 540g and 540h, the correlator 541d, the maximum value detecting unit 542d, and a delay setting unit 544d. The variable delay unit 543 and the delay setting units 544a to 544d represent examples of a delay signal generating unit. Meanwhile, except for the points explained below, the blocks in FIG. 37 which are referred to by the same reference numerals as in FIG. 31 have the same or identical functions as the blocks illustrated in FIG. 31. Hence, their explanation is not repeated.

The maximum value detecting unit 542a identifies the delay amount d₁ of the transmission signal x₁ and outputs the identified delay amount d₁ to the delay setting units 544a, 544b, and 544d. The maximum value detecting unit 542b identifies the delay amount d₃ of the transmission signal x₃ and outputs the identified delay amount d₃ to the delay setting unit 544c. The variable delay unit 543 delays the transmission signal x₃, which is output from the BBU 11, by the first delay period.

The delay setting units 544a, 544b, and 544d delay the transmission signal x₁, which is output from the BBU 11, by the delay amount d₁ output from the maximum value detecting unit 542a. The delay setting unit 544c delays the transmission signal x₃, which is output from the BBU 11, by the delay amount d₃ output from the maximum value detecting unit 542b. In the sixth embodiment, the variable delay unit 543 represents an example of a first delaying unit; the delay setting unit 544a represents an example of a second delaying unit; and the delay setting unit 544b represents an example of a third delaying unit. Moreover, in the sixth embodiment, the delay setting unit 544c represents an example of a fourth delaying unit; and the delay setting unit 544d represents an example of a fifth delaying unit.

The multiplier 540a multiplies the transmission signal x₃, which has been delayed by the variable delay unit 543, to the reception signal rₓ output from the RRE 30; and generates the intermediate signal Sₘ₁. The multiplier 540e multiplies the complex conjugate of the transmission signal x₁, which has been delayed by the delay setting unit 544b, to the reception signal rₓ output from the RRE 30. The multiplier 540f multiplies the transmission signal x₃, which has been delayed by the delay setting unit 544c, to the multiplication result obtained by the multiplier 540e; and generates the intermediate signal Sₘ₂. The multiplier 540c calculates the square of the transmission signal x₁ that has been delayed by the delay setting unit 544a. The multiplier 540g calculates the square of the transmission signal x₁ that has been delayed by the delay setting unit 544d.

Delay Amount Measurement Operation

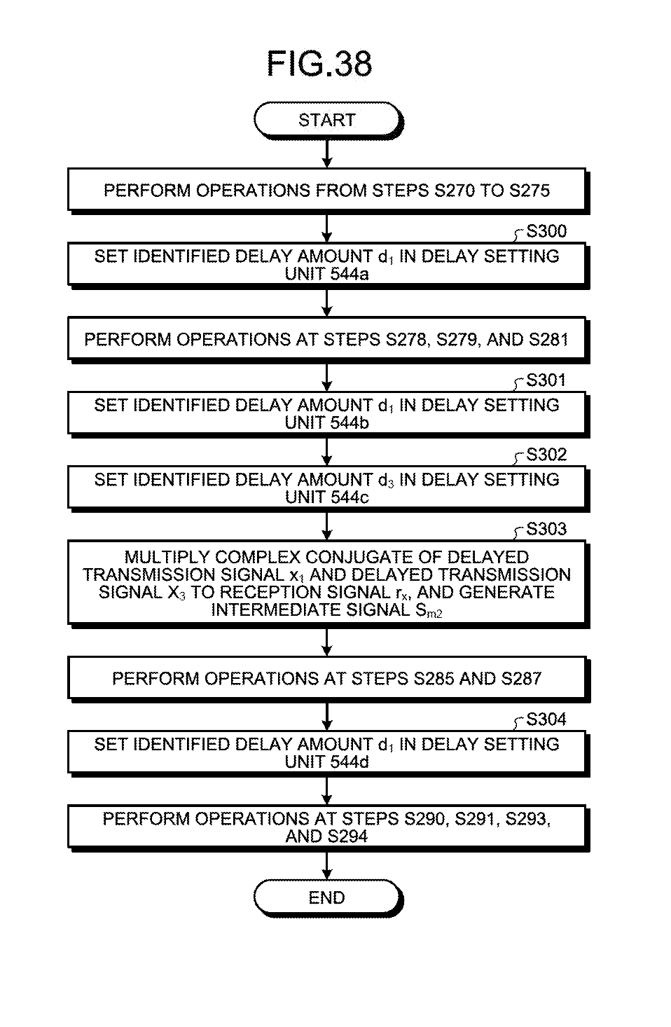

FIG. 38 is a flowchart for explaining an example of a delay amount measurement operation performed according to the sixth embodiment. The delay amount measurement operation illustrated in FIG. 38 is performed by the delay measuring instrument 50. In the delay amount measurement operation illustrated in FIG. 38, regarding the operations identical to the operations in the delay amount measurement operations illustrated in FIGS. 32 and 33, the same step numbers are used as the step numbers in the delay amount measurement operations illustrated in FIGS. 32 and 33, and the detailed explanation of those operations is not repeated.

Firstly, the operations from Steps S270 to S275, which are explained with reference to FIG. 32, are performed. Then, the delay amount d₁ of the transmission signal x₁, as identified by the maximum value detecting unit 542a, is set in the delay setting unit 544a (S300). The delay setting unit 544a delays the transmission signal x₁, which is output from the BBU 11, by the delay amount d₁ set therein. That is followed by the operations at Steps S278, S279, and S281 explained with reference to FIG. 32.

Subsequently, the delay amount d₁ of the transmission signal x₁, as identified by the maximum value detecting unit 542a, is set in the delay setting unit 544b (S301). The delay setting unit 544b delays the transmission signal x₁, which is output from the BBU 11, by the delay amount d₁ set therein. Moreover, the delay amount d₃ of the transmission signal x₃, as identified by the maximum value detecting unit 542b, is set in the delay setting unit 544c (S302). The delay setting unit 544c delays the transmission signal x₃, which is output from the BBU 11, by the delay amount d₃ set therein.

Subsequently, the complex conjugate of the transmission signal x₁, which has been delayed by the delay setting unit 544b, and the transmission signal x₃, which has been delayed by the delay setting unit 544c, are multiplied to the reception signal rₓ output from the RRE 30; and the intermediate signal Sₘ₂ is generated (S303). More particularly, the multiplier 540e multiplies the complex conjugate of the transmission signal x₁, which has been delayed by the delay setting unit 544b, to the reception signal rₓ output from the RRE 30. Then, the multiplier 540f multiplies the transmission signal x₃, which has been delayed by the delay setting unit 544c, to the multiplication result obtained by the multiplier 540e; and generates the intermediate signal Sₘ₂. That is followed by the operations at Steps S285 and S287 explained with reference to FIG. 33.

Subsequently, the delay amount d₁ of the transmission signal x₁, as identified by the maximum value detecting unit 542a, is set in the delay setting unit 544d (S304). The delay setting unit 544d delays the transmission signal x₁, which is output from the BBU 11, by the delay amount d₁ set therein. That is followed by the operations at Steps S290, S291, S293, and S294 explained with reference to FIG. 33.

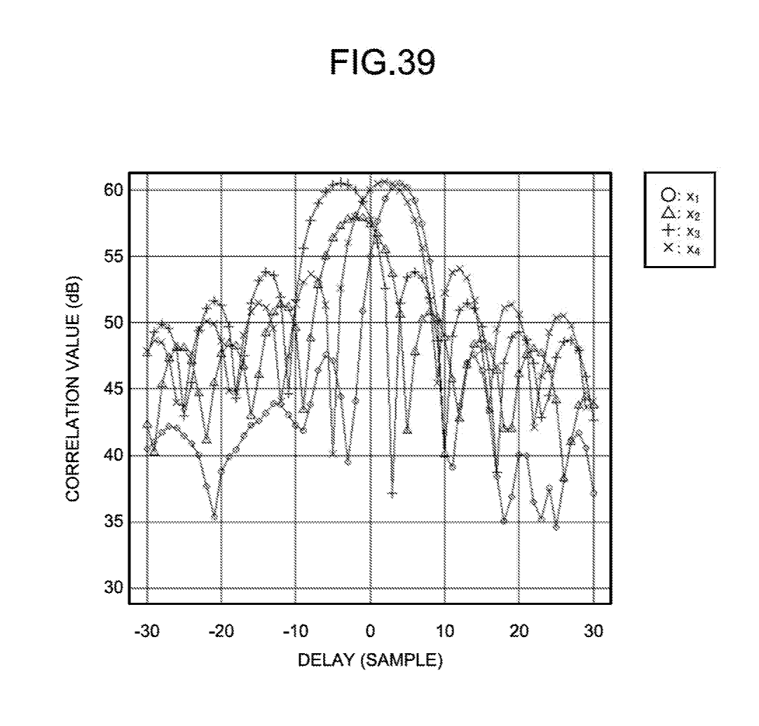

Regarding each transmission signal, a delay profile calculated by the delay measuring instrument 50 according to the sixth embodiment is as illustrated in FIG. 39, for example. FIG. 39 is a diagram illustrating an example of the delay profile of each transmission signal. In FIG. 39, the horizontal axis represents amounts of delay of each transmission signal with respect to the intermodulation signal, and the vertical axis represents correlation values. Moreover, in FIG. 39, open circles represent the correlation values between the intermediate signal Sₘ₁ and the square of the transmission signal x₁; and open triangles represent the correlation values between the intermediate signal Sₘ₂ and the transmission signal x₂. Furthermore, in FIG. 39, “+” signs represent the correlation values between the intermediate signal Sₘ₃ and the complex conjugate of the transmission signal x₃; and “×” signs represent the correlation values between the intermediate signal Sₘ₄ and the complex conjugate of the transmission signal x₄. Moreover, in FIG. 39, the illustrated correlation values represent correlation values with a reception signal that includes an intermodulation signal resulting from the transmission signal x₁ having the amount of delay of +4 samples, the transmission signal x₂ having the amount of delay of −2 samples, the transmission signal x₃ having the amount of delay of −4 samples, and the transmission signal x₄ having the amount of delay of +2 samples. Meanwhile, the sampling frequency and the sampling interval Δt₂ are identical to FIG. 10.

Another Example of Delay Measuring Instrument 50 According to Sixth Embodiment

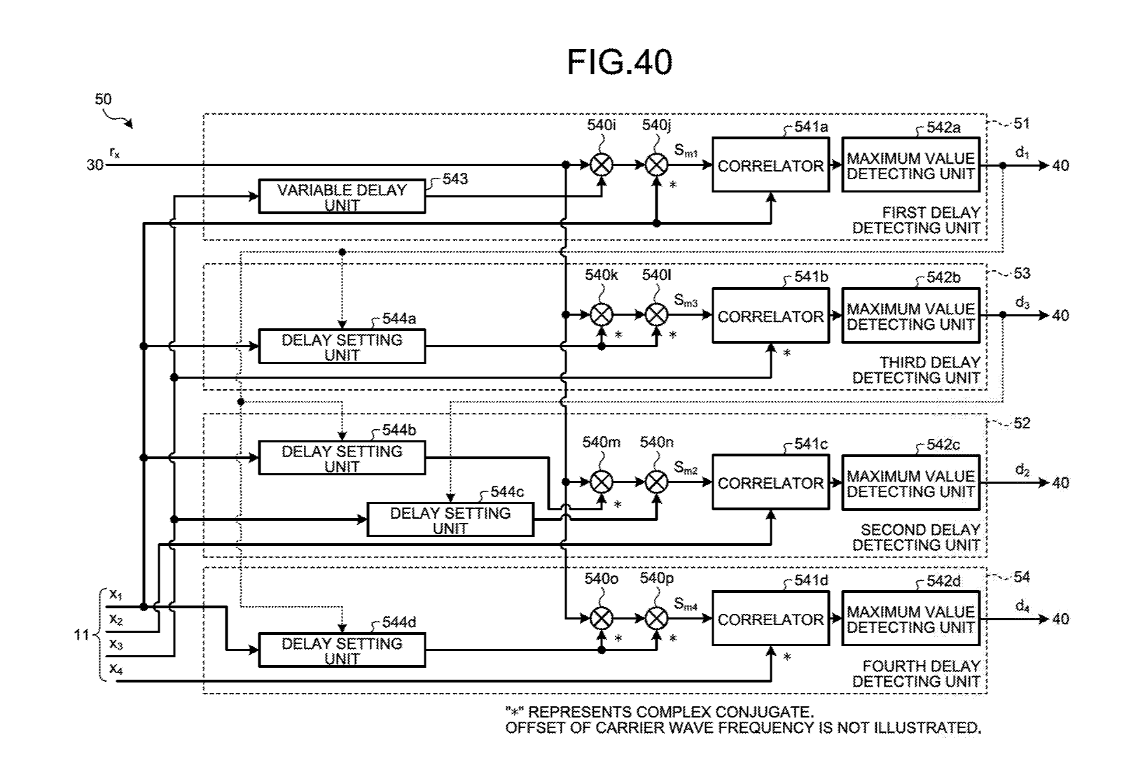

The delay measuring instrument 50 according to the sixth embodiment can also be configured as illustrated in FIG. 40, for example. FIG. 40 is a block diagram illustrating another example of the delay measuring instrument 50 according to the sixth embodiment. The delay measuring instrument 50 illustrated in FIG. 40 includes the first delay detecting unit 51, the second delay detecting unit 52, the third delay detecting unit 53, and the fourth delay detecting unit 54. The first delay detecting unit 51 includes the multipliers 540i and 540j, the correlator 541a, the maximum value detecting unit 542a, and the variable delay unit 543. The second delay detecting unit 52 includes the multipliers 540m and 540n, the correlator 541c, the maximum value detecting unit 542c, and the delay setting units 544b and 544c. The third delay detecting unit 53 includes the multipliers 540k and 540l, the correlator 541b, the maximum value detecting unit 542b, and the delay setting unit 544a. The fourth delay detecting unit 54 includes the multipliers 540o and 540p, the correlator 541d, the maximum value detecting unit 542d, and the delay setting unit 544d. Meanwhile, except for the points explained below, the blocks in FIG. 40 which are referred to by the same reference numerals as in FIG. 35 or FIG. 37 have the same or identical functions as the blocks illustrated in FIG. 35 or FIG. 37. Hence, their explanation is not repeated.

The multiplier 540i multiplies the transmission signal x₃, which has been delayed by the variable delay unit 543, to the reception signal rₓ output from the RRE 30. The multiplier 540j multiplies the complex conjugate of the transmission signal x₁, which is output from the BBU 11, to the multiplication result obtained by the multiplier 540i; and generates the intermediate signal Sₘ₁. The correlator 541a calculates the correlation values between the intermediate signal Sₘ₁ and the transmission signal x₁, which is output from the BBU 11, while varying the setting of the amount of delay of the transmission signal x₁.

The multiplier 540k multiplies the complex conjugate of the transmission signal x₁, which has been delayed by the delay setting unit 544a, to the reception signal rₓ output from the RRE 30. The multiplier 540l multiplies the complex conjugate of the transmission signal x₁, which has been delayed by the delay setting unit 544a, to the multiplication result obtained by the multiplier 540k; and generates the intermediate signal Sₘ₃. The correlator 541b calculates the correlation values between the intermediate signal Sₘ₃ and the complex conjugate of the transmission signal x₃, which is output from the BBU 11, while varying the setting of the amount of delay of the complex conjugate of the transmission signal x₃.

The multiplier 540m multiplies the complex conjugate of the transmission signal x1, which has been delayed by the delay setting unit 544b, to the reception signal rₓ output from the RRE 30. The multiplier 540n multiplies the transmission signal x₃, which has been delayed by the delay setting unit 544c, to the multiplication result obtained by the multiplier 540m; and generates the intermediate signal Sₘ₂. The correlator 541c calculates the correlation values between the intermediate signal Sₘ₂ and the transmission signal x₂, which is output from the BBU 11, while varying the setting of the amount of delay of the transmission signal x₂.

The multiplier 540o multiplies the complex conjugate of the transmission signal x₁, which has been delayed by the delay setting unit 544d, to the reception signal rₓ output from the RRE 30. The multiplier 540p multiplies the complex conjugate of the transmission signal x₁, which has been delayed by the delay setting unit 544d, to the multiplication result obtained by the multiplier 540o; and generates the intermediate signal Sₘ₄. The correlator 541d calculates the correlation values between the intermediate Sₘ₄ and the complex conjugate of the transmission signal x₄, which is output from the BBU 11, while varying the setting of the amount of delay of the complex conjugate of the transmission signal x₄.

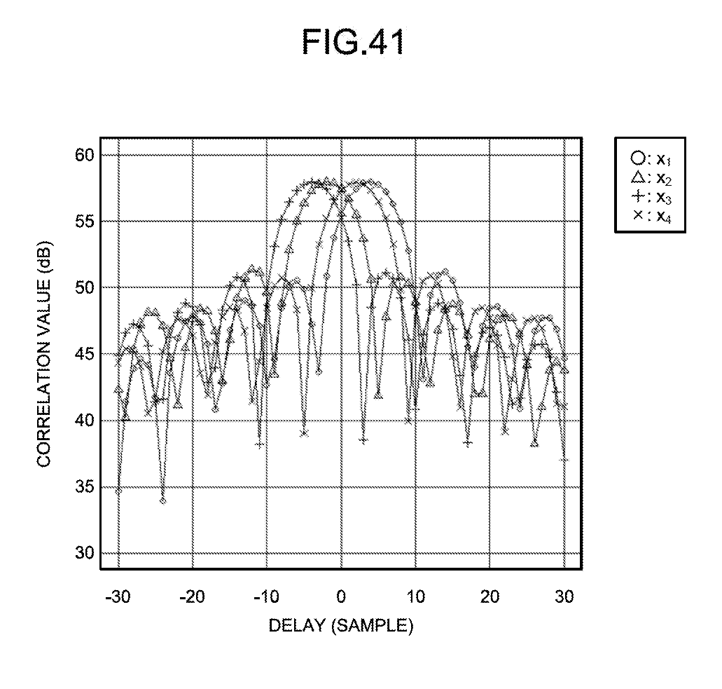

Regarding each transmission signal, a delay profile calculated by the delay measuring instrument 50 illustrated in FIG. 40 is as illustrated in FIG. 41, for example. FIG. 41 is a diagram illustrating an example of the delay profile of each transmission signal. In FIG. 41, the horizontal axis represents amounts of delay of each transmission signal with respect to the intermodulation signal, and the vertical axis represents correlation values. Moreover, in FIG. 41, open circles represent the correlation values between the intermediate signal Sₘ₁ and the transmission signal x₁, and open triangles represent the correlation values between the intermediate signal Sₘ₂ and the transmission signal x₂. Furthermore, in FIG. 41, “+” signs represent the correlation values between the intermediate signal Sₘ₃ and the complex conjugate of the transmission signal x₃; and “×” signs represent the correlation values between the intermediate signal Sₘ₄ and the complex conjugate of the transmission signal x₄. Moreover, in FIG. 41, the illustrated correlation values represent correlation values with a reception signal that includes an intermodulation signal resulting from the transmission signal x₁ having the amount of delay of +4 samples, the transmission signal x₂ having the amount of delay of −2 samples, the transmission signal x₃ having the amount of delay of −4 samples, and the transmission signal x₄ having the amount of delay of +2 samples. Meanwhile, the sampling frequency and the sampling interval Δt₂ are identical to FIG. 10.

Effect of Sixth Embodiment

The explanation given above is about the sixth embodiment. In the delay measuring instrument 50 according to the sixth embodiment, in a reception signal that includes an intermodulation signal resulting from two sets of transmission signals having different frequencies, the amount of delay of a single transmission signal is calculated and is then used in calculating the amounts of delay of the other transmission signals. That enables achieving reduction in the amount of calculation at the time of calculating the amounts of delay of the other transmission signals.

### [g] Seventh Embodiment

In the communication device 10 according to the first embodiment, at the time of calculating the amount of delay of one of a plurality of transmission signals responsible for the occurrence of an intermodulation signal, either delay signals obtained by delaying the other transmission signals by first amounts of delay or the complex conjugates of those delay signals are multiplied to the reception signal rₓ, and intermediate signals are generated. In contrast, in the communication device 10 according to a seventh embodiment, at the time of calculating the amount of delay of one of a plurality of transmission signals responsible for the occurrence of an intermodulation signal, either the time averages of the other transmission signals or the complex conjugates of those time averages are multiplied to the reception signal rₓ, and intermediate signals are generated.

Of the intermodulation signal resulting from the transmission signal x₁ having the frequency f₁ and the transmission signal x₂ having the frequency f₂, the intermodulation signal S_{PIM} of the component of 2f₁-f₂ is expressed using, for example, Equation (1) given earlier. In the case of measuring the delay amount d₁ of the transmission signal x₁; for example, as given below in Equation (10), a time average signal of the transmission signal x₂ is multiplied to the intermodulation signal S_{PIM}, and the intermediate signal Sₘ₁ is generated.

Sₘ₁=S_{PIM}·{x₂(t−1)+x₂(t)+x₂(t+1)}=K{x₂(t−1)·x₂*(t)+|x₂(t)|²+x₂(t+1)·x₂*(t)}·x₁²(t) (10)

Herein, K represents (A₃+A₅₁|x₁(t)|²+A₅₂|x₂(t)|²+A₅₃|x₃(t)|²+ . . . ).

In Equation (10) given above, {x₂(t−1)+x₂(t)+x₂(t+1)} represents the time average signal of 3 samples in the transmission signal x₂.

In Equation (10) given above, since x₂(t−1) is shifted by 1 sample with respect to x₂(t), x₂(t−1) is a signal having a close waveform to the waveform of x₂(t). For that reason, the multiplication result of x₂(t−1) and x₂*(t) becomes a close value to |x₂(t)²| representing the multiplication result of x₂(t) and x₂*(t). Herein, |x₂(t)²| is a real number. In an identical manner, since x₂(t+1) is shifted by 1 sample with respect to x₂(t), x₂(t+1) is a signal having a close waveform to the waveform of x₂(t). For that reason, the multiplication result of x₂(t+1) and x₂*(t) becomes a close value to |x₂(t)²| representing the multiplication result of x₂(t) and x₂*(t). Thus, Sₘ₁ in Equation (10) given above is expressed as the product of x₁²(t) and a value close to a real value. That is, when the correlation is calculated between Sₘ₁ given above in Equation (10) and x₁²(t), the correlation value is the maximum value at the delay amount d₁ of the transmission signal x₁ included in the intermodulation signal S_{PIM}.

Meanwhile, the time average of the transmission signal x₂ represents the average of the signals formed by delaying the transmission signal x₂ by different first amounts of delay, and includes the signals formed by delaying the transmission signal x₂ by the first amounts of delay. When the time average of the transmission signal x₂ is calculated, there is an expansion in the range in which the correlation can be taken between the transmission stream component responsible for the occurrence of the intermodulation signal and the transmission signal x₂ subjected to time averaging. However, if the time average length is increased, the signal-to-noise ratio (SN ratio) becomes smaller. For that reason, the time average length is set by taking into account the desired SN ratio. Moreover, in the seventh embodiment, the degree of resolution of the first amounts of delay, by each of which the transmission signal x₂ is delayed at the time of calculating the time average of the transmission signal x₂, can be made to be coarser than the degree of resolution of the first amounts of delay explained earlier in the first to sixth embodiments. The signal formed by taking the time average of the transmission signal x₂ represents an example of a delay signal.

Given below is the explanation of an example of a specific functional block of the delay measuring instrument 50 that implements the operations of the seventh embodiment.

Delay Measuring Instrument 50

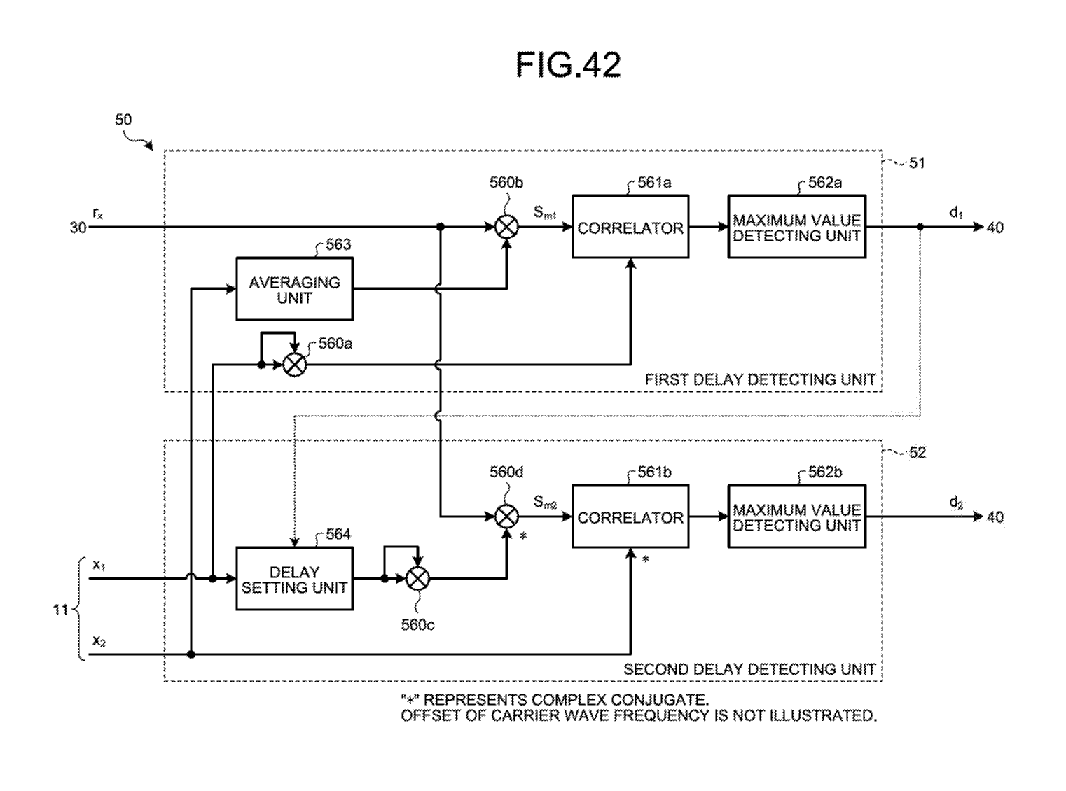

FIG. 42 is a block diagram illustrating an example of the delay measuring instrument 50 according to the seventh embodiment. The delay measuring instrument 50 according to the seventh embodiment includes the first delay detecting unit 51 and the second delay detecting unit 52. The first delay detecting unit 51 includes multipliers 560a and 560b, a correlator 561a, a maximum value detecting unit 562a, and an averaging unit 563. The second delay detecting unit 52 includes multipliers 560c and 560d, a correlator 561b, a maximum value detecting unit 562b, and a delay setting unit 564. The multipliers 560a to 560d are complex multipliers, for example. Moreover, as far as the correlators 561a and 561b are concerned, for example, it is possible to use sliding correlators as illustrated in FIG. 6 or it is possible to use matched filters as illustrated in FIG. 7. The averaging unit 563 and the delay setting unit 564 represent examples of a delay signal generating unit. The multipliers 560b and 560d represent examples of an intermediate signal generating unit. The maximum value detecting units 562a and 562b represent examples of a calculating unit.

The averaging unit 563 calculates, with respect to the transmission signal x₂ output from the BBU 11, the moving average for a predetermined number of samples and calculates the time average. The averaging unit 563 can calculate the time average of the transmission signal x₂ using, for example, a filter. The multiplier 560a calculates the square of the transmission signal x₁ that is output from the BBU 11. The multiplier 560b multiplies, to the reception signal rₓ output from the RRE 30, the time average of the transmission signal x₂ as calculated by the averaging unit 563; and generates the intermediate signal Sₘ₁. The multiplier 560b represents an example of a first generating unit.

The correlator 561a calculates the correlation values between the intermediate signal Sₘ₁, which has been calculated by the multiplier 560b, to the square of the transmission signal x₁ as calculated by the multiplier 560a. The maximum value detecting unit 562a detects the maximum correlation value from among the correlation values calculated by the correlator 561a. Then, the maximum value detecting unit 562a outputs, as the delay amount d₁ of the transmission signal x₁, the amount of delay corresponding to the detected maximum correlation value to the delay setting unit 564 and the replica generating unit 40. The maximum value detecting unit 562a represents an example of a first calculating unit.

The delay setting unit 564 delays the transmission signal x₁, which is output from the BBU 11, by the delay amount d₁ of the transmission signal x₁ as detected by the maximum value detecting unit 562a. The multiplier 560c calculates the square of the transmission signal x₁ that has been delayed by the delay setting unit 564. The multiplier 560d multiplies, to the reception signal rₓ output from the RRE 30, the complex conjugate of the square of the transmission signal x₁ as calculated by the multiplier 560c; and generates the intermediate signal Sₘ₂. The multiplier 560d represents an example of a second generating unit.

The correlator 561b calculates the correlation values between the intermediate signal Sₘ₂, which is calculated by the multiplier 560d, and the complex conjugate of the transmission signal x₂ output from the BBU 11. The maximum value detecting unit 562b detects the maximum correlation value from among the correlation values calculated by the correlator 561b. Then, the maximum value detecting unit 562b outputs, as the delay amount d₂ of the transmission signal x₂, the amount of delay corresponding to the detected maximum correlation value to the replica generating unit 40. The maximum value detecting unit 562b represents an example of a second calculating unit.

Delay Amount Measurement Operation

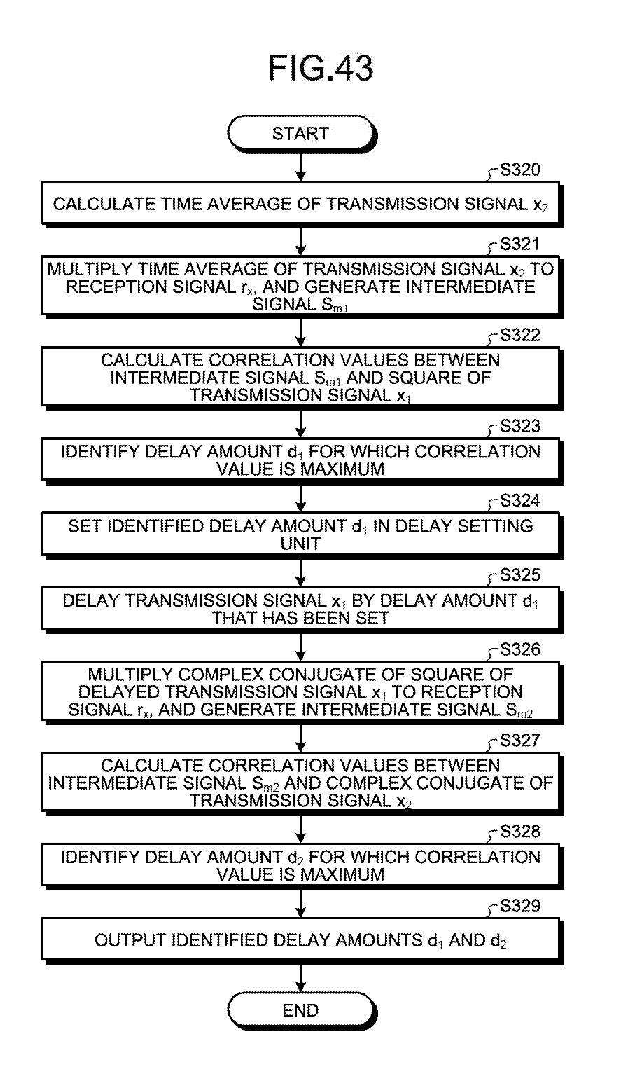

FIG. 43 is a flowchart for explaining an example of a delay amount measurement operation performed according to the seventh embodiment. The delay amount measurement operation illustrated in FIG. 43 is performed by the delay measuring instrument 50.

Firstly, regarding a predetermined number of samples, the averaging unit 563 calculates the time average of the transmission signal x₂ (S320). The multiplier 560b multiplies the transmission signal x₂, which has been subjected to time averaging by the averaging unit 563, to the reception signal rₓ output from the RRE 30; and generates the intermediate signal Sₘ₁ (S321). Then, the correlator 561a calculates the correlation values between the intermediate signal Sₘ₁ and the square of the transmission signal x₁, as calculated by the multiplier 560a, while varying the setting of the delay amount d₁ of the square of the transmission signal x₁ (S322). The maximum value detecting unit 562a identifies the delay amount d₁ for which the correlation value is the maximum value from among the correlation values calculated by the correlator 561a (S323).

Subsequently, the maximum value detecting unit 562a outputs the identified delay amount d₁ of the transmission signal x₁ to the delay setting unit 564. As a result, the delay amount d₁, which is identified by the maximum value detecting unit 562a, is set in the delay setting unit 564 (S324). The delay setting unit 564 delays the transmission signal x₁, which is output from the BBU 11, by the delay amount d₁ set therein (S325). The multiplier 560c calculates the square of the transmission signal x₁ that has been delayed by the delay setting unit 564.

Subsequently, the multiplier 560d multiplies the complex conjugate of the square of the transmission signal x₁, which has been delayed by the delay setting unit 564 and which has been raised to the power of 2 by the multiplier 560c, to the reception signal rₓ output from the RRE 30; and generates the intermediate signal Sₘ₂ (S326). Then, the correlator 561b calculates the correlation values between the intermediate signal Sₘ₂ and the complex conjugate of the transmission signal x₂ while varying the setting of the delay amount d₂ of the transmission signal x₂ (S327). The maximum value detecting unit 562b identifies such delay amount d₂ of the transmission signal x₂ for which the correlation value is the maximum value from among the correlation values calculated by the correlator 561b (S328). Then, the maximum value detecting units 562a and 562b output the identified delay amounts d₁ and d₂, respectively, to the replica generating unit 40 (S329). It marks the end of the delay amount measurement operation illustrated in FIG. 43.

In the delay amount measurement operation illustrated in FIG. 43, the time average of the transmission signal x₂ is used at the time of identifying the delay amount d₁ of the transmission signal x₁, and the delay amount d₂ of the transmission signal x₂ is identified using the identified delay amount d₁ of the transmission signal x₁. However, the technology disclosed herein is not limited to that example. Alternatively, for example, the time average of the transmission signal x₁ can be used at the time of identifying the delay amount d₂ of the transmission signal x₂, and the delay amount d₁ of the transmission signal x₁ can be identified using the identified delay amount d₂ of the transmission signal x₂. Still alternatively, the delay amount d₁ of the transmission signal x₁ and the delay amount d₂ of the transmission signal x₂ can be independently identified. More particularly, the delay amount d₁ of the transmission signal x₁ can be identified using the time average of the transmission signal x₂, and the delay amount d₂ of the transmission signal x₂ can be identified using the time average of the transmission signal x₁.

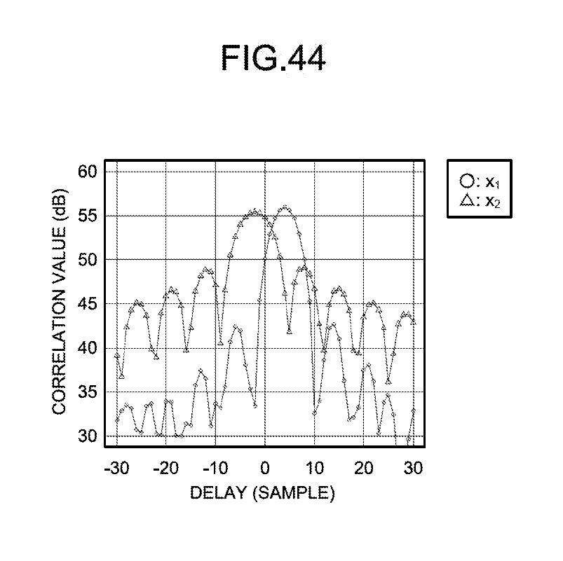

Regarding each transmission signal, a delay profile calculated by the delay measuring instrument 50 according to the seventh embodiment is as illustrated in FIG. 44, for example. FIG. 44 is a diagram illustrating an example of the delay profile of each transmission signal. In FIG. 44, the horizontal axis represents amounts of delay of each transmission signal with respect to the intermodulation signal, and the vertical axis represents correlation values. Moreover, in FIG. 44, open circles represent the correlation values between the intermediate signal Sₘ₁ and the square of the transmission signal x₁, and open triangles represent the correlation values between the intermediate signal Sₘ₂ and the complex conjugate of the transmission signal x₂. Furthermore, in FIG. 44, the illustrated correlation values represent correlation values with a reception signal that includes an intermodulation signal resulting from the transmission signal x₁ having the amount of delay of +4 samples and the transmission signal x₂ having the amount of delay of −2 samples. Meanwhile, the sampling frequency and the sampling interval Δt₂ are identical to FIG. 10.

Another Example of Delay Measuring Instrument 50 According to Seventh Embodiment

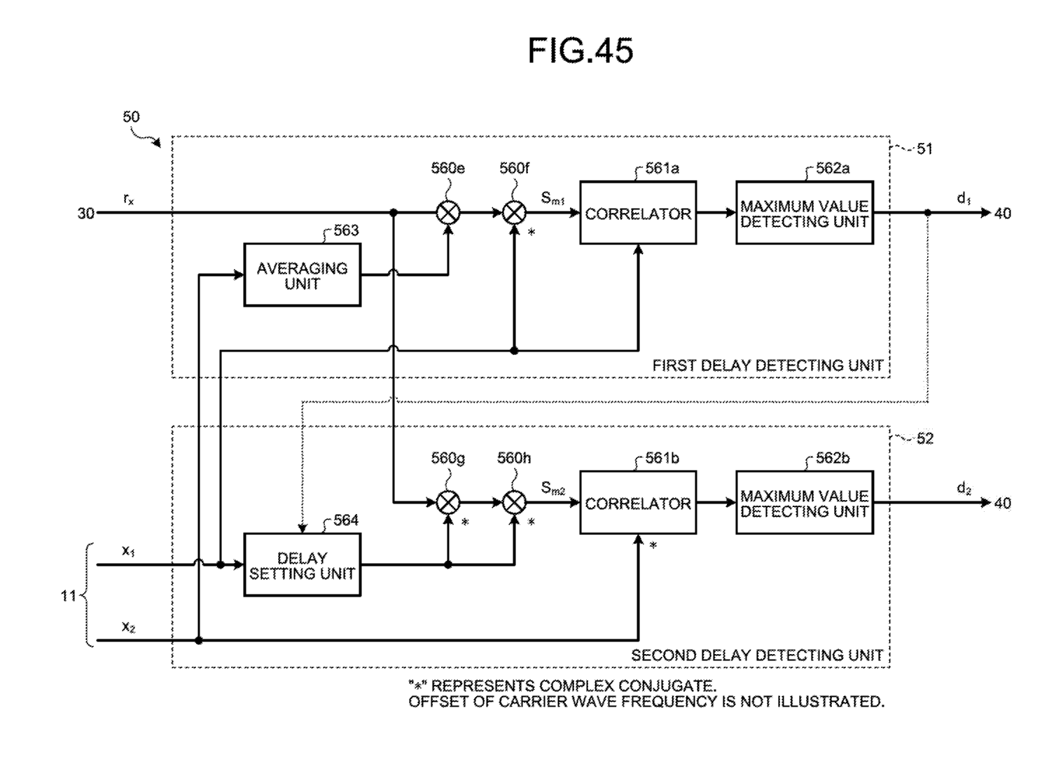

The delay measuring instrument 50 according to the seventh embodiment can also be configured as illustrated in FIG. 45, for example. FIG. 45 is a block diagram illustrating another example of the delay measuring instrument 50 according to the seventh embodiment. The delay measuring instrument 50 illustrated in FIG. 45 includes the first delay detecting unit 51 and the second delay detecting unit 52. The first delay detecting unit 51 includes multipliers 560e and 560f, the correlator 561a, the maximum value detecting unit 562a, and the averaging unit 563. The second delay detecting unit 52 includes multipliers 560g and 560h, the correlator 561b, the maximum value detecting unit 562b, and the delay setting unit 564. Meanwhile, in FIG. 45, the blocks which are referred to by the same reference numerals as in FIG. 42 have the same or identical functions as the blocks illustrated in FIG. 42. Hence, their explanation is not repeated.

The multiplier 560e multiplies the time average of the transmission signal x₂, as calculated by the averaging unit 563, to the reception signal rₓ output from the RRE 30. The multiplier 560f multiplies the complex conjugate of the transmission signal x₁, which is output from the BBU 11, to the multiplication result obtained by the multiplier 560e; and generates the intermediate signal Sₘ₁. The correlator 561a calculates the correlator values between the intermediate signal Sₘ₁, which is calculated by the multiplier 560f, and the transmission signal x₁, which is output from the BBU 11, while varying the setting of the delay amount d₁ of the transmission signal x₁.

The multiplier 560g multiplies the complex conjugate of the transmission signal x₁, which has been delayed by the delay amount d₁ by the delay setting unit 564, to the reception signal rₓ output from the RRE 30. The multiplier 560h multiplies the complex conjugate of the transmission signal x₁, which has been delayed by the delay amount d₁ by the delay setting unit 564, to the multiplication result obtained by the multiplier 560g; and generates the intermediate signal Sₘ₂.

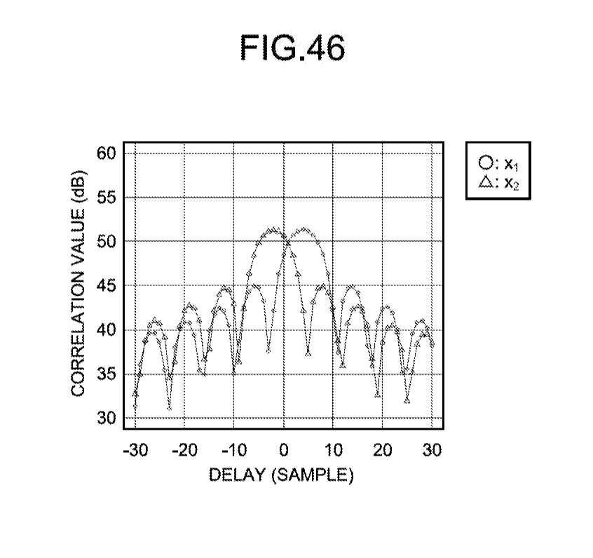

Regarding each transmission signal, a delay profile calculated by the delay measuring instrument 50 illustrated in FIG. 45 is as illustrated in FIG. 46, for example. FIG. 46 is a diagram illustrating an example of the delay profile of each transmission signal. In FIG. 46, the horizontal axis represents amounts of delay of each transmission signal with respect to the intermodulation signal, and the vertical axis represents correlation values. Moreover, in FIG. 46, open circles represent the correlation values between the intermediate signal Sₘ₁ and the transmission signal x₁, and open triangles represent the correlation values between the intermediate signal Sₘ₂ and the complex conjugate of the transmission signal x₂. Furthermore, in FIG. 46, the illustrated correlation values represent correlation values with a reception signal that includes an intermodulation signal resulting from the transmission signal x₁ having the amount of delay of +4 samples and the transmission signal x₂ having the amount of delay of −2 samples. Meanwhile, the sampling frequency and the sampling interval Δt₂ are identical to FIG. 10.

Effect of Seventh Embodiment

The explanation given above is about the seventh embodiment. The delay measuring instrument 50 according to the seventh embodiment includes the averaging unit 563, the multiplier 560b, and the maximum value detecting unit 562a. The averaging unit 563 calculates the time average of the signals formed by delaying the transmission signal x₁ by a plurality of different first amounts of delay. The multiplier 560b multiplies, to the reception signal rₓ, the transmission signal x₁ that has been subjected to time averaging by the averaging unit 563; and generates the intermediate signal Sₘ₁. Based on the correlation values between the intermediate signal Sₘ₁ and the transmission signal x₂, the maximum value detecting unit 562a calculates the amount of delay of the transmission signal x₂ with respect to the intermodulation signal. As a result, in the communication device 10 according to the seventh embodiment, the intermodulation signal included in the reception signal can be cancelled out with accuracy.

### [h] Eighth Embodiment

In the seventh embodiment described above, the explanation is given about the communication device 10 that cancels out the intermodulation signal resulting from the transmission signals x₁ and x₂ that are transmitted at two different frequencies. In an eighth embodiment, the explanation is given about cancelling out an intermodulation signal resulting from the transmission signals x₁, x₂, and x₃ that are transmitted at three different frequencies. In the following explanation, f₁ is defined as the frequency of the transmission signal x₁, f₂ is defined as the frequency of the transmission signal x₂, and f₃ represents the frequency of the transmission signal x₃; and it is assumed that f₁<f₂<f₃ holds true. The transmission signal x₁ represents an example of a first transmission signal, the transmission signal x₂ represents an example of a second transmission signal, and the transmission signal x₃ represents an example of a third transmission signal.

Delay Measuring Instrument 50

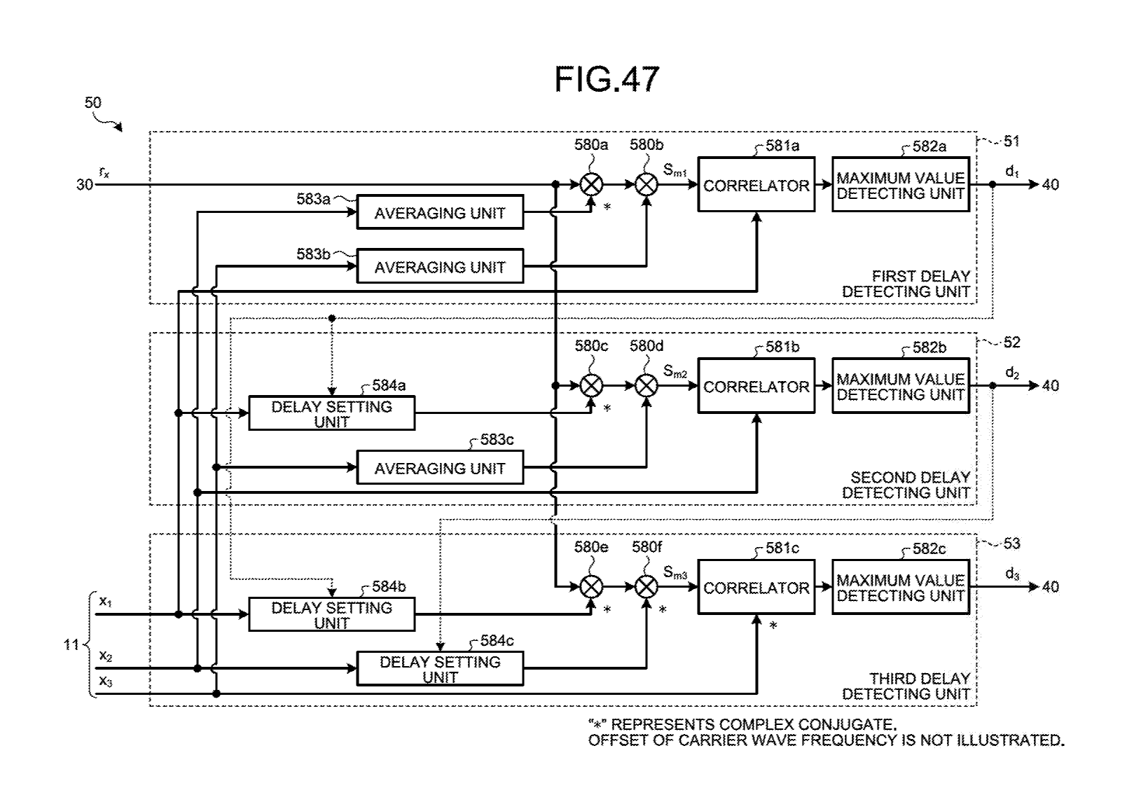

FIG. 47 is a block diagram illustrating an example of the delay measuring instrument 50 according to the eighth embodiment. The delay measuring instrument 50 according to the eighth embodiment includes the first delay detecting unit 51, the second delay detecting unit 52, and the third delay detecting unit 53. The first delay detecting unit 51 includes multipliers 580a and 580b, a correlator 581a, a maximum value detecting unit 582a, and averaging units 583a and 583b. The second delay detecting unit 52 includes multipliers 580c and 580d, a correlator 581b, a maximum value detecting unit 582b, a delay setting unit 584a, and an averaging unit 583c. The third delay detecting unit 53 includes multipliers 580e and 580f, a correlator 581c, a maximum value detecting unit 582c, and delay setting units 584b and 584c. The multipliers 580a to 580f are complex multipliers, for example. Moreover, as far as the correlators 581a to 581c are concerned, for example, it is possible to use sliding correlators as illustrated in FIG. 6 or it is possible to use matched filters as illustrated in FIG. 7. The averaging units 583a to 583c and the delay setting units 584a to 584c represent examples of a delay signal generating unit. The multipliers 580b, 580d, and 580f represent examples of an intermediate signal generating unit. The maximum value detecting units 582a to 582c represent examples of a calculating unit.

The averaging unit 583a calculates the time average of a predetermined number of samples with respect to the transmission signal x₂ output from the BBU 11. The averaging unit 583b calculates the time average of a predetermined number of samples with respect to the transmission signal x₃ output from the BBU 11. The multiplier 580a multiplies the complex conjugate of the time average of the transmission signal x₂, as calculated by the averaging unit 583a, to the reception signal rₓ output from the RRE 30. The multiplier 580b multiplies the time average of the transmission signal x₃, as calculated by the averaging unit 583b, to the multiplication result obtained by the multiplier 580a; and generates the intermediate signal Sₘ₁. The multipliers 580a and 580b are examples of a first generating unit.

The correlator 581a calculates the correlation values between the intermediate signal Sₘ₁, which is calculated by the multiplier 580b, and the transmission signal x₁, which is output from the BBU 11. The maximum value detecting unit 582a detects the maximum correlation value from among the correlation values calculated by the correlator 581a. Then, the maximum value detecting unit 582a outputs, as the delay amount d₁ of the transmission signal x₁, the amount of delay corresponding to the detected maximum correlation value to the delay setting units 584a and 584b and the replica generating unit 40. The maximum value detecting unit 582a represents an example of a first calculating unit.

The delay setting unit 584a delays the transmission signal x₁, which is output from the BBU 11, by the delay amount d₁ of the transmission signal x₁ as detected by the maximum value detecting unit 582a. The averaging unit 583c calculates the time average of a predetermined number of samples with respect to the transmission signal x₃ output from the BBU 11. The multiplier 580c multiplies the complex conjugate of the transmission signal x₁, which has been delayed by the delay setting unit 584a, to the reception signal rₓ output from the RRE 30. The multiplier 580d multiplies the transmission signal x₃, which has been subjected to time averaging by the averaging unit 583c, to the multiplication result obtained by the multiplier 580c; and generates the intermediate signal Sₘ₂. The multipliers 580c and 580d are examples of a second generating unit.

The correlator 581b calculates the correlation values between the intermediate signal Sₘ₂, which is calculated by the multiplier 580d, and the transmission signal x₂, which is output from the BBU 11. The maximum value detecting unit 582b detects the maximum correlation value from among the correlation values calculated by the correlator 581b. Then, the maximum value detecting unit 582b outputs, as the delay amount d₂ of the transmission signal x₂, the amount of delay corresponding to the detected maximum correlation value to the delay setting unit 584c and the replica generating unit 40. The maximum value detecting unit 582b represents an example of a second calculating unit.

The delay setting unit 584b delays the transmission signal x₁, which is output from the BBU 11, by the delay amount d₁ of the transmission signal x₁ as detected by the maximum value detecting unit 582a. The delay setting unit 584c delays the transmission signal x₂, which is output from the BBU 11, by the delay amount d₂ of the transmission signal x₂ as detected by the maximum value detecting unit 582b. The multiplier 580e multiplies the complex conjugate of the transmission signal x₁, which has been delayed by the delay setting unit 584b, to the reception signal rₓ output from the RRE 30. The multiplier 580f multiplies the complex conjugate of the transmission signal x₂, which has been delayed by the delay setting unit 584b, to the multiplication result obtained by the multiplier 580e; and generates the intermediate signal Sₘ₃. The multipliers 580e and 580f are examples of a third generating unit.

The correlator 581c calculates the correlation values between the intermediate value Sₘ₃, which is calculated by the multiplier 580f, and the complex conjugate of the transmission signal x₃ output from the BBU 11. The maximum value detecting unit 582c detects the maximum correlation value from among the correlation values calculated by the correlator 581c. Then, the maximum value detecting unit 582c outputs, as the delay amount d₃ of the transmission signal x₃, the amount of delay corresponding to the detected maximum correlation value to the replica generating unit 40. The maximum value detecting unit 582c represents an example of a third calculating unit.

Delay Amount Measurement Operation

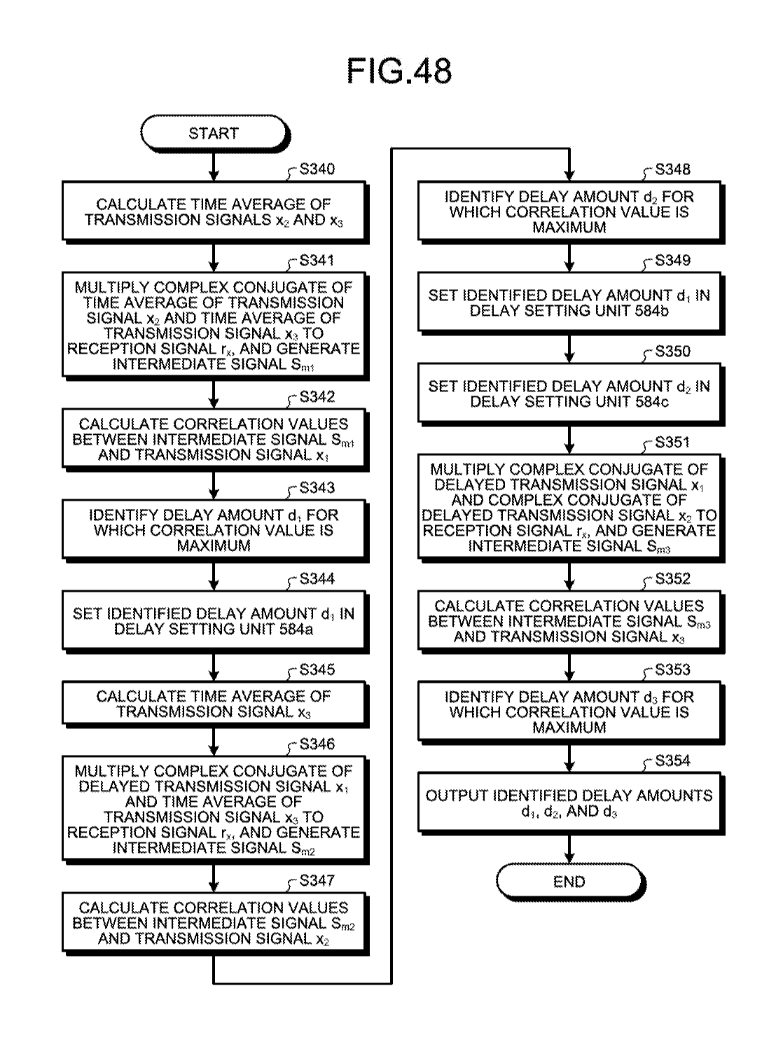

FIG. 48 is a flowchart for explaining an example of a delay amount measurement operation performed according to the eighth embodiment. The delay amount measurement operation illustrated in FIG. 48 is performed by the delay measuring instrument 50.

Firstly, the averaging unit 583a calculates the time average of a predetermined number of samples with respect to the transmission signal x₂; and the averaging unit 583b calculates the time average of a predetermined number of samples with respect to the transmission signal x₃ (S340). The multiplier 580a multiplies the complex conjugate of the transmission signal x₂, which has been subjected to time averaging by the averaging unit 583a, to the reception signal rₓ output from the RRE 30. The multiplier 580b multiplies the transmission signal x₃, which has been subjected to time averaging by the averaging unit 583b, to the multiplication result obtained by the multiplier 580a; and generates the intermediate signal Sₘ₁ (S341). Then, the correlator 581a calculates the correlation values between the intermediate signal Sₘ₁, which is calculated by the multiplier 580b, and the transmission signal x₁, which is output from the BBU 11, while varying the setting of the delay amount d₁ of the transmission signal x₁ (S342). The maximum value detecting unit 582a identifies the delay amount d₁ of the transmission signal x₁ for which the correlation value is the maximum value from among the correlation values calculated by the correlator 581a (S343).

Subsequently, the maximum value detecting unit 582a outputs the identified delay amount d₁ of the transmission signal x₁ to the delay setting unit 584a. As a result, the delay amount d₁, which has been identified by the maximum value detecting unit 582a, is set in the delay setting unit 584a (S344). The averaging unit 583c calculates the time average of the transmission signal x₃ for a predetermined number of samples (S345). The multiplier 580c multiplies the complex conjugate of the transmission signal x₁, which has been delayed by the delay setting unit 584a, to the reception signal rₓ output from the RRE 30. Then, the multiplier 580d multiplies the transmission signal x₃, which has been subjecting to time averaging, to the multiplication result obtained by the multiplier 580c; and generates the intermediate signal Sₘ₂ (S346). Then, the correlator 581b calculates the correlation values between the intermediate signal Sₘ₂ and the transmission signal x₂, which is output from the BBU 11, while varying the setting of the delay amount d₂ of the transmission signal x₂ (S347). The maximum value detecting unit 582b identifies the delay amount d₂ of the transmission signal x₂ for which the correlation value is the maximum value from among the correlation values calculated by the correlator 581b (S348).

Subsequently, the maximum value detecting unit 582a outputs the identified delay amount d₁ of the transmission signal x₁ to the delay setting unit 584b. As a result, the delay amount d₁, which has been identified by the maximum value detecting unit 582a, is set in the delay setting unit 584b (S349). Moreover, the maximum value detecting unit 582b outputs the identified delay amount d₂ of the transmission signal x₂ to the delay setting unit 584c. As a result, the delay amount d₂, which has been identified by the maximum value detecting unit 582b, is set in the delay setting unit 584c (S350). The multiplier 580e multiplies the complex conjugate of the transmission signal x₁, which has been delayed by the delay setting unit 584b, to the reception signal rₓ output from the RRE 30. Then, the multiplier 580f multiplies the complex conjugate of the transmission signal x₂, which has been delayed by the delay setting unit 584c, to the multiplication result obtained by the multiplier 580e; and generates the intermediate signal Sₘ₃ (S351). Then, the correlator 581c calculates the correlation values between the intermediate signal Sₘ₃ and the transmission signal x₃, which is output from the BBU 11, while varying the setting of the delay amount d₃ of the transmission signal x₃ (S352). The maximum value detecting unit 582c identifies the delay amount d₃ of the transmission signal x₃ for which the correlation value is the maximum value from among the correlation values calculated by the correlator 581c (S353). Then, the maximum value detecting units 582a to 582c output the identified delay amounts d₁ to d₃, respectively, to the replica generating unit 40 (S354). It marks the end of the delay amount measurement operation illustrated in FIG. 48.

Effect of Eighth Embodiment

The explanation given above is about the eighth embodiment. In the communication device 10 according to the eighth embodiment, in a reception signal that includes an intermodulation signal resulting from three transmission signals having different frequencies, the amount of delay of a single transmission signal is calculated and is used in calculating the amounts of delay of the other transmission signals. That enables achieving reduction in the amount of calculation at the time of calculating the amounts of delay of the other transmission signals.

Miscellaneous

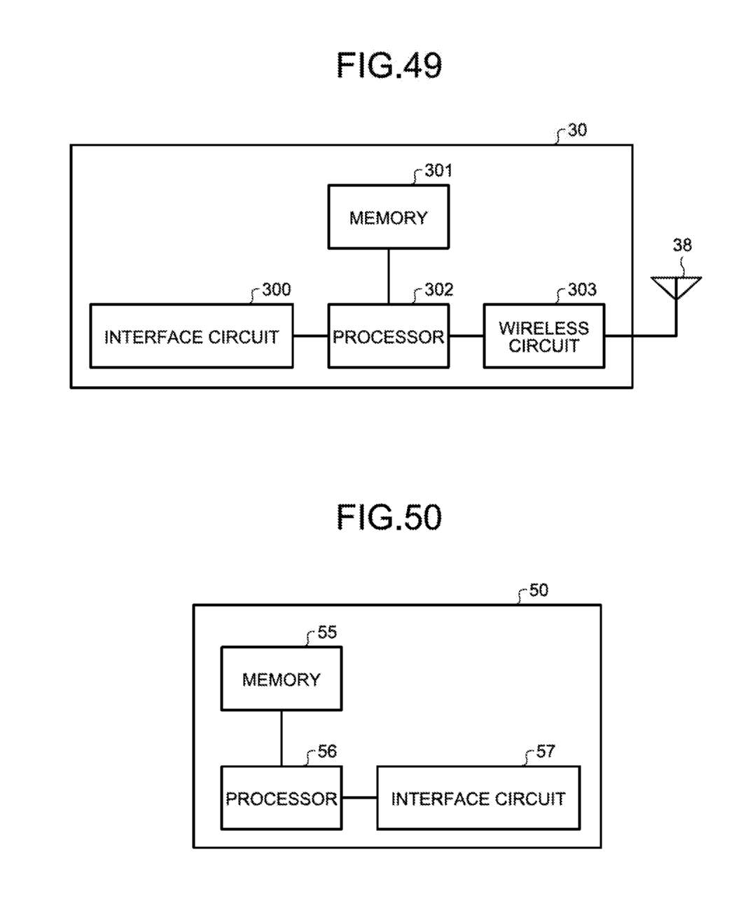

The RRE 30 according to the embodiments described above is implemented using hardware illustrated in FIG. 49, for example. FIG. 49 is a diagram illustrating an example of hardware of the RRE 30. For example, as illustrated in FIG. 49, the RRE 30 includes an interface circuit 300, a memory 301, a processor 302, a wireless circuit 303, and the antenna 38.

The interface circuit 300 enables transmission and reception of signals between the BBU 11 and PIM canceller 20 according to a communication standard such as the common public radio interface (CPRI). The wireless circuit 303 includes the DAC 31, the ADC 32, the quadrature modulator 33, the quadrature demodulator 34, the PA 35, the LNA 36, and the DUP 37. The memory 301 is used to store computer programs and data meant for implementing the functions of the RRE 30. The processor 302 executes the computer programs read from the memory 301, and implements various functions of the RRE 30 in cooperation with the interface circuit 300 and the wireless circuit 303.

The delay measuring instrument 50 according to the embodiments described above is implemented using hardware illustrated in FIG. 50, for example. FIG. 50 is a diagram illustrating an example of hardware of the delay measuring instrument 50. For example, as illustrated in FIG. 50, the delay measuring instrument 50 includes a memory 55, a processor 56, and an interface circuit 57.

The interface circuit 57 enables transmission and reception of signals between the BBU 11 and the RRE 30 according to a communication standard such as CPRI. The memory 55 is used to store computer programs and data meant for implementing the functions of the delay measuring instrument 50. The processor 56 executes the computer programs read from the memory 55 and implements various functions of the delay measuring instrument 50, such as the functions of a multiplier, a correlator, a maximum value detecting unit, a variable delay unit, a delay setting unit, and an averaging unit, in cooperation with the interface circuit 57.

Meanwhile, the technology disclosed herein is not limited to the embodiments described above, and various modifications can be made within the scope of the gist of the technology. For example, in the embodiments described above, the delay measuring instrument 50 is configured as a device independent of the BBU 11 and the RRE 30, and is installed in between the BBU 11 and the RRE 30. However, the technology disclosed herein is not limited to that example. Alternatively, for example, the delay measuring instrument 50 can be installed in the BBU 11 or in each RRE 30.

Moreover, the first to sixth embodiments, in which the amount of delay of each transmission signal is obtained while varying the first amount of delay, can be combined with the seventh and eighth embodiments, in which the amount of delay of each transmission signal is obtained using the time average of the transmission signals. As a result, the degree of resolution of the first amount of delay in the first to sixth embodiments can be made to be further coarser.

According to one embodiment, an intermodulation signal included in a receiving signal can be cancelled out with accuracy.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A communication device comprising:
a transmitting unit that transmits a plurality of transmission signals at mutually different frequencies;
a receiving unit that receives a reception signal which includes an intermodulation signal resulting from the plurality of transmission signals;
a delay measuring instrument that measures an amount of delay of each of the plurality of transmission signals;
an intermodulation signal generating unit that generates the intermodulation signal from the plurality of transmission signals based on the amount of delay of each of the plurality of transmission signals as measured by the delay measuring instrument; and
a cancelling unit that cancels out the intermodulation signal included in the reception signal by combining the intermodulation signal, which is generated by the intermodulation signal generating unit, and the reception signal, wherein
the delay measuring instrument includes
a delay signal generating unit that generates a delay signal which includes a signal formed by delaying one particular transmission signal, from among the plurality of transmission signals, by a first amount of delay,
an intermediate signal generating unit that multiplies, to the reception signal, either the delay signal or a complex conjugate of the delay signal generated by the delay signal generating unit, and generates an intermediate signal, and
a calculating unit that, based on a correlation value between the intermediate signal and other transmission signal included in the plurality of transmission signals, calculates an amount of delay of the other transmission signal with respect to the intermodulation signal.

2. The communication device according to claim 1, wherein
the delay signal generating unit delays the one particular transmission signal by the first amount of delay while varying the first amount of delay among a plurality of different first amounts of delay, and
the calculating unit calculates the amount of delay of the other transmission signal with respect to the intermodulation signal based on the correlation value between the intermediate signal corresponding to each first amount of delay and the other transmission signal.

3. The communication device according to claim 2, wherein
the delay measuring instrument includes a correlating unit that delays the other transmission signal by a second amount of delay with respect to the intermediate signal, and calculates the correlation value between the other transmission signal, which has been delayed by the second amount of delay, and the intermediate signal, wherein
the correlating unit calculates, while varying the second amount of delay among a plurality of different second amounts of delay, the correlation value corresponding to each second amount of delay, and
the difference between two first amounts of delay is greater than the difference between two second amounts of delay.

4. The communication device according to claim 2, wherein
the plurality of transmission signals include a first transmission signal and a second transmission signal transmitted at different frequencies,
the delay signal generating unit includes
a first delaying unit that delays the first transmission signal by the first amount of delay, and
a second delaying unit that delays the second transmission signal by the first amount of delay,
the intermediate signal generating unit includes
a first generating unit that multiplies the second transmission signal, which has been delayed by the second delaying unit, to the reception signal, and generates a first intermediate signal, and
a second generating unit that multiplies a complex conjugate of a square of the first transmission signal, which has been delayed by the first delaying unit, to the reception signal, and generates a second intermediate signal, and
the calculating unit includes
a first calculating unit that, based on a correlation value between the first intermediate signal corresponding to each first amount of delay and a square of the first transmission signal, calculates an amount of delay of the first transmission signal with respect to the intermodulation signal, and
a second calculating unit that, based on a correlation value between the second intermediate signal corresponding to each first amount of delay and a complex conjugate of the second transmission signal, calculates an amount of delay of the second transmission signal with respect to the intermodulation signal.

5. The communication device according to claim 2, wherein
the plurality of transmission signals include a first transmission signal and a second transmission signal transmitted at different frequencies,
the delay signal generating unit includes
a first delaying unit that delays the first transmission signal by a predetermined amount of delay, and
a second delaying unit that delays the second transmission signal by the first amount of delay,
the intermediate signal generating unit includes
a first generating unit that multiplies the second transmission signal, which has been delayed by the second delaying unit, to the reception signal, and generates a first intermediate signal, and
a second generating unit that multiplies a complex conjugate of a square of the first transmission signal, which has been delayed by the first delaying unit, to the reception signal, and generates a second intermediate signal,
the calculating unit includes
a first calculating unit that, based on a correlation value between the first intermediate signal corresponding to each first amount of delay and a square of the first transmission signal, calculates an amount of delay of the first transmission signal with respect to the intermodulation signal, and
a second calculating unit that, based on a correlation value between the second intermediate signal and a complex conjugate of the second transmission signal, calculates an amount of delay of the second transmission signal with respect to the intermodulation signal, and
the first delaying unit delays the first transmission signal by the amount of delay calculated by the first calculating unit.

6. The communication device according to claim 2, wherein
the plurality of transmission signals include a first transmission signal, a second transmission signal, and a third transmission signal transmitted at different frequencies,
the delay signal generating unit includes
a first delaying unit that delays the first transmission signal by the first amount of delay,
a second delaying unit that delays the second transmission signal by the first amount of delay, and
a third delaying unit that delays the third transmission signal by the first amount of delay,
the intermediate signal generating unit includes
a first generating unit that multiplies a complex conjugate of the second transmission signal, which has been delayed by the second delaying unit, and the third transmission signal, which has been delayed by the third delaying unit, to the reception signal, and generates a first intermediate signal,
a second generating unit that multiplies a complex conjugate of the first transmission signal, which has been delayed by the first delaying unit, and the third transmission signal, which has been delayed by the third delaying unit, to the reception signal, and generates a second intermediate signal, and
a third generating unit that multiplies a complex conjugate of the first transmission signal, which has been delayed by the first delaying unit, and a complex conjugate of the second transmission signal, which has been delayed by the second delaying unit, to the reception signal, and generates a third intermediate signal,
the calculating unit includes
a first calculating unit that, based on a correlation value between the first intermediate signal corresponding to each first amount of delay and the first transmission signal, calculates an amount of delay of the first transmission signal with respect to the intermodulation signal,
a second calculating unit that, based on a correlation value between the second intermediate signal corresponding to each first amount of delay and the second transmission signal, calculates an amount of delay of the second transmission signal with respect to the intermodulation signal, and
a third calculating unit that, based on a correlation value between the third intermediate signal corresponding to each first amount of delay and a complex conjugate of the third transmission signal, calculates an amount of delay of the third transmission signal with respect to the intermodulation signal.

7. The communication device according to claim 2, wherein
the plurality of transmission signals include a first transmission signal, a second transmission signal, and a third transmission signal transmitted at different frequencies,
the delay signal generating unit includes
a first delaying unit that delays the second transmission signal by the first amount of delay,
a second delaying unit that delays the third transmission signal by the first amount of delay,
a third delaying unit that delays the first transmission signal by a predetermined amount of delay,
a fourth delaying unit that delays the third transmission signal by a predetermined amount of delay,
a fifth delaying unit that delays the first transmission signal by a predetermined amount of delay, and
a sixth delaying unit that delays the second transmission signal by a predetermined amount of delay,
the intermediate signal generating unit includes
a first generating unit that multiplies a complex conjugate of the second transmission signal, which has been delayed by the first delaying unit, and the third transmission signal, which has been delayed by the second delaying unit, to the reception signal, and generates a first intermediate signal,
a second generating unit that multiplies a complex conjugate of the first transmission signal, which has been delayed by the third delaying unit, and the third transmission signal, which has been delayed by the fourth delaying unit, to the reception signal, and generates a second intermediate signal, and
a third generating unit that multiplies a complex conjugate of the first transmission signal, which has been delayed by the fifth delaying unit, and a complex conjugate of the second transmission signal, which has been delayed by the sixth delaying unit, to the reception signal, and generates a third intermediate signal,
the calculating unit includes
a first calculating unit that, based on a correlation value between the first intermediate signal corresponding to each first amount of delay and the first transmission signal, calculates an amount of delay of the first transmission signal with respect to the intermodulation signal,
a second calculating unit that, based on a correlation value between the second intermediate signal and the second transmission signal, calculates an amount of delay of the second transmission signal with respect to the intermodulation signal, and
a third calculating unit that, based on a correlation value between the third intermediate signal and a complex conjugate of the third transmission signal, calculates an amount of delay of the third transmission signal with respect to the intermodulation signal,
the third delaying unit and the fifth delaying unit delay the first transmission signal by the amount of delay calculated by the first calculating unit,
the fourth delaying unit delays the third transmission signal by the first amount of delay which is set in the second delaying unit when the amount of delay of the first transmission signal is calculated by the first calculating unit, and
the sixth delaying unit delays the second transmission signal by the amount of delay calculated by the second calculating unit.

8. The communication device according to claim 2, wherein
the plurality of transmission signals include two sets of transmission signals transmitted at different frequencies,
one set of the two sets of transmission signals includes a first transmission signal and a second transmission signal transmitted at a same frequency,
other set of the two sets of transmission signals includes a third transmission signal and a fourth transmission signal transmitted at a same frequency,
the delay signal generating unit includes
a first delaying unit that delays the third transmission signal by the first amount of delay,
a second delaying unit that delays the first transmission signal by the first amount of delay,
a third delaying unit that delays the fourth transmission signal by the first amount of delay, and
a fourth delaying unit that delays the second transmission signal by the first amount of delay,
the intermediate signal generating unit includes
a first generating unit that multiplies the third transmission signal, which has been delayed by the first delaying unit, to the reception signal, and generates a first intermediate signal,
a second generating unit that multiplies the fourth transmission signal, which has been delayed by the third delaying unit, to the reception signal, and generates a second intermediate signal,
a third generating unit that multiplies a complex conjugate of a square of the first transmission signal, which has been delayed by the second delaying unit, to the reception signal, and generates a third intermediate signal, and
a fourth generating unit that multiplies a complex conjugate of a square of the second transmission signal, which has been delayed by the fourth delaying unit, to the reception signal, and generates a fourth intermediate signal, and
the calculating unit includes
a first calculating unit that, based on a correlation value between the first intermediate signal corresponding to each first amount of delay and a square of the first transmission signal, calculates an amount of delay of the first transmission signal with respect to the intermodulation signal,
a second calculating unit that, based on a correlation value between the second intermediate signal corresponding to each first amount of delay and a square of the second transmission signal, calculates an amount of delay of the second transmission signal with respect to the intermodulation signal,
a third calculating unit that, based on a correlation value between the third intermediate signal corresponding to each first amount of delay and a complex conjugate of the third transmission signal, calculates an amount of delay of the third transmission signal with respect to the intermodulation signal, and
a fourth calculating unit that, based on a correlation value between the fourth intermediate signal corresponding to each first amount of delay and a complex conjugate of the fourth transmission signal, calculates an amount of delay of the fourth transmission signal with respect to the intermodulation signal.

9. The communication device according to claim 2, wherein
the plurality of transmission signals include two sets of transmission signals transmitted at different frequencies,
one set of the two sets of transmission signals includes a first transmission signal and a second transmission signal transmitted at a same frequency,
the other set of the two sets of transmission signals includes a third transmission signal and a fourth transmission signal transmitted at a same frequency,
the delay signal generating unit includes
a first delaying unit that delays the third transmission signal by the first amount of delay,
a second delaying unit that delays the first transmission signal by a predetermined amount of delay,
a third delaying unit that delays the first transmission signal by a predetermined amount of delay,
a fourth delaying unit that delays the third transmission signal by a predetermined amount of delay, and
a fifth delaying unit that delays the first transmission signal by a predetermined amount of delay,
the intermediate signal generating unit includes
a first generating unit that multiplies the third transmission signal, which has been delayed by the first delaying unit, to the reception signal, and generates a first intermediate signal,
a second generating unit that multiplies a complex conjugate of the first transmission signal, which has been delayed by the third delaying unit, and the third transmission signal, which has been delayed by the fourth delaying unit, to the reception signal, and generates a second intermediate signal,
a third generating unit that multiplies a complex conjugate of a square of the first transmission signal, which has been delayed by the second delaying unit, to the reception signal, and generates a third intermediate signal, and
a fourth generating unit that multiplies a complex conjugate of a square of the first transmission signal, which has been delayed by the fifth delaying unit, to the reception signal, and generates a fourth intermediate signal,
the calculating unit includes
a first calculating unit that, based on a correlation value between the first intermediate signal corresponding to each first amount of delay and a square of the first transmission signal, calculates an amount of delay of the first transmission signal with respect to the intermodulation signal,
a second calculating unit that, based on a correlation value between the second intermediate signal and the second transmission signal, calculates an amount of delay of the second transmission signal with respect to the intermodulation signal,
a third calculating unit that, based on a correlation value between the third intermediate signal and a complex conjugate of the third transmission signal, calculates an amount of delay of the third transmission signal with respect to the intermodulation signal, and
a fourth calculating unit that, based on a correlation value between the fourth intermediate signal and a complex conjugate of the fourth transmission signal, calculates an amount of delay of the fourth transmission signal with respect to the intermodulation signal,
the second delaying unit, the third delaying unit, and the fifth delay unit delay the first transmission signal by the amount of delay calculated by the first calculating unit, and
the fourth delaying unit delays the third transmission signal by the amount of delay calculated by the second calculating unit.

10. The communication device according to claim 1, wherein
the delay signal generating unit calculates a time average of a signal formed by delaying the one particular transmission signal regarding a plurality of different first amounts of delay,
the intermediate signal generating unit multiplies, to the reception signal, either the one particular transmission signal or a complex conjugate of the one particular transmission signal that has been subjected to time averaging by the delay signal generating unit, and generates the intermediate signal, and
the calculating unit calculates, based on the correlation value between the intermediate signal and the other transmission signal included in the plurality of transmission signals, the amount of delay of the other transmission signal with respect to the intermodulation signal.

11. The communication device according to claim 10, wherein
the plurality of transmission signals include a first transmission signal and a second transmission signal transmitted at different frequencies,
the delay signal generating unit includes
an averaging unit that calculates a time average of the second transmission signal, and
a delaying unit that delays the first transmission signal by a predetermined amount of delay,
the intermediate signal generating unit includes
a first generating unit that multiplies the time average of the second transmission signal, which has been calculated by the averaging unit, to the reception signal, and generates a first intermediate signal, and
a second generating unit that multiplies a complex conjugate of a square of the first transmission signal, which has been delayed by the delaying unit, to the reception signal, and generates a second intermediate signal,
the calculating unit includes
a first calculating unit that, based on a correlation value between the first intermediate signal and a square of the first transmission signal, calculates an amount of delay of the first transmission signal with respect to the intermodulation signal, and
a second calculating unit that, based on a correlation value between the second intermediate value and a complex conjugate of the second transmission signal, calculates an amount of delay of the second transmission signal with respect to the intermodulation signal, and
the delaying unit delays the first transmission signal by the amount of delay calculated by the first calculating unit.

12. The communication device according to claim 10, wherein
the plurality of transmission signals include a first transmission signal, a second transmission signal, and a third transmission signal transmitted at different frequencies,
the delay measuring instrument further includes
a first averaging unit that calculates a time average of the second transmission signal,
a second averaging unit that calculates a time average of the third transmission signal, and
a third averaging unit that calculates a time average of the third transmission signal,
the delay signal generating unit includes
a first delaying unit that delays the first transmission signal by a predetermined amount of delay,
a second delaying unit that delays the first transmission signal by a predetermined amount of delay, and
a third delaying unit that delays the second transmission signal by a predetermined amount of delay,
the intermediate signal generating unit includes
a first generating unit that multiplies a complex conjugate of the time average of the second transmission signal, which has been calculated by the first averaging unit, and the time average of the third transmission signal, which has been calculated by the second averaging unit, to the reception signal, and generates a first intermediate signal,
a second generating unit that multiplies a complex conjugate of the first transmission signal, which has been delayed by the first delaying unit, and the time average of the third transmission signal, which has been calculated by the third averaging unit, to the reception signal, and generates a second intermediate signal, and
a third generating unit that multiplies a complex conjugate of the first transmission signal, which has been delayed by the second delaying unit, and a complex conjugate of the second transmission signal, which has been delayed by the third delaying unit, to the reception signal, and generates a third intermediate signal,
the calculating unit includes
a first calculating unit that, based on a correlation value between the first intermediate signal and the first transmission signal, calculates an amount of delay of the first transmission signal with respect to the intermodulation signal,
a second calculating unit that, based on a correlation value between the second intermediate signal and the second transmission signal, calculates an amount of delay of the second transmission signal with respect to the intermodulation signal, and
a third calculating unit that, based on a correlation value between the third intermediate signal and a complex conjugate of the third transmission signal, calculates an amount of delay of the third transmission signal with respect to the intermodulation signal,
the first delaying unit and the second delaying unit delay the first transmission signal by the amount of delay calculated by the first calculating unit, and
the third delaying unit delays the second transmission signal by the amount of delay calculated by the second calculating unit.

13. A cancellation method in a communication device, the method comprising:
transmitting a plurality of transmission signals at mutually different frequencies;
receiving a reception signal that includes an intermodulation signal resulting from the plurality of transmission signals;
measuring an amount of delay of each of the plurality of transmission signals;
generating the intermodulation signal from the plurality of transmission signals based on the measured amount of delay of each of the plurality of transmission signals; and
canceling out the intermodulation signal included in the reception signal by combining the generated intermodulation signal with the reception signal, wherein
the measuring includes
generating a delay signal that includes a signal formed by delaying one particular transmission signal, from among the plurality of transmission signals, by a first amount of delay,
generating an intermediate signal by multiplying, to the reception signal, either the generated delay signal or a complex conjugate of the generated delay signal, and
calculating, based on a correlation value between the intermediate signal and other transmission signal included in the plurality of transmission signals, an amount of delay of the other transmission signal with respect to the intermodulation signal.
